(19) United States
(12) Patent Application Publication
(10) Pub. No.: US 2009/0177503 A1
(43) Pub. Date: Jul. 9, 2009

(54) Scheduling apparatus and computer readable medium storing scheduling program

(75) Inventors: Junko Kawano, Okazaki-shi (JP); Shoji Onoto, Nagoya-shi (JP); Hiroaki Matsuba, Nagoya-shi (JP); Makoto Tanaka, Nagoya-shi (JP); Akiko Yamato, Nagoya-shi (JP); Yoshiaki Komatsu, Yokkaichi-shi (JP); Yoshibumi Kato, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 12/382,221

(22) Filed: Mar. 11, 2009

Related U.S. Application Data
(63) Continuation-in-part of application No. PCT/JP07/65239, filed on Aug. 3, 2007.

(30) Foreign Application Priority Data
Sep. 29, 2006 (JP) 2006-267985
Sep. 29, 2006 (JP) 2006-269336

(51) Int. Cl. G06Q 10/00; G06N 7/02

(52) U.S. Cl. 705/5; 706/52; 705/9

(57) ABSTRACT

A scheduling apparatus to arrange a schedule for a new event in accordance with an input includes an input accepting device, a personal schedule information acquisition device, a schedule determination device, and a schedule registration device. The input accepting device accepts new event information. The personal schedule information acquisition device acquires personal schedule information from a personal schedule storage device. The schedule determination device determines a new schedule including a holding date and time and a holding location based on the new event information, the personal schedule information, and at least one of a weather forecast or a travel distance of at least one of the participants to attend the new event. The schedule registration device registers the determined new schedule into the personal schedule storage device.

### CROSS-REFERENCE TO RELATED APPLICATION

This application is a U.S. continuation-in-part application filed under 35 USC 111(a) claiming benefit under 35 USC 120 and 365(c) of International Application No. PCT/JP2007/065239, filed Aug. 3, 2007, which claims priority to Application Ser. Nos. 2006-267985, filed in Japan on Sep. 29, 2006, and 2006-269336, filed in Japan on Sep. 29, 2006. The disclosure of the foregoing applications is incorporated by reference herein in their entireties.

### BACKGROUND

The present disclosure relates to a scheduling apparatus and a computer-readable medium storing a scheduling program.

Conventionally, an agent may arrange a schedule of participants in an event such as a conference in a known system. The agent may recognize an intention of a user and may perform processing with a minimum user intervention, based on autonomous determination. In a schedule management support apparatus described in Japanese Patent Application Laid-Open Publication No. 9-91341, for example, if a user instructs an agent to hold a conference of some name, the agent may reference history information of the past, and first present a conference condition including a combination of most frequent participating members, a conference room most frequently used for the conference, and an average degree of priority of the conference. Then, when conference condition settings are completed with a change made by a user or with an approval given by the user, the agent automatically makes an inquiry about schedules of the participants and selects an optimal time zone to determine a new schedule. For selection of the optimal time zone, the agent may consider availabilities of conference rooms, time zones suitable for such a conference, important members who should attend the conference, and dates and times of the conference held in the past. The agent may also regard a time obtained by subtracting a travel time to move to a location where the conference will be held as an available time. In addition, if there is no available time in the date and time desired for holding the conference, the agent may rearrange another date and time available for the participating members, by examining available times of the participating members near the date and time desired for holding the conference.

### SUMMARY

Such a schedule determination by the conventional schedule management support apparatus is based only on available times of members requested to attend the conference and the past history. The weather of the day when the conference will actually be held and where users will be before and after the conference is not considered. As a result, determined date and time or a location of the conference may not be the most appropriate for the users. If an event is held outdoors or if the members need to travel to the location where a conference will be held, for example, it may not be desirable that it should rain on the day of the conference. Moreover, if a plurality of conferences is held consecutively, it may not be desirable that an inefficient travel should be forced such as travels between the same places several times or making a detour.

It is an object of the present disclosure to provide a scheduling apparatus and a computer-readable medium storing a scheduling program that may arrange a schedule based on at least one of the weather and a travel distance between locations of events, such as conferences.

Exemplary embodiments provide a scheduling apparatus that arranges a schedule for a new event in accordance with an input. The scheduling apparatus includes an input accepting device, a personal schedule information acquisition device, a schedule determination device, and a schedule registration device. The input accepting device accepts as an input new event information that may include a desired date and time of the new event, a desired location of the new event, and participants of the new event. At least the participants is requisite in the new event information. The personal schedule information acquisition device acquires personal schedule information from a personal schedule storage device. The personal schedule storage device stores the personal schedule information including identification information of a user, a registered date and time and a registered location. The registered date and time is a date and time of a registered existing event, while the registered location is a location of the registered existing event. The schedule determination device determines a new schedule based on the new event information accepted by the input accepting device, the personal schedule information acquired by the personal schedule information acquisition device, and at least one of a weather forecast or a travel distance of at least one of the participants to attend the new event. The new schedule includes a holding date, which is a determined date and a time of the new event, and a holding location, which is a determined location of the new event. The schedule registration device registers the new schedule determined by the schedule determination device into the personal schedule storage device.

Exemplary embodiments also provide a computer-readable medium storing a scheduling program. The scheduling program includes instructions to cause a computer to execute accepting new event information that may include a desired date and time of the new event, a desired location of the new event, and participants of the new event, at least the participants being requisite in the new event information, acquiring personal schedule information from a personal schedule storage device, the personal schedule information a including identification information of a user, a registered date and time and a registered location of a registered event, determining a new schedule including a holding date and time and a holding location based on the accepted new event information, the acquired personal schedule information, and at least one of a weather forecast or a travel distance of at least one of the participants to attend the new event, the holding date and time being a determined date and a time of the new event, and the holding location being a determined location of the new event, and registering the determined new schedule into the personal schedule storage device.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

Exemplary embodiments of the disclosure will be described below in detail with reference to the accompanying drawings in which:

FIG. 1 is a schematic view showing a system configuration according to a first embodiment.

FIG. 2 is a block diagram showing an electrical configuration of a user terminal.

FIG. 3 is a block diagram showing an electrical configuration of a server.

FIG. 4 is a schematic view showing a configuration of a hard disk drive of the user terminal.

FIG. 5 is a schematic view showing a configuration of a hard disk drive of the server.

FIG. 6 is a schematic view showing a configuration of a location database storage area.

FIG. 7 is a schematic view showing a configuration of a weather forecast database storage area 283.

FIG. 8 is a schematic view showing a configuration of a schedule for one person in a personal schedule database.

FIG. 9 is a schematic view showing a configuration of a travel distance value storage area.

FIG. 10 is a schematic view showing a configuration of a RAM.

FIG. 11 is a schematic view showing a configuration of a possible-date-and-time storage area.

FIG. 12 is a schematic view showing a configuration of a first travel distance value storage area.

FIG. 13 is a schematic view showing a configuration of a second travel distance value storage area.

FIG. 14 is a schematic view showing a configuration of a third travel distance value storage area.

FIG. 15 is an explanatory diagram of a new schedule input screen.

FIG. 16 is an explanatory diagram of a registration confirmation screen.

FIG. 17 is an explanatory diagram of an attendance confirmation screen.

FIG. 18 is an explanatory diagram of an outdoor cancellation screen.

FIG. 19 is a flowchart of main processing according to a first exemplary embodiment.

FIG. 20 is a flowchart of first scheduling processing performed in the main processing.

FIG. 21 is a flowchart of location examination processing performed in the first scheduling processing and third scheduling processing.

FIG. 22 is a flowchart of the third scheduling processing performed in the main processing.

FIG. 23 is a flowchart of clear weather examination processing performed in the third scheduling processing.

FIG. 24 is a flowchart of second scheduling processing.

FIG. 25 is a flowchart of fourth scheduling processing.

FIG. 26 is a flowchart of the fourth scheduling processing, continued from FIG. 25.

FIG. 27 is a flowchart of the fourth scheduling processing, continued from FIG. 26.

FIG. 28 is a flowchart of attendance confirmation processing.

FIG. 29 is a flowchart of execution determination processing.

FIG. 30 is a schematic view showing a configuration of the hard disk drive of the user terminal according to a second embodiment.

FIG. 31 is a schematic view showing a configuration of the hard disk drive of the server according to the second embodiment.

FIG. 32 is a schematic view showing a configuration of the RAM of the user terminal according to the second embodiment.

FIG. 33 is a schematic view showing a configuration of a possible-date-and-time storage area.

FIG. 34 is a schematic view showing a configuration of an interim inquiry result storage area.

FIG. 35 is an explanatory diagram of an execution confirmation screen.

FIG. 36 is a flowchart of main processing according to the second embodiment.

FIG. 37 is a flowchart of the main processing according to the second embodiment, continued from FIG. 36.

FIG. 38 is a flowchart of the main processing, continued from FIG. 37.

FIG. 39 is a flowchart of the main processing, continued from FIG. 38.

FIG. 40 is a flowchart of the main processing, continued from FIG. 39.

FIG. 41 is a flowchart of indoor processing performed in the main processing.

FIG. 42 is a flowchart of outdoor processing performed in the main processing.

FIG. 43 is a flowchart of indoor arrangement processing performed in the main processing.

FIG. 44 is a flowchart of indoor determination processing performed in the indoor arrangement processing.

FIG. 45 is a flowchart of outdoor arrangement processing performed in the main processing.

FIG. 46 is a flowchart of indoor interim schedule inquiry reception processing performed in the main processing.

FIG. 47 is a flowchart of attendance determination processing performed in the indoor determination processing and the outdoor arrangement processing.

FIG. 48 is a schematic view showing a system configuration of a scheduling system according to a third embodiment.

FIG. 49 is a block diagram showing an electrical configuration of a server.

FIG. 50 is a block diagram showing an electrical configuration of a user terminal.

FIG. 51 is a schematic diagram of a new schedule input screen.

FIG. 52 is a flowchart of main processing according to a third embodiment.

FIG. 53 is a flowchart of the main processing according to a third embodiment, continued from FIG. 52.

FIG. 54 is a flowchart of schedule determination processing performed in the main processing.

FIG. 55 is a flowchart of first determination processing performed in the schedule determination processing.

FIG. 56 is a flowchart of second determination processing performed in the schedule determination processing.

FIG. 57 is a flowchart of the second determination processing performed in the schedule determination processing, continued from FIG. 56.

FIG. 58 is a flowchart of third determination processing performed in the schedule determination processing.

FIG. 59 is an explanatory diagram showing an example of conference room data display.

FIG. 60 is a schematic view of an importance calculation table for a short travel distance.

FIG. 61 is a schematic view of an importance calculation table for a long travel distance.

FIG. 62 is an explanatory diagram concerning a location determination process using an importance.

FIG. 63 is another explanatory diagram concerning the location determination process using the importance.

FIG. 64 is still another explanatory diagram concerning the location determination process using the importance.

FIG. 65 is still another explanatory diagram concerning the location determination process using the importance.

FIG. 66 is another schematic diagram of the new schedule input screen.

FIG. 67 is an explanatory diagram concerning a date-and-time determination process using the importance.

FIG. 68 is a flowchart of approval determination processing.

FIG. 69 is a schematic view showing a system configuration of a scheduling system according to a fourth embodiment.

FIG. 70 is a block diagram showing an electrical configuration of a server.

FIG. 71 is a block diagram showing an electrical configuration of a user terminal.

FIG. 72 is a schematic diagram of a new schedule input screen.

FIG. 73 is a flowchart of main processing according to a fourth embodiment.

FIG. 74 is a flowchart of schedule acquisition processing performed in the main processing.

FIG. 75 is a flowchart of first determination processing performed in the main processing.

FIG. 76 is a flowchart of second determination processing performed in the main processing.

FIG. 77 is a flowchart of the second determination processing performed in the main processing, continued from FIG. 76.

FIG. 78 is a flowchart of third determination processing performed in the main processing.

FIG. 79 is a flowchart of the third determination processing performed in the main processing, continued from FIG. 78.

FIG. 80 is schematic view showing a system configuration of a scheduling system according to a modification of the third embodiment.

FIG. 81 is a block diagram showing an electrical configuration of a user terminal.

### DETAILED DESCRIPTION OF THE EXEMPLARY EMBODIMENTS

Exemplary embodiments of the present disclosure will be described below with reference to drawings. The drawings may be used to describe technical features that can be adopted by the present disclosure and thus, the described configurations of apparatuses, flows of various kinds of processing and the like are not intended to be limited thereto and are only examples for description.

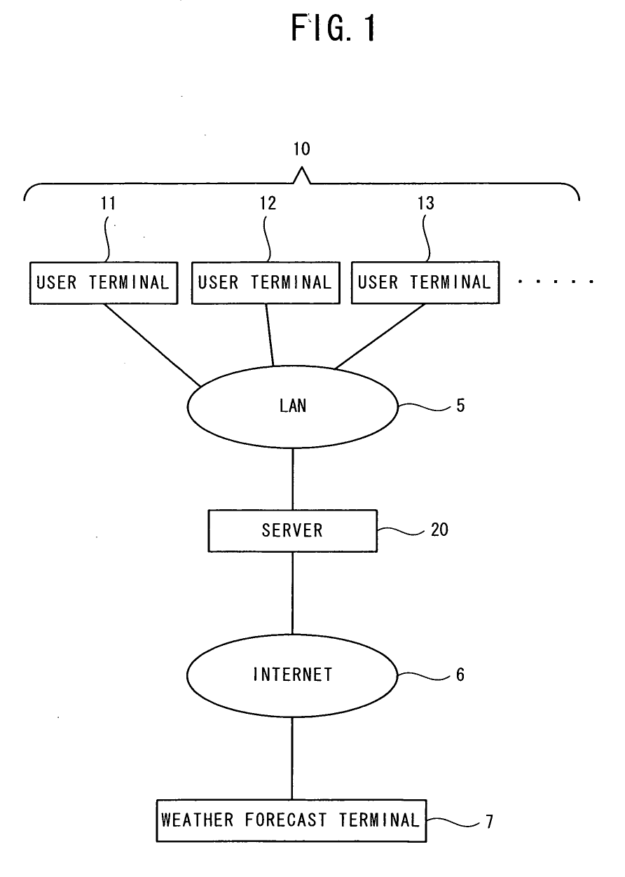

First, an apparatus configuration in a first exemplary embodiment and a second exemplary embodiment will be described with reference to FIG. 1. As shown in FIG. 1, user terminals 11, 12, and 13 . . . and a server 20 may be connected to a local area network (LAN) 5. The terminals and the server 20 may mutually exchange data via the LAN 5. While the user terminals 11, 12, and 13 are exemplified in FIG. 1, the number of user terminals is not limited to three. The number may be two, four, or more. When the user terminals connected to the LAN 5 are generically indicated or an unspecified user terminal is indicated, such a user terminal (or user terminals) will be hereinafter called a “user terminal 10”. The user terminal 10 may be a terminal operated by a user. Various kinds of database may be stored on the server 20. Moreover, the server 20 may also be connected to the Internet 6 and may obtain information about the weather forecast by connecting to a weather forecast terminal 7 via the Internet 6.

In the first embodiment, scheduling processing is performed by the server 20, based on desired information inputted by the user through the user terminal 10. In the first embodiment, schedules (personal schedules) of all users are stored together on the server 20. In the second embodiment, desired information is inputted by the user through the user terminal 10, and scheduling processing is performed by the user terminal 10 based on the desired information. In the second embodiment, a personal schedule of each user is stored in each of the user terminals 10. An inquiry about available time zones in schedules and the like is made from the user terminal through which desired information is inputted (for example, the user terminal 11) to other user terminals 12, 13, . . . of users designated as participants, and the final schedule arrangement is made in the user terminal 11.

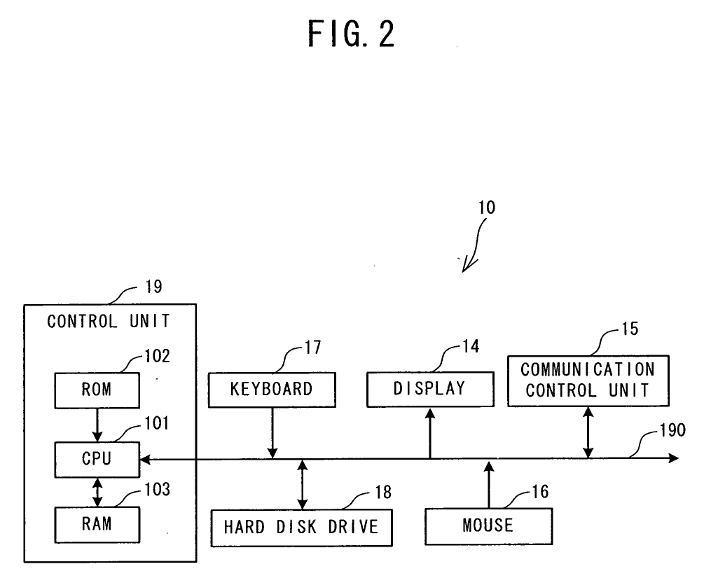

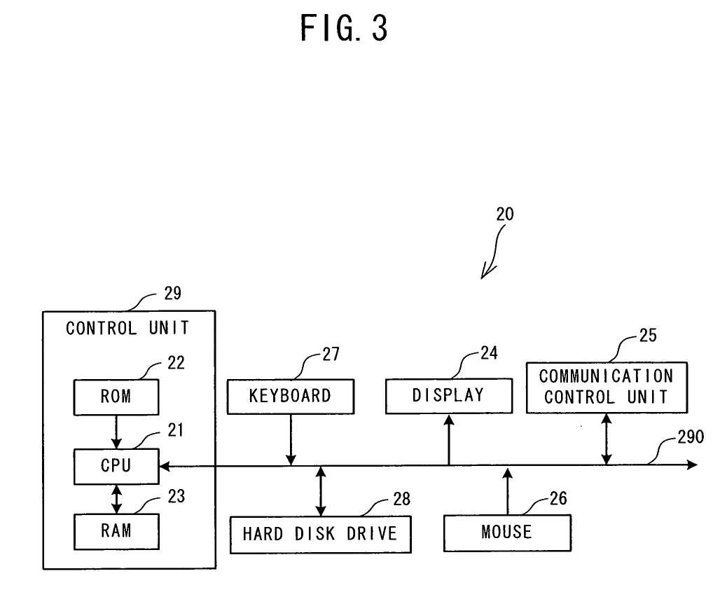

Electrical configurations of the user terminal 10 and the server 20, which are common to the first embodiment and the second embodiment, will be described with reference to FIGS. 2 and 3. As shown in FIG. 2, the user terminal 10 is a so-called personal computer and is provided with a control unit 19 including a CPU 101 to manage controls of the user terminal 10, a ROM 102 storing BIOS and the like, and a RAM 103 having storage areas to temporarily store various kinds of data. The ROM 102 and the RAM 103 are each connected to the CPU 101. The CPU 101 is further connected via a data bus 190 to a hard disk drive 18, a keyboard 17 through which various kinds of data may be inputted, a mouse 16, a display 14 to display various kinds of data, and a communication control unit 15 to control communication for connection to the LAN 5 and the Internet 6.

As shown in FIG. 3, the server 20 is provided with a control unit 29 including a CPU 21 to manage control of the server 20, a ROM 22 storing BIOS and the like, and a RAM 23 having storage areas to temporarily store various kinds of data. The ROM 22 and the RAM 23 are each connected to the CPU 21. The CPU 21 is further connected via a data bus 290 to a hard disk drive 28, a keyboard 27 through which various kinds of data may be inputted, a mouse 26, a display 24 to display various kinds of data, and a communication control unit 25 to control communication for connection to the LAN 5.

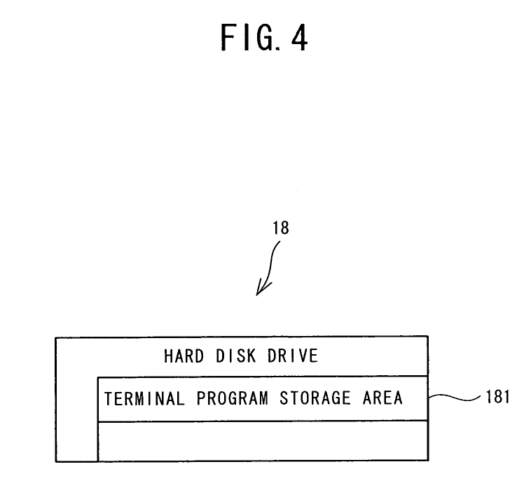

Next, the first embodiment will be described with reference to FIGS. 4 to 29. In the first embodiment, scheduling processing is performed by the server 20 based on desired information inputted by the user through the user terminal 10.

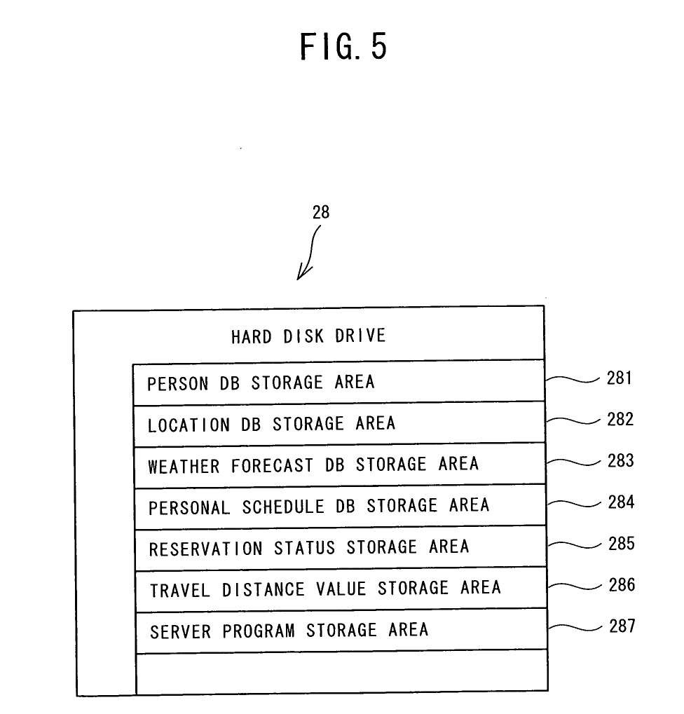

First, storage areas of the hard disk drive 18 provided in the user terminal 10 and storage areas of the hard disk drive 28 provided on the server 20 will be described with reference to FIGS. 4 and 5. Here, only storage areas related to scheduling processing described below in detail will be described, but other storage areas that are not described may also be provided in each hard disk drive.

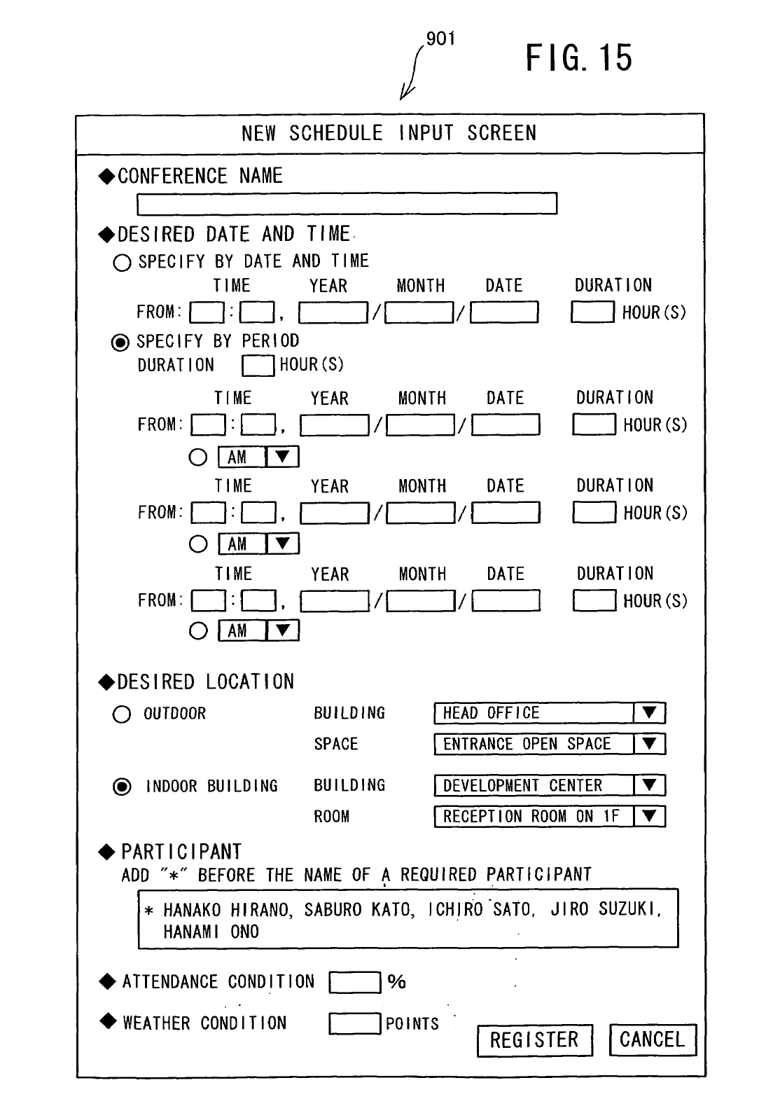

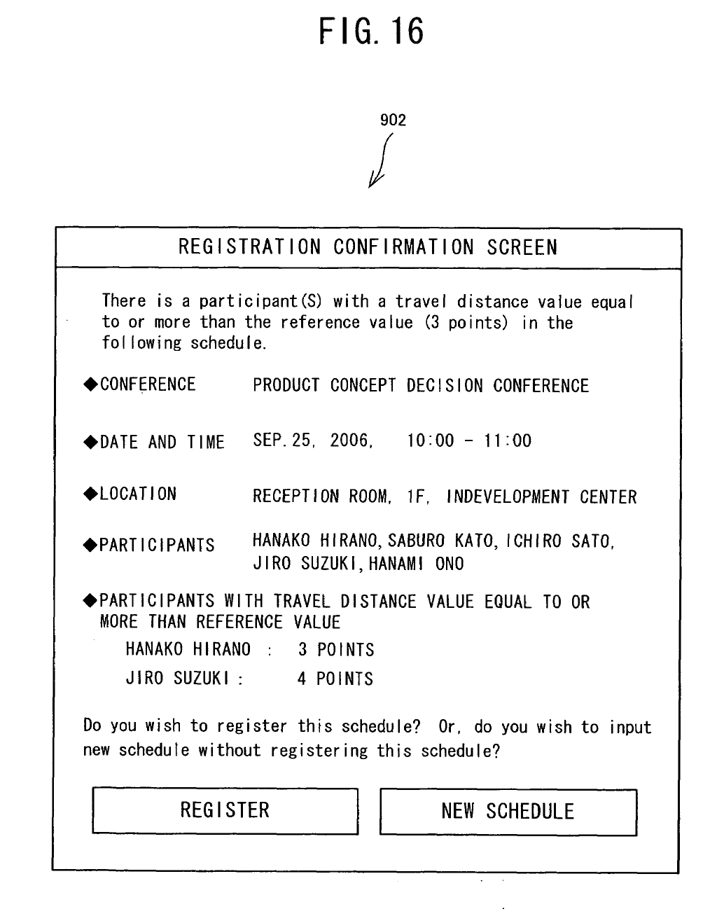

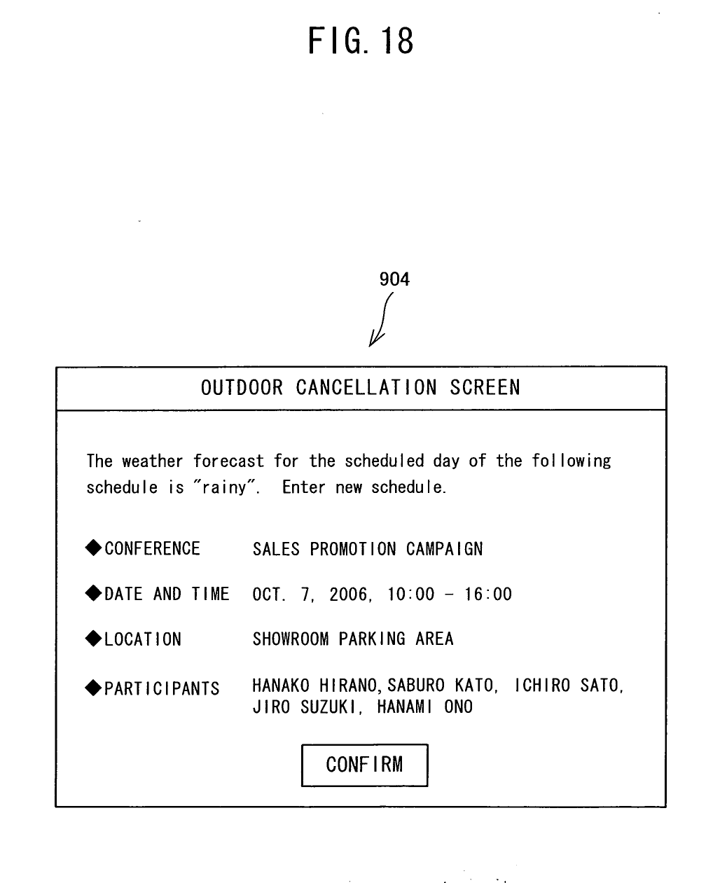

As shown in FIG. 4, the hard disk drive 18 of the user terminal 10 is provided with a terminal program storage area 181, in which a terminal program operable on the user terminal 10 is stored. The terminal program may cause the new schedule input screen 901 (See FIG. 15) to be displayed to make the user input a new schedule. The terminal program may also transmit desired information, which is information inputted via the new schedule input screen 901, to the server 20. The terminal program may also cause an information screen (See FIG. 16 and FIG. 18) to be displayed after receiving information transmitted from the server 20.

As shown in FIG. 5, the hard disk drive 28 of the server 20 is provided with a person database (DB) storage area 281, a location database (DB) storage area 282, a weather forecast database (DB) storage area 283, a personal schedule database (DB) storage area 284, a reservation status storage area 285, a travel distance value storage area 286, and a server program storage area 287.

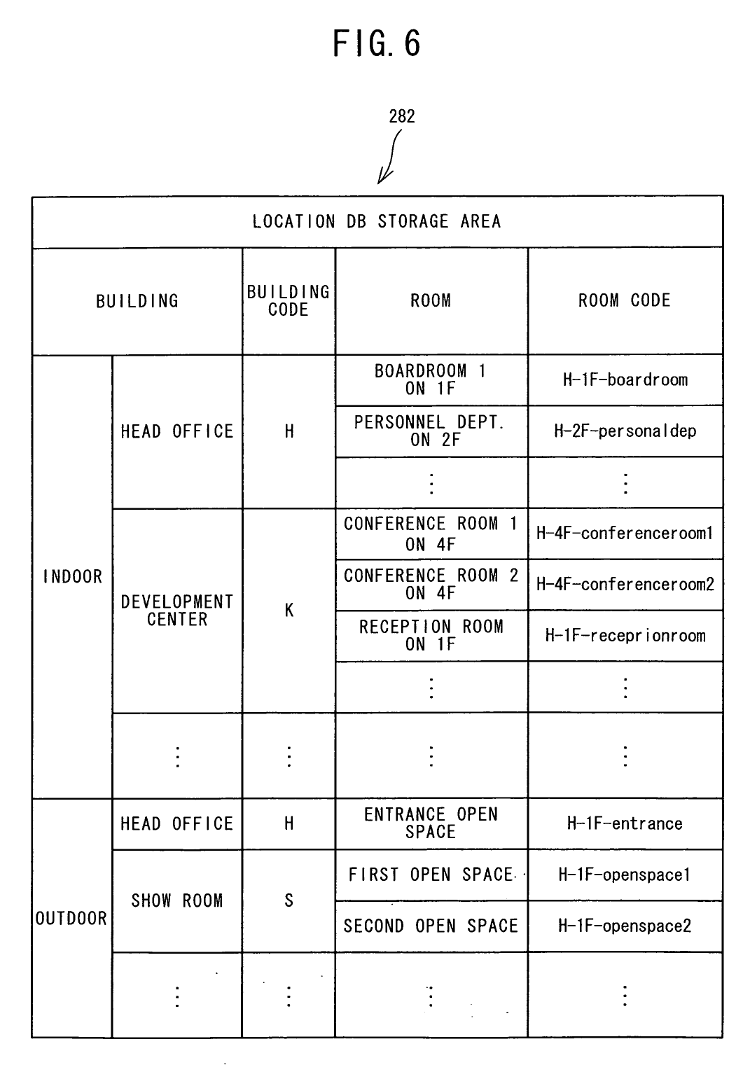

The person DB storage area 281 stores information about persons who may attend a conference arranged by the processing in the present embodiment. The location DB storage area 282 stores information about locations that may be designated as a site of a conference arranged by the processing in the present embodiment (See FIG. 6). What is registered as a schedule by the processing in the present embodiment is not limited to a plan of “conference”, and may be a plan of an event or other kinds of meetings, etc.

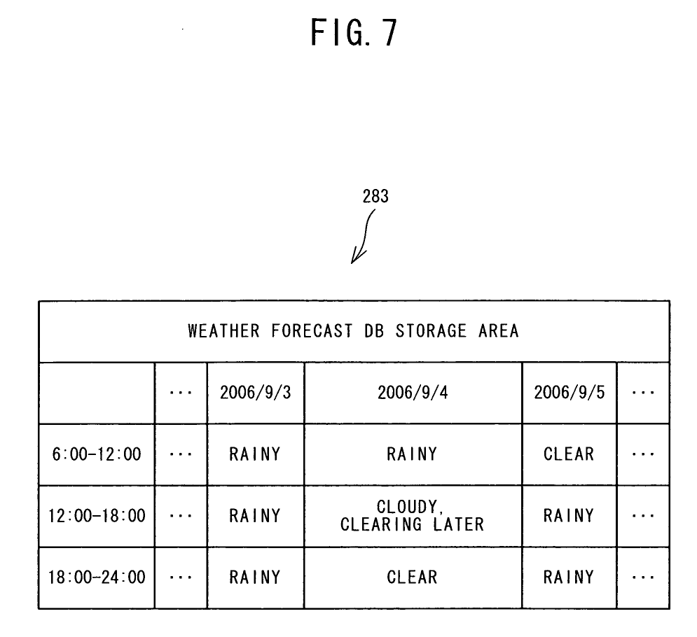

The weather forecast DB storage area 283 stores weather forecasts acquired from the weather forecast terminal 7 (See FIG. 7). Times at which the weather forecasts are made public may be registered with the server 20 in advance and the server 20 may connect to the weather forecast terminal 7 at such times to acquire the latest weather forecast, which is stored into the weather forecast DB storage area 283.

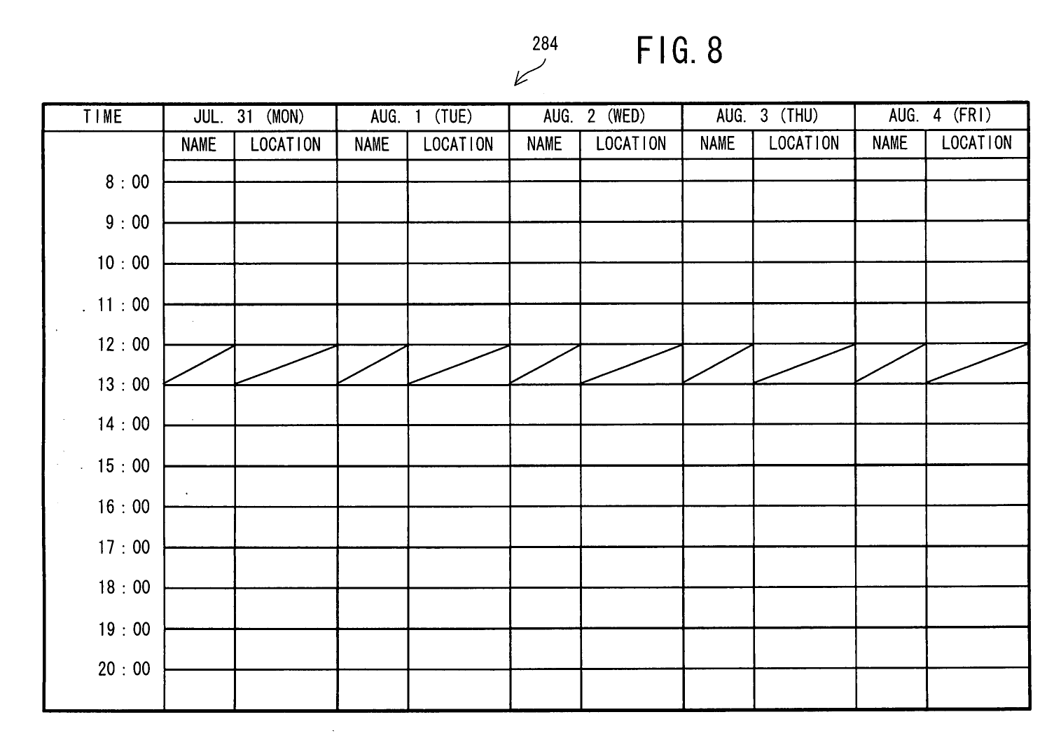

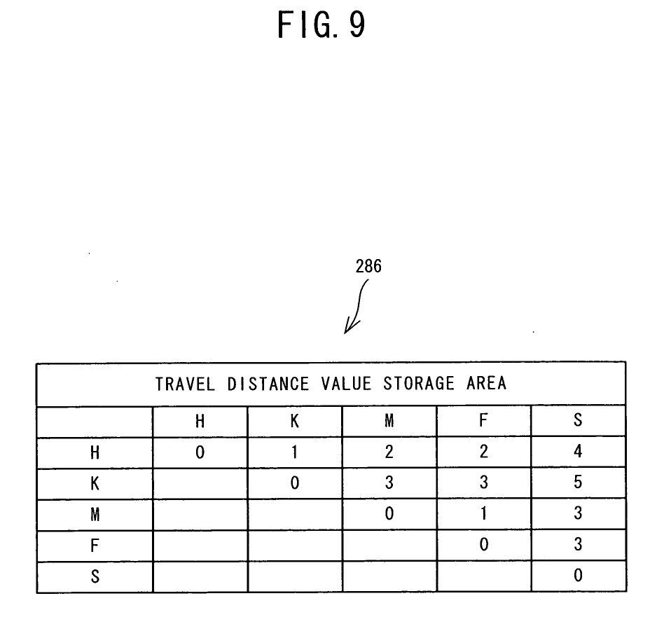

The personal schedule DB storage area 284 stores schedules of a plurality of users whose schedules may be managed by the processing in the present embodiment (See FIG. 8). The reservation status storage area 285 stores reservation status for each of the locations stored in the location DB storage area 282. The travel distance value storage area 286 stores values each indicating a magnitude of a travel distance between each location and another location stored in the location DB storage area 282, (See FIG. 9). The server program storage area 287 stores a server program that arranges a schedule upon receiving the desired information from a user terminal.

As shown in FIG. 6, the location DB storage area 282 is provided with a building field, a building code field, a room field, and a room code field. In the building field, names of buildings that may be registered as a location of a conference may be stored. In the building code field, codes that respectively indicate the buildings may be stored. In the room field, names of rooms in each building may be stored. In the room code field, codes that respectively indicate the rooms may be stored. The data stored in the location DB storage area 282 may be roughly divided into data indicating “indoor” locations and data indicating “outdoor” locations so that each location may be identified whether the location is indoors or outdoors.

Next, the weather forecast DB storage area 283 will be described with reference to FIG. 7. As shown in FIG. 7, the weather forecast is stored for each time zone of each day. In the present example, the weather forecasts are stored for three time zones of “6:00-12:00”, “12:00-18:00”, and “18:00-24:00”. The weather concerning clear skies will be hereinafter called a “clear weather”, and a date and time at which a “clear weather” is forecast will be hereinafter called a “clear date and time”. The weather concerning rain, snow, hail, sleet, or mist will be hereinafter called a “rainy weather” and a date and time at which a “rainy weather” is forecast will be hereinafter called a “rainy date and time”.

Next, the personal schedule DB storage area 284 will be described with reference to FIG. 8. The personal schedule DB storage area 284 stores information for a predetermined period (for example, one year from today), for each of the persons whose personal information is stored in the person DB storage area 281. In the present embodiment, as shown in FIG. 8, in the personal schedule DB storage area 284, a name and a location of a scheduled event may be stored for each time zone. Information about names of other participants and the like may also be stored.

Next, the travel distance value storage area 286 will be described with reference to FIG. 9. As shown in FIG. 9, the travel distance value storage area 286 is a two-dimensional array, and elements in the rows and columns are values stored in the building code field in the location DB storage area 282. In the example shown in FIG. 9, travel distance values are stored for five locations of “H”, “K”, “M”, “F” and “S”. The travel distance value indicates a magnitude of a distance between the buildings. For example, the travel distance value of “H” and “M” is “2”, and the travel distance of “H” and “S” is “4”. A larger value of the travel distance value indicates a longer travel distance. For example, the above-mentioned values indicate that the building “S” is farther away than the building “M” from the building “H”.

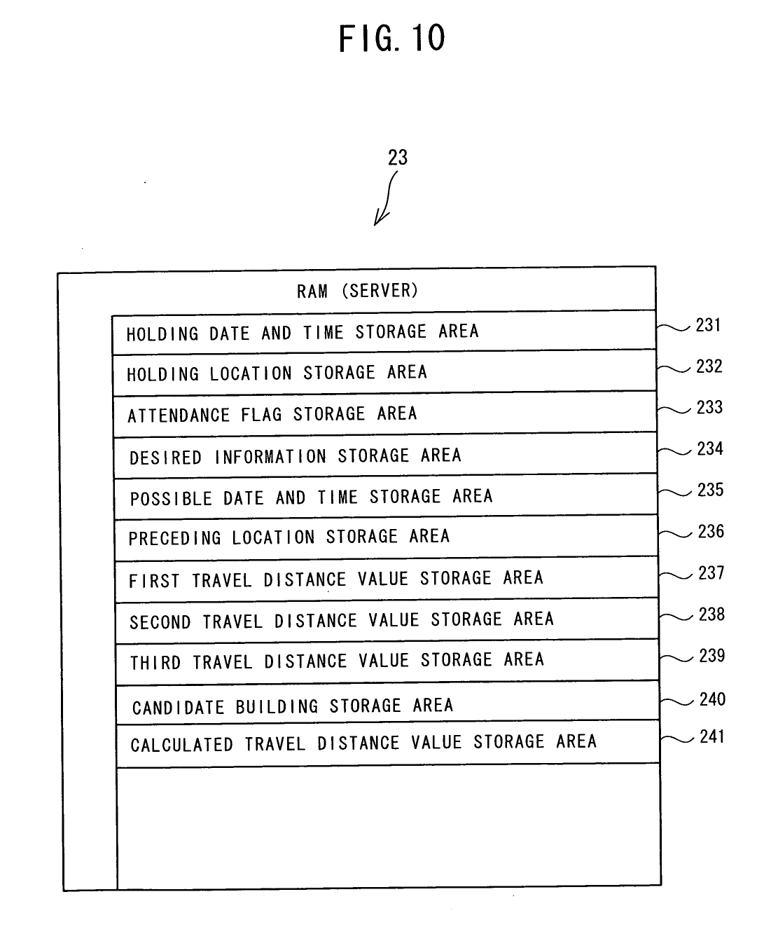

Next, storage areas provided in the RAM 23 of the server 20 will be described with reference to FIGS. 10 to 13. As shown in FIG. 10, the RAM 23 of the server 20 is provided with a holding date and time storage area 231, a holding location storage area 232, an attendance flag storage area 233, a desired information storage area 234, a possible date and time storage area 235, a preceding location storage area 236, a first travel distance value storage area 237, a second travel distance value storage area 238, a third travel distance value storage area 239, a candidate building storage area 240, and a calculated travel distance value storage area 241. Other storage areas may also be provided in the RAM 23, though not shown in FIG. 10. The user terminal 10 is controlled so that the above information is stored into predetermined storage areas of the hard disk drive 18 when the user terminal 10 is turned off, and subsequent processing may be performed when the user terminal 10 is activated next time.

In the holding date and time storage area 231, a date and time determined as a date and time for holding a conference may be stored as a “holding date and time”. In the holding location storage area 232, a code of a location determined as a location for holding a conference may be stored as a “holding location”. In the attendance flag storage area 233, an attendance flag that indicates an attendance status of participants in the conference may be stored, based on attendance responses from the participants. In the desired information storage area 234, the desired information transmitted from the user terminal 10 may be stored.

In the possible date and time storage area 235, a possible date(s) and time(s) may be stored while a new schedule is arranged. The possible date and time is a date and time at which all participants can attend the conference (at which other schedules are not registered) among desired dates and times. The desired date and time is a date and time inputted from the new schedule input screen 901 (see FIG. 5). In the preceding location storage area 236, a value indicating a location where each participant is located immediately before the holding date and time may be stored. The location where a participant is located immediately before the holding date and time is hereinafter referred to as a “preceding location” of a participant.

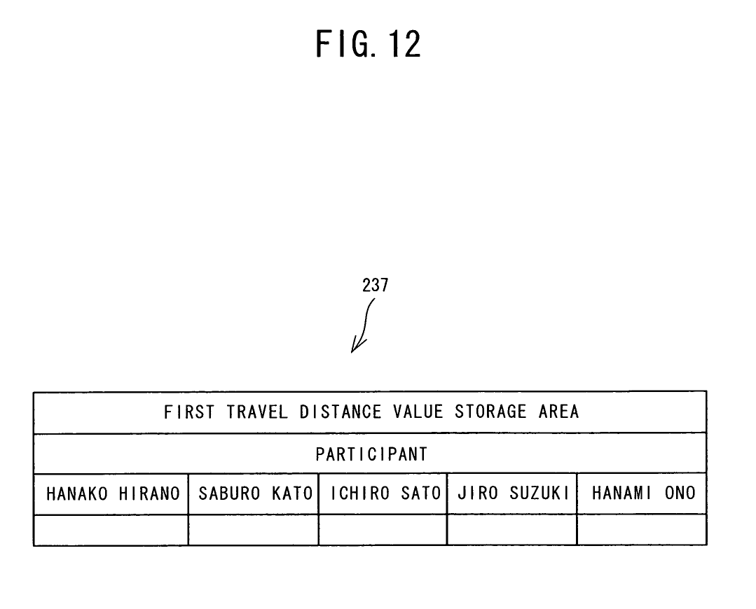

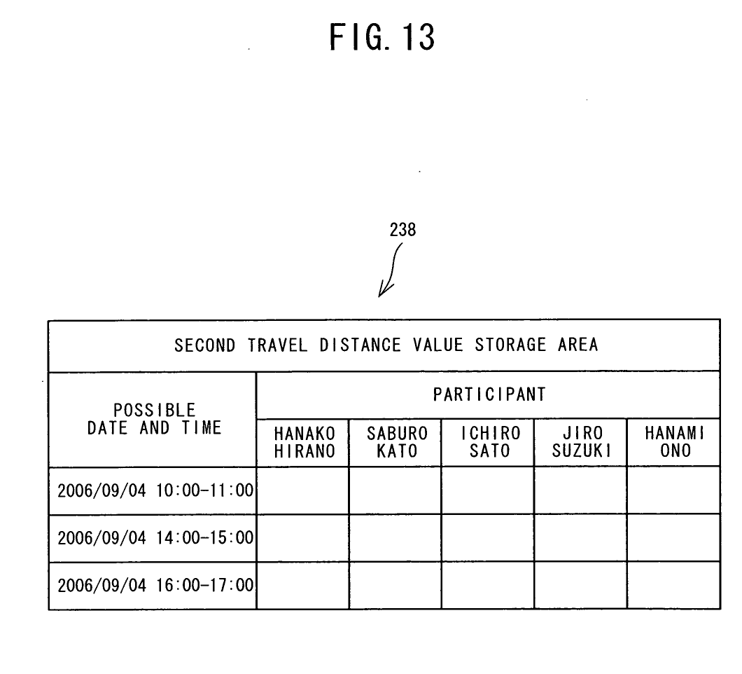

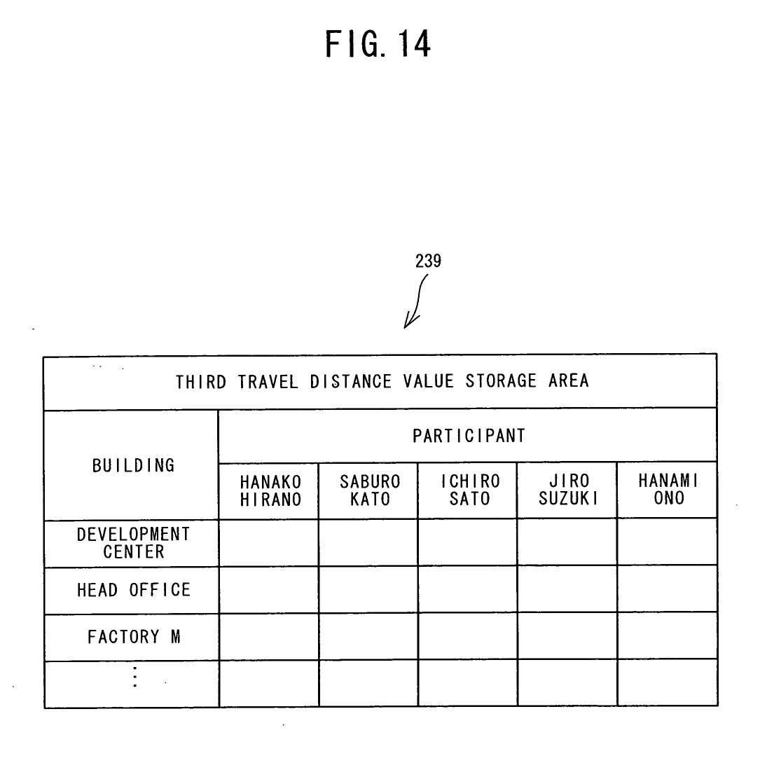

In the first travel distance value storage area 237, a travel distance value for a travel between the preceding location and the holding location (See FIG. 12) may be stored, if the location where the conference will be held is specified. In the second travel distance value storage area 238, a travel distance value for a travel between the building of holding location and the preceding location for each possible date and time (See FIG. 13) may be stored. In the third travel distance value storage area 239, a travel distance value for a travel between the preceding location and each candidate building (See FIG. 14) may be stored, if the location where the conference will be held is not specified. In the candidate building storage area 240, a building code that indicates a building chosen as a candidate building for the holding location (room) may be stored. In the calculated travel distance value storage area 241, a calculated travel distance value calculated from the travel distance values may be stored.

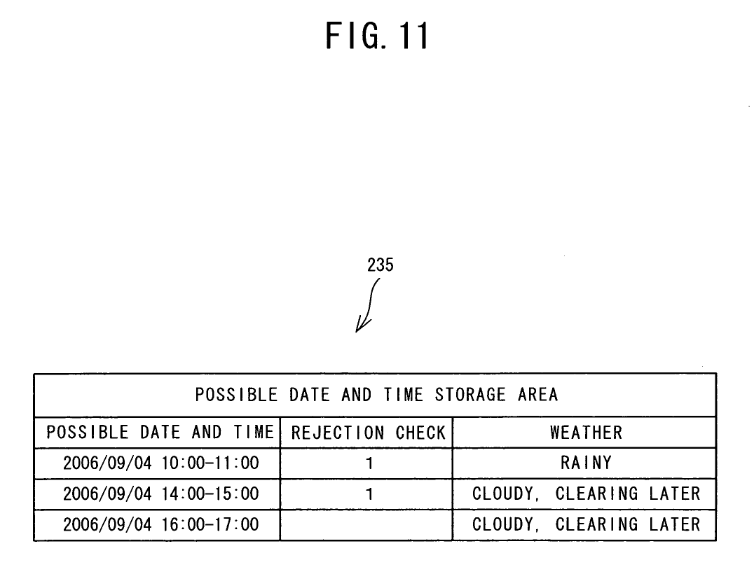

As shown in FIG. 11, the possible date and time storage area 235 has a possible date and time field, a rejection check field, and a weather field. In the possible date and time field, among the desired dates and times, a date and time when schedules of all participants are available may be stored. In the rejection check field, a value (for example, “1”) indicating that the possible date and time is rejected may be stored, if the date and time is examined and is not chosen as the holding date and time. In the weather field, the weather forecast acquired from the server 20 may be stored.

As shown in FIG. 12, the first travel distance value storage area 237 is provided with a participant field. In the participant field, a travel distance value for a travel from the preceding location (building) to the specified holding location may be stored for each of the participants. The preceding location of each participant is stored in the preceding location storage area 236.

As shown in FIG. 13, the second travel distance value storage area 238 is provided with a possible date and time field and a participant field. The travel distance value for a travel between the preceding location (building) and the holding location for each possible date and time may be stored for each of the participants in the second travel distance value storage area 238. The preceding location of each participant is stored in the preceding location storage area 236.

As shown in FIG. 14, the third travel distance value storage area 239 is provided with a building field and a participant field. The travel distance value for a travel between the preceding location and each building may be stored. All the buildings stored in the location DB storage area 282 are stored in the building field.

Next, screens to be displayed on the user terminal 10 will be described with reference to FIGS. 15 to 18. The new schedule input screen 901 shown in FIG. 15 may be displayed on the display 14 when the terminal program is started and registration of a new schedule is instructed at the user terminal 10. As shown in FIG. 15, a conference name input field, desired date and time input fields, desired location input fields, a participant input field, an attendance condition input field, a weather condition input field, a “Register” button and a “Cancel” button are provided.

The name of a new schedule may be inputted into the conference name input field. The desired date and time input fields include “Specify by date and time” and “Specify by period” radio buttons. When the “Specify by date and time” radio button is selected, the start date and time and a duration of the conference may be inputted. When the “Specify by period” radio button is selected, a duration and a desired time zone for the conference may be inputted. In the example shown in FIG. 15, three desired time zones can be inputted. Input fields for a date, the start time of each time zone and the duration, and a list box for specifying am or pm are provided for each time zone.

The desired location input fields include “Outdoor” and “Indoor” radio buttons. When the “Outdoor” radio button is selected, a list box to select a building and a list box to select a space may be selectable. In the list box to select a building, names of buildings stored in the building field of data stored as “outdoor” in the location DB storage area 282 may be set as options. In the list box to select a space, names of outdoor spaces stored in the room field of data stored as “Outdoor” may be set as options. When the “Indoor” radio button is selected, a list box to select a building and a list box to select a room are selectable. In the list box to select a building, names of building stored in the building field of data stored as “indoor” in the location DB storage area 282 may set as options. In the list box of room selection, names of rooms stored in the room field of data stored as “Indoor” may be set as options.

Names of participants may be inputted into the participant field. Here, a participant who is requested to necessarily attend the conference is called a “required participant”, and the name of the required participant is instructed to be preceded by a mark “*”. A value of percentage of attendants required for a schedule to be formally fixed may be inputted into the attendance condition input field. In the weather condition input field, a reference value may be inputted. The reference value is used to determine whether the holding location is too far away when the weather is not a clear weather, based on the travel distance value, which is a value related to the travel distance of the participants.

When the Register button is selected, information inputted via the new schedule input screen 901 is transmitted to the server 20 as “desired information”. When the Cancel button is selected, input information is discarded and the information is not transmitted to the server 20.

Next, the registration confirmation screen 902 will be described with reference to FIG. 16. If there is any participant whose travel distance value is equal to or more than a reference value, information about such a participant is transmitted from the server 20 to the user terminal 10 of a user who drafted the schedule (hereinafter referred to as a “drafter”). Then, the registration confirmation screen 902 shown in FIG. 16 is displayed on the display 14.

As shown in FIG. 16, a conference name, a date and time, a location, names of participants are displayed in the registration confirmation screen 902 as a content of the schedule. In addition, a message saying, for example, “The travel distance value is equal to or more than the reference value” is displayed, and a “Register” button and a “New schedule” button are provided below the message. If the “Register” button is selected, information indicating the selection is transmitted to the server 20 and the server 20 stores the schedule under examination in the personal schedule DB storage area 284 for each participant.

If the “New schedule” button is selected, information indicating the selection is transmitted to the server 20, the schedule under examination is discarded, and the schedule input screen 901 is newly displayed. Further, a name(s) of a participant(s) whose travel distance value is equal to or more than the reference value and the travel distance value of the participant may be displayed in the registration confirmation screen 902. Thus, the drafter can use such information to determine whether to select the “Register” button or to select the “New schedule” button.

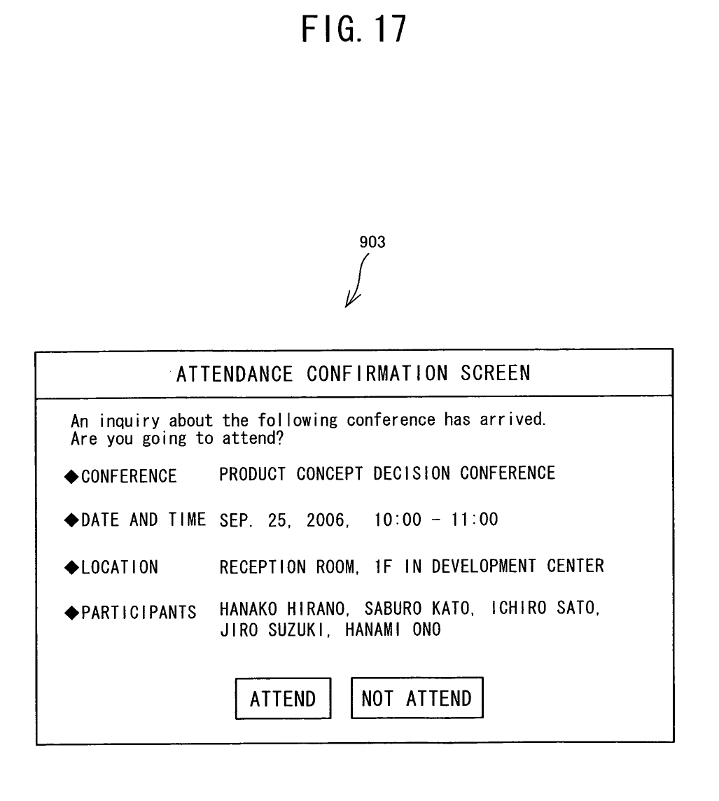

Next, the attendance confirmation screen 903 will be described with reference to FIG. 17. When the holding date and time and the holding location for a schedule have been finally fixed, the attendance confirmation screen 903 may be used to make an inquiry about whether or not each participant can attend the conference to be held according to the determined schedule. As shown in FIG. 17, a conference name, a date and time, a location, and participants are displayed in the attendance confirmation screen 903 as a content of the schedule. In addition, an “Attend” button and a “Not Attend” button are displayed. If the “Attend” button is selected, information indicating that the user will attend the conference and identifying the user is transmitted to the server 20. If the “Not Attend” button is selected, information indicating that the user will not attend the conference and identifying the user is transmitted to the server 20.

Next, the outdoor cancellation screen 904 will be described with reference to FIG. 18. If the holding location is outdoors and the weather at the holding date and time is not expected to be clear, the outdoor cancellation screen 904 may be used to notify the drafter thereof. As shown in FIG. 18, a conference name, a date and time, a location, and participants are displayed in the outdoor cancellation screen 904 as a content of the schedule. Moreover, a “Confirm” button is provided. If the “Confirm” button is selected, the outdoor cancellation screen 904 will be closed.

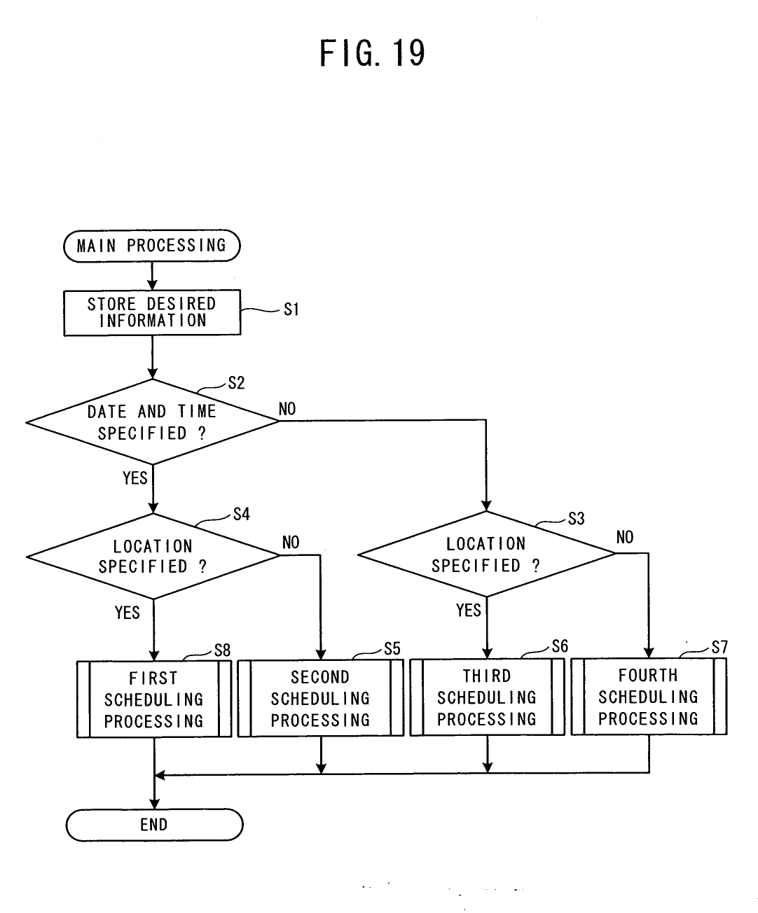

Next, processing to arrange a schedule that is performed by the CPU 21 of the server 20 according to a server program will be described with reference to FIGS. 19 to 29. First, main processing will be described with reference to FIG. 19. The main processing may be started when entries are made via the new schedule input screen 901 in the user terminal 10 and the server 20 receives the desired information, which is the input information.

In the processing, the desired information may be classified as one of four cases depending on a content of the desired information, and processing in accordance with the case will be performed. More specifically, the four cases include a case where “only one date and time and only one location are specified”, a case where “only one location is specified”, a case where “only one date and time is specified”, and a case where “neither only one date and time nor only one location is specified”. In the following description, the user terminal 10 of the drafter, where entries via the new schedule input screen 901 were made, is called the user terminal 11.

First, the received desired information is stored into the desired information storage area 234 (S1). Here, if a date and time is not specified as a desired date and time, business hours during one week after today, for example, may be assumed to be the desired date and time. If today is September 1 (Fri), 9:00-18:00 in each day of September 4 (Mon) to September 8 (Fri) may be assumed to be the desired dates and times. Then, it is determined whether only one date and time is specified as the desired date and time and thus, the date and time is already fixed (S2). At this step, it may be determined that the date and time is already fixed, if the “Specify by date and time” radio button has been selected in the desired date and time input fields of the new schedule input screen 901 (See FIG. 15) and only one date and time has been specified (Yes at S2).

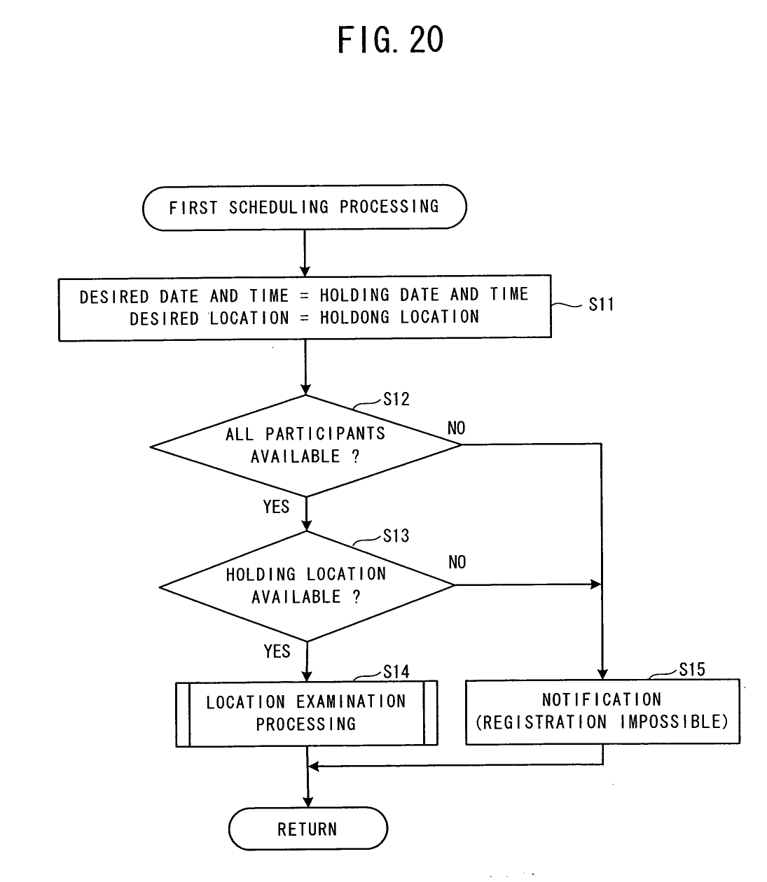

Then, it is determined whether only one location is specified and thus, the location is already fixed (S4). At this step, it may be determined that the location is already fixed, if a specific room or space has been selected in the desired location input fields of the new schedule input screen 901 (Yes at S4). Such a case corresponds to the case where “only one date and time and only one location are specified”. Then, first scheduling processing will be performed (S8, See FIG. 20).

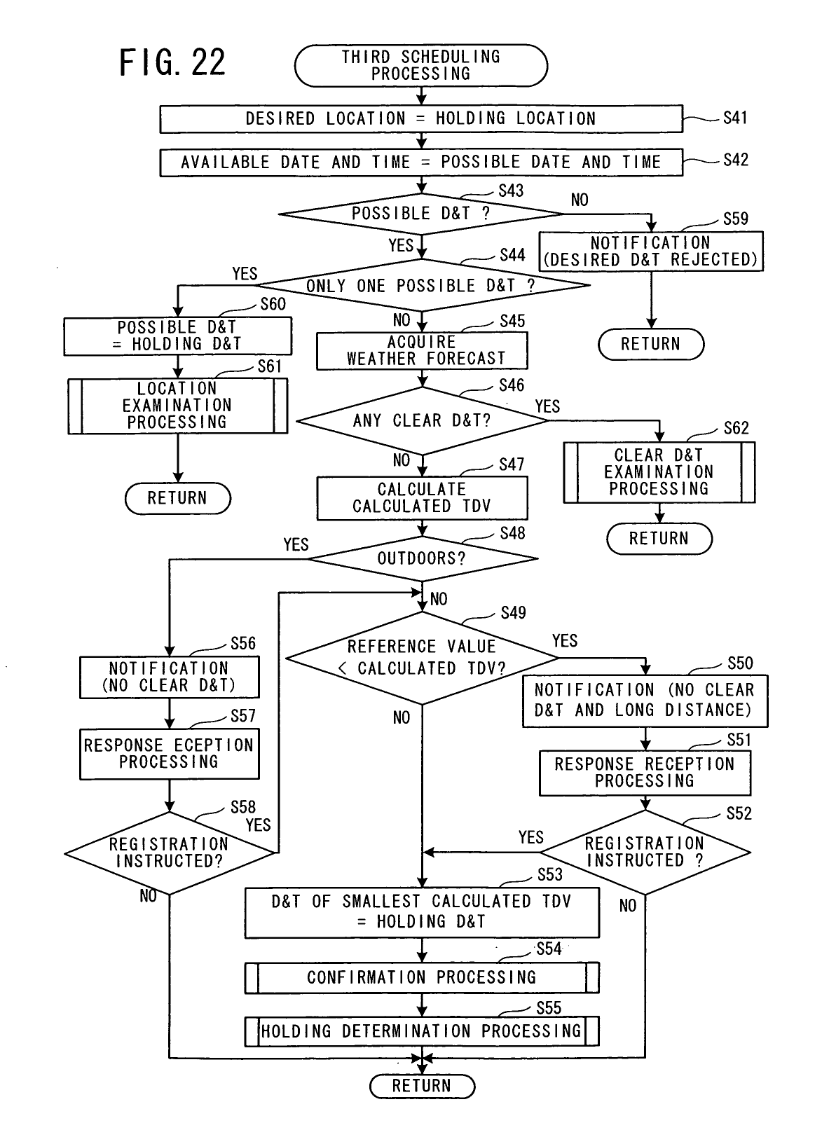

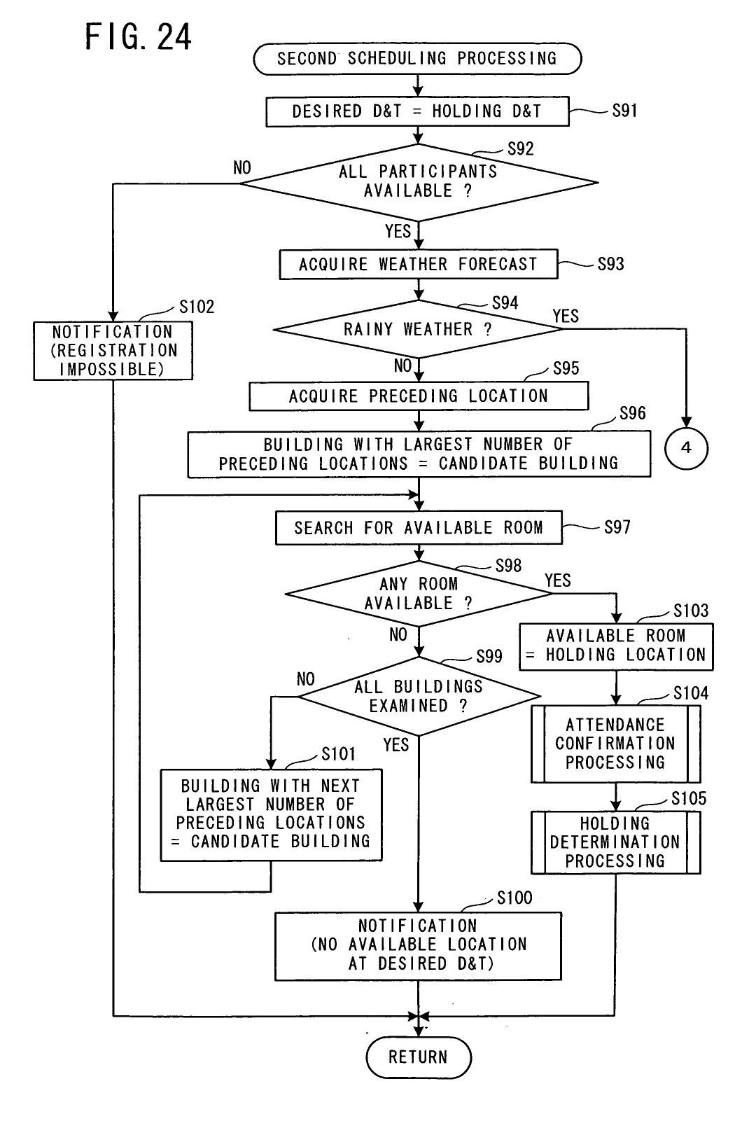

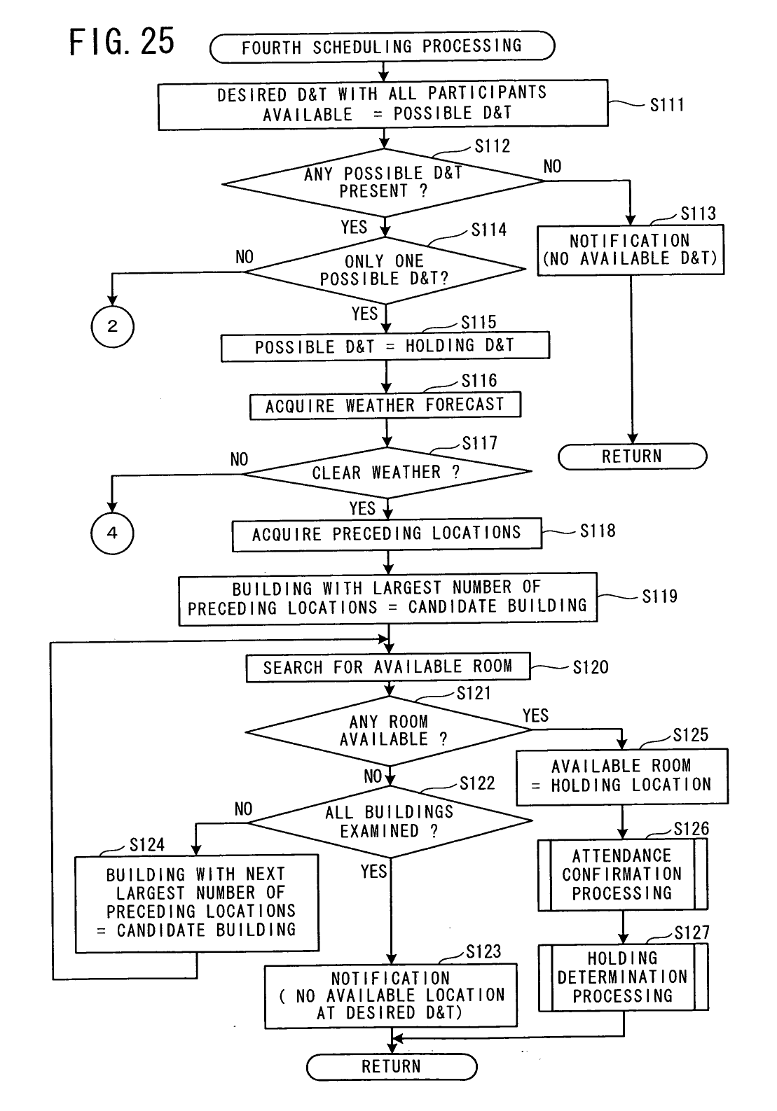

If the date and time is already fixed (Yes at S2), but the location is not fixed yet (No at S4), the case where “only one date and time is specified” applies. Then, second scheduling processing will be performed (S5, See FIG. 24). If the date and time is not fixed (No at S2), but the location is fixed (Yes at S3), the case where “only one location is specified” applies. Then, third scheduling processing will be performed (S6, See FIG. 22). If neither date and time (No at S2) nor location is fixed (No at S3), the case “neither only one date and time nor only one location is specified” applies. Then, fourth scheduling processing will be performed (S7, See FIG. 25).

The first scheduling processing (S8, See FIG. 20), the second scheduling processing (S5, See FIG. 24), the third scheduling processing (S6, See FIG. 22), and the fourth scheduling processing (S7, See FIG. 25) will be described below in this order.

The first scheduling processing that is performed in a case where “only one date and time and only one location are specified” will be described with reference to a flowchart in FIG. 20. In this case, the desired date and time contained in the desired information includes only one specified date and time, and the desired location contained in the desired information includes only one specified room (space). For example, one hour between 10:00-11:00 of Sep. 25, 2006, may be specified as the desired date and time, and the room “Reception room on 1F” of the building “Development Center” may be specified as the desired location.

First, the desired date and time is stored into the holding date and time storage area 231 as the holding date and time, and the desired location is stored into the holding location storage area 232 as the holding location (S11). Then, the schedule for the holding date and time (10:00-11:00 of Sep. 25, 2006) of each participant is read from the personal schedule DB storage area 284 to determine whether the schedules of all the participants are available for the holding date and time (S12).

If the schedules of all the participants are available (Yes at S12), the reservation status storage area 285 is referenced to determine whether the holding location (the room “Reception room on 1F” of the building “Development Center” in the example) is available (S13). If the schedules of all the participants are not available (No at S12), or if the holding location is already reserved for another schedule (No at S13), information to display a message screen is transmitted to the user terminal 11 of the drafter (S15). The message screen indicates that the schedule cannot be fixed at the desired date and time and at the desired location, and that conditions need to be changed. Then, the first scheduling processing terminates to return to the main processing in FIG. 19, which will also terminate.

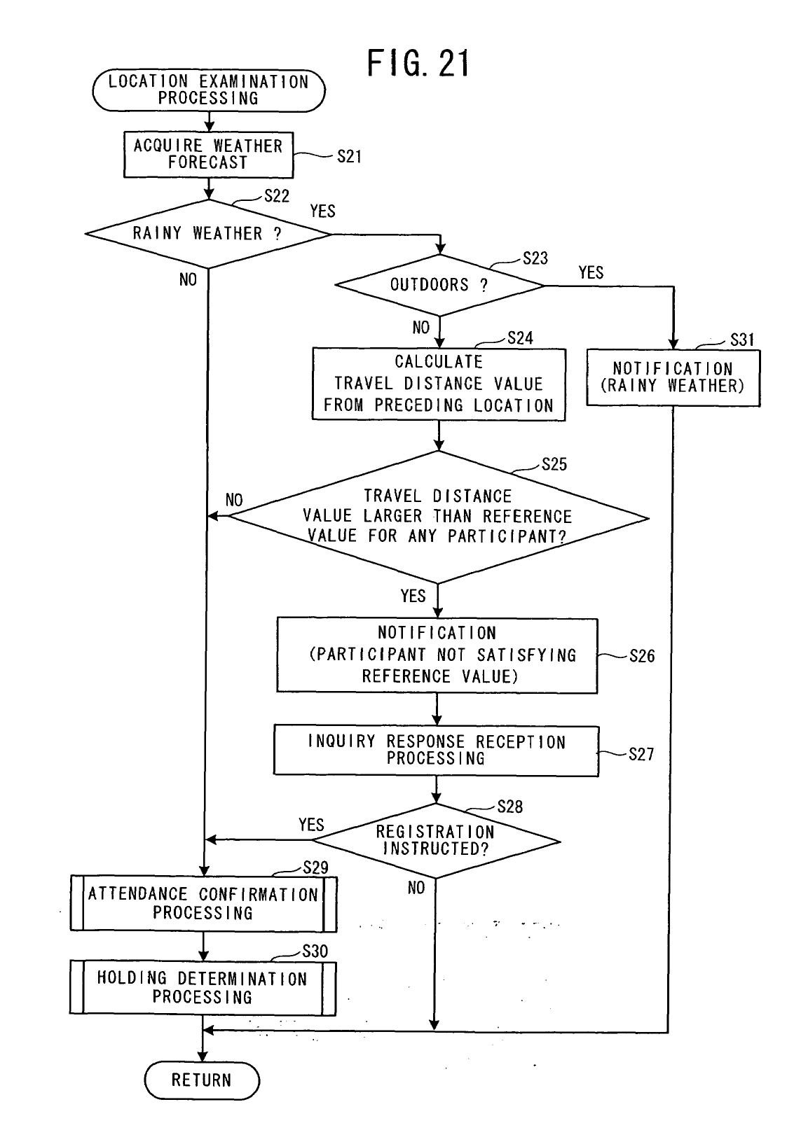

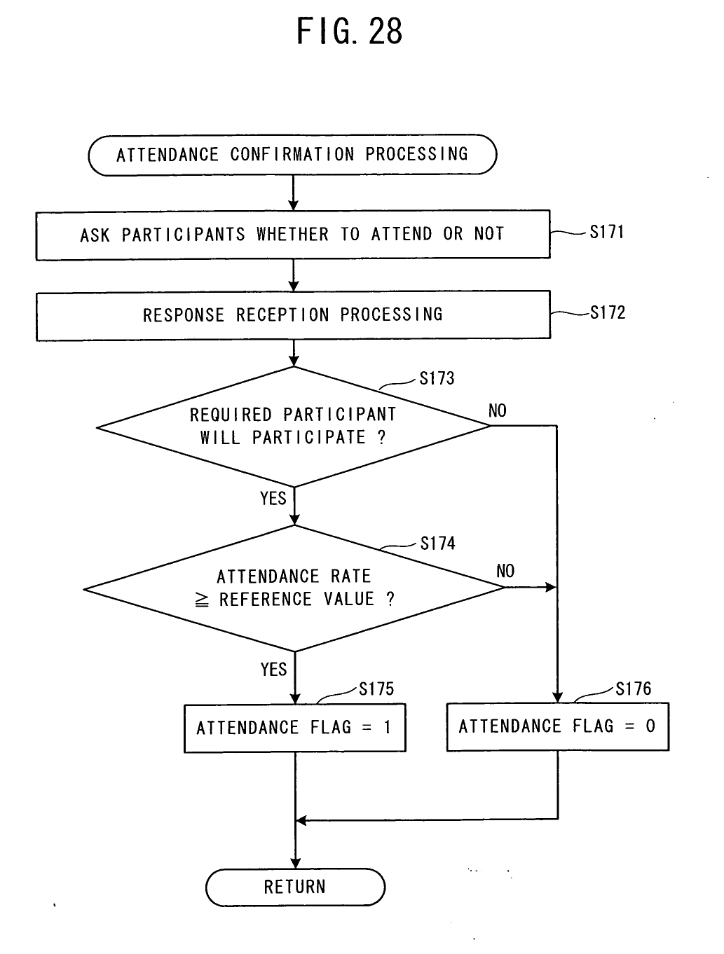

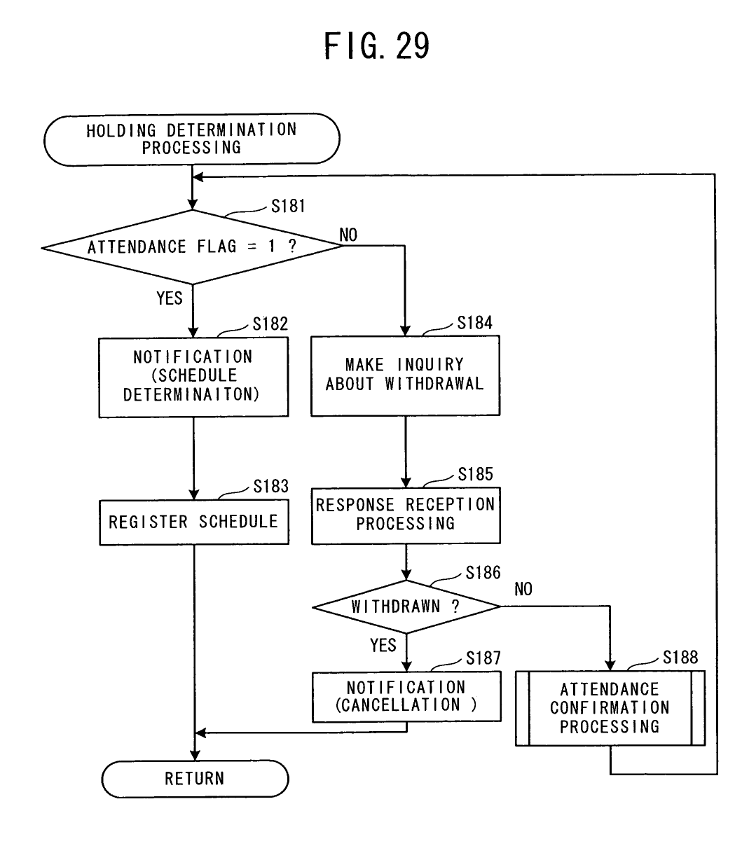

If the holding location is available (Yes at S13), location examination processing is performed (S14, See FIG. 21). As shown in FIG. 21, in the location examination processing, the weather forecast at the holding date and time is first referenced. If a rainy weather is forecast, and if the holding location is outdoors or the travel distance value is larger than the reference value, steps are taken. Specifically, following the start of the processing, the weather forecast for the holding date and time is acquired from the weather forecast DB storage area 283 (S21). Then, whether a rainy weather is forecast is determined (S22). If the forecast weather is not rainy (No at S22), attendance confirmation processing is performed (S29, See FIG. 28), and holding determination processing is performed (S30, See FIG. 29). Then, the location examination processing terminates to return to the first scheduling processing shown in FIG. 20. Further, the first scheduling processing also terminates to return to the main processing, which will also terminate.

If the weather is rainy (Yes at S22), it is determined whether the holding location is outdoors (S23). If the holding location is determined to be outdoors by the location DB storage area 282 being referenced (Yes at S23), information to display the outdoor cancellation screen 904 (See FIG. 18) is transmitted to the user terminal 11 of the drafter (S31). The outdoor cancellation screen 904 indicates that a rainy weather is forecast for the desired date and time. Then, the location examination processing terminates to return to the first scheduling processing. Further, the first scheduling processing also terminates to return to the main processing, which will also terminate.

If the holding location is not outdoors (No at S23), the preceding location is read from the personal schedule DB storage area 284 for each participant, and stored into the preceding location storage area 236. Further, the travel distance value for a travel from the preceding location to the holding location is read from the travel distance value storage area 286 for each participant, and stored into the first travel distance value storage area 237 (S24). For a participant who is in “Head office” immediately before the holding date and time, for example, if the holding location is “Development center”, the travel distance value for a travel between “Head office (H)” and “Development center (K)” may be set as “1”.

Then, it is determined whether there is any participant whose travel distance value is larger than the reference value (S25). If there is no participant whose travel distance value is larger than the reference value (No at S25), the travel distance may not matter even under the rainy weather. Thus, the attendance confirmation processing is performed (S29, See FIG. 28) and the holding determination processing is performed (S30, See FIG. 29) to terminate the location examination processing before returning to the first scheduling processing. Further, the first scheduling processing also terminates to return to the main processing, which will also terminate.

On the other hand, if there is any participant whose travel distance value is larger than the reference value (Yes at S25) when the rainy weather is forecast, a long travel distance may cause a problem. Thus, information to display the registration confirmation screen 902 (See FIG. 16) is transmitted to the user terminal 11 of the drafter (S26). The registration confirmation screen 902 indicates that there is a participant whose travel distance value does not satisfy the reference value with the desired location. Then, inquiry response reception processing to receive a response from the user terminal 11 is performed (S27). When the registration confirmation screen 902 is displayed in the user terminal 11, “Register” button or “New schedule” button is selected by the drafter. Then, information showing a selection result is transmitted to the server 20.

If the received result indicates that a registration of the schedule is instructed (Yes at S28), the attendance confirmation processing is performed (S29, See FIG. 28) and the execution determination processing is performed (S30, See FIG. 29) to terminate the location examination processing. If the received result indicates that an arrangement of a new schedule is instructed (No at S28), the location examination processing terminates. In both cases, the processing returns to the first scheduling processing and then, the first scheduling processing also terminates to return to the main processing, which will also terminate. If “New schedule” button is selected on the registration confirmation screen 902, the schedule input screen 901 (See FIG. 15) is newly displayed by the terminal program of the user terminal 10.

Here, the attendance confirmation processing will be described with reference to the flowchart of FIG. 28. As shown in FIG. 28, first, information to display the attendance confirmation screen 903 (See FIG. 17) is transmitted to the user terminal 10 of the participants (S171). The attendance confirmation screen 903 notifies each participant of the holding date and time and the holding location of the schedule and to request a response concerning an attendance or absence of the participant. Then, response reception processing for the attendance response or absence response from the user terminal 10 of each participant is performed (S172). Here, if the responses from all the participants are not received during a predetermined period (for example, two days), error processing is performed. For example, a message screen may be caused to be displayed in the user terminal 11 of the drafter, an e-mail may be transmitted to the participants to prompt the participants to return a response (E-mail addresses are assumed to be stored in the person DB storage area 281), or the participant who has not responded may be handled as an absentee.

Next, it is determined whether the attendance response has been received from the required participant (S173).

If the attendance response has not been received (No at S173), “0 (zero)” is stored in the attendance flag (S176), and the attendance confirmation processing is terminated. If the attendance response has been received from the required participant (Yes at S173), an attendance rate is calculated based on the response results and it is determined whether an attendance rate is equal to or more than a reference value (S174).

The reference value may be a value inputted via the attendance condition field of the new schedule input screen 901 (See FIG. 15). If no value has been inputted in this field, a predetermined value, for example, 80% may be used as the reference value. If the attendance rate is less than the reference value (No at S174), “0 (zero)” is stored in the attendance flag (S176), and the attendance confirmation processing is terminated. If, on the other hand, the attendance rate is equal to or more than the reference value (Yes at S174), “1 (one)” is stored in the attendance flag (S175), and the attendance confirmation processing is terminated.

Next, the holding determination processing will be described with reference to a flowchart in FIG. 29. As shown in FIG. 29, first, it is determined whether the attendance flag, in which a value has been stored in the attendance confirmation processing, is “1” is determined (S181). If the attendance flag is “1” (Yes at S181), the schedule may be registered. Thus, information about a screen for notification of a determined schedule is transmitted to the user terminal 10 of participants (S182). Then, the name of the present schedule and the holding location are registered in a storage area allocated to the participants for the holding date and time in the personal schedule DB storage area 284 (S183).

If the attendance flag is not “1” (No at S181), the schedule may not be registered, so that information to display an inquiry screen to make an inquiry about whether to withdraw the present schedule is transmitted to the user terminal 11 of the drafter (S184). Then, response reception processing for the inquiry is performed (S185). The inquiry screen (not shown) may display a content of the schedule, response results concerning an attendance, and attendance rate, and have a “Withdraw” button and a “Reconfirm” button. Thus, the drafter may make a selection from withdrawing the schedule and requesting the participants to return a response again, with reference to the information which is displayed.

If information indicating that the “Withdraw” button has been selected is received in the response reception processing (Yes at S186), information to display a screen indicating the content of the schedule and that the schedule has been canceled is transmitted to the user terminal 10 of the participants and the user terminal 11 of the drafter (S187). Then, the holding determination processing is terminated. If, instead of information indicating that the “Withdraw” button has been selected, information indicating that the “Reconfirm” button has been selected is received (No at S186), the attendance confirmation processing is performed (S188) before returning to step S181.

In a case where “only one date and time and only one location are specified”, as described above, the desired date and time is set as the holding date and time and the desired location is set as the holding location. Then, if all the participants are available at the holding date and time and the holding location is available, the weather forecast at the holding date and time is referenced. If a rainy weather is forecast, the travel distance value for a travel from the preceding location to the holding location is calculated for each participant. If the travel distance value is not larger than the reference value, the registration confirmation screen 902 (See FIG. 16) is displayed in the user terminal 11 of the drafter to prompt the drafter to determine whether to register the schedule.

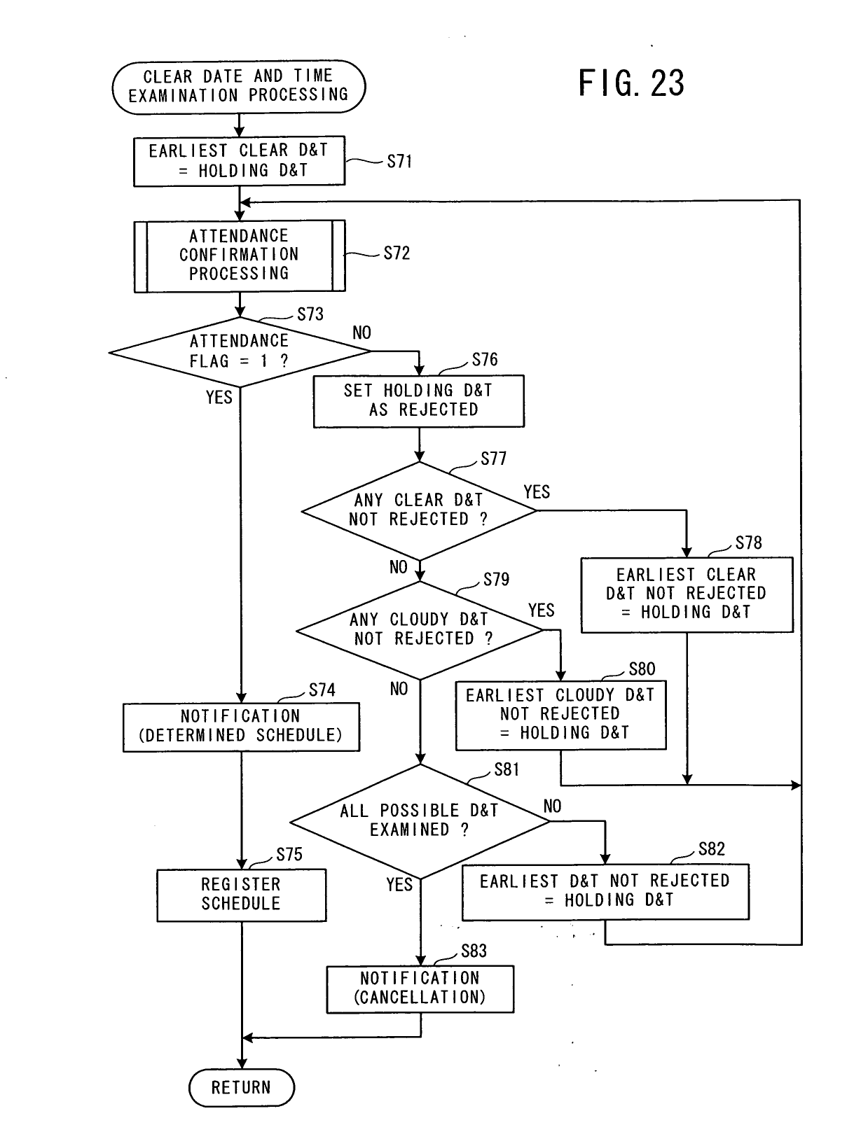

Next, the third scheduling processing that is performed in a case where “only one location is specified” will be described with reference to flowcharts in FIGS. 22 and 23. In the flowcharts to be used with the following description, “D&T” may be used to stand for the term “date(s) and time(s)”, and “TDV” may be used to stand for the term “travel distance value”. In the case where “only one location is specified”, only one desired location is specified, but the desired date and time is not necessarily specified as only one date and time. For example, one hour from 10:00 of Sep. 4, 2006, one hour from 14:00 of Sep. 4, 2006, and one hour from 16:00 of Sep. 4, 2006 may be specified as the desired dates and times, and only one room “Reception room on 1F” of the building “Development Center” may be specified as the “desired location”.

First, the desired location is stored into the holding location storage area 232 as the holding location (S41). Then, the reservation status of the holding location at the desired dates and times is read from the reservation status storage area 285. Then, dates and times at which the holding location is not reserved (is available) are stored into the possible date and time field of the possible date and time storage area 235 as possible dates and times (S42). Then, it is determined whether there is any possible date and time (S43). If any date and time is stored in the possible date and time field of the possible date and time storage area 235, it may be determined that there is any possible date and time (Yes at S43). Therefore, processing proceeds to step S44.

If, on the other hand, no date and time is stored in the possible date and time field of the possible date and time storage area 235, it may be determined that there is no possible date and time (No at S43). In such a case, information to display a message screen that indicates that the desired dates and times are not available transmitted to the user terminal 11 of the drafter (S59). Then, the third scheduling processing terminates to return to the main processing, which will also terminate.

If there is any possible date and time (Yes at S43), it is determined whether there is only one possible date and time (S44). If there is only one possible date and time (Yes at S44), the only one possible date and time is stored into the holding date and time storage area 231 as the holding date and time (S60). In this case, only one holding location and only one holding date and time are fixed. Thus, the location examination processing is performed (S61, See FIG. 21) and then the third scheduling processing terminates to return to the main processing, which will also terminate. The location examination processing is the same as the processing performed at step S14 in the first scheduling processing (See FIG. 20) in the case where “only one date and time and only one location are specified”. Thus, a description thereof is only cited and not repeated here.

If there is more than one possible date and time (No at S44), the weather forecasts of all the possible dates and times are acquired from the weather forecast DB storage area 283, and stored into the weather field of the possible date and time storage area 235 (S45). In the example shown in FIG. 7, the weather in the time zone 6:00-12:00 of September 4 is “rainy”, and the weather in the time zone 12:00-18:00 is “cloudy at first, then clearing”. Accordingly, as shown in FIG. 11, corresponding to the possible date and time “10:00-11:00 of Sep. 4, 2006”, “rainy” may be stored. Corresponding to the possible date and time “14:00-15:00 of Sep. 4, 2006”, “cloudy at first, then clearing” may be stored. Corresponding to the possible date and time “16:00-17:00 of Sep. 4, 2006”, “cloudy at first, then clearing” may be stored. “10:00-11:00 of Sep. 4, 2006” is a date and time at which a rainy weather is forecast and thus regarded as a “rainy date and time”. “14:00-15:00 of Sep. 4, 2006” and “16:00-17:00 of Sep. 4, 2006” are dates and times at which clear weathers are respectively forecast and thus regarded as “clear dates and times”.

Next, it is determined whether there is any clear date and time among the possible dates and times (S46). If no clear weather is stored in the weather field of the possible date and time storage area 235, there is no clear date and time (No at S46). In such a case, calculated travel distance values are calculated for each possible date and time and stored into the calculated travel distance value storage area 241 of the RAM 23 (S47). More specifically, the preceding location is read from the personal schedule DB storage area 284 for each participant and each possible date and time, and stored into the preceding location storage area 236. Then, the travel distance value for a travel from the preceding location to the holding location is read from the travel distance value storage area 286 for each possible date and time and stored into the second travel distance value storage area 238. Then, the smallest travel distance value for each possible date and time is stored into the calculated travel distance value storage area 241 as the calculated travel distance value.

Next, it is determined whether the holding location is outdoors (S48). If the holding location is outdoors (Yes at S48), information to display a message screen that indicates that a clear weather is not forecast at possible dates and times and at the desired location (outdoors) is transmitted to the user terminal 11 of the drafter (S56). A “Register” button and a “New schedule” button are provided to the message screen, and the weather forecasts for the possible dates and times are displayed in the screen. Thus, if the drafter wishes to register the schedule even if the weather is not clear, the “Register” button may be selected. For example, the drafter may wish to register the schedule if the weather forecast is “cloudy”, if the schedule should immediately be registered regardless of the weather, or the like.

Then, reception processing of response information that indicates a selection result transmitted from the user terminal 11 of the drafter is performed (S57). If the response information indicates that a registration of the schedule is instructed (Yes at S58), processing proceeds to step S49. Subsequently, one date and time is selected from the possible dates and times as the holding date and time (S49 to S53), the attendance confirmation processing is performed (S54, See FIG. 28), and the holding determination processing is performed (S55, See FIG. 29). Then, the third scheduling processing terminates to return to the main processing, which will also terminate. If the response information does not indicate that a registration of the schedule is instructed (No at S58), the third scheduling processing terminates to return to the main processing in FIG. 19, which will also terminate.

If the holding location is not outdoors (No at S48), processing directly proceeds to step S49. At step S49, the calculated travel distance values obtained at step S47 and stored in the calculated travel distance value storage area 241 are referenced, and it is determined whether all the calculated travel distance values are larger than the reference value (S49). If all the calculated travel distance value are larger than the reference value (Yes at S49), information to display a message screen is transmitted to the user terminal 11 of the drafter (S50). The message screen indicates that clear weathers are not forecast at possible dates and times and at the desired location, and that some participant(s) will have a long travel distance” A “Register” button and a “New schedule” button are provided to the screen, and the weather forecasts for the possible dates and times and the travel distance values of the participants are displayed in the screen. Thus, if the drafter wishes to register the schedule even if the weather is not clear and some participants have a long travel distance, the “Register” button may be selected. Then, reception processing of response information that indicates a selection result transmitted from the user terminal 11 of the drafter is performed (S51).

If the response information indicates that a registration of the schedule is instructed (Yes at S52), the processing proceeds to step S53. At step S53, the possible date and time corresponding to the smallest calculated travel distance value among the calculated travel distance values stored in the calculated travel distance value storage area 241 is stored into the holding date and time storage area 231 as the holding date and time (S53). Then, the attendance confirmation processing is performed (S54, See FIG. 28) and the holding determination processing is performed (S55, See FIG. 29) to terminate the third scheduling processing before returning to the main processing, which will also terminate. If the response information does not indicate that a registration of the schedule is instructed (No at S52), the third scheduling processing terminates to return to the main processing, which will also terminate.

If any of the calculated travel distance values is equal to or less than the reference value (No at S49), processing directly proceeds to step S53. At step S53, the possible date and time corresponding to the smallest calculated travel distance value among the calculated travel distance values stored in the calculated travel distance value storage area 241 is stored into the holding date and time storage area 231 as the holding date and time (S53). Then, the attendance confirmation processing is performed (S54, See FIG. 28) and the holding determination processing is performed (S55, See FIG. 29) to terminate the third scheduling processing before returning to the main processing, which will also terminate.

Next, a case in which it is determined that there is a clear date and time among the possible dates and times (Yes at S46) will be described. In this case, clear date and time examination processing is performed (S49: See FIG. 23). As shown in FIG. 23, first, the earliest date and time among the clear possible dates and times is set as the holding date and time (S71). More specifically, the earliest date and time among the dates and times corresponding to which a clear weather is stored in the weather field in the possible date and time storage area 235 is taken as the holding date and time, and stored into the holding date and time storage area 231. Because the holding date and time and the holding location are fixed at this step, the attendance confirmation processing is performed (S72, See FIG. 28). The attendance confirmation processing is already described above and thus, a description thereof is only cited and not repeated here.

Next, it is determined whether the attendance flag set in the attendance confirmation processing is “1 (one)” (S73). If the attendance flag is “1” (Yes at S73), the required participants have responded with attendance responses and the attendance rate is equal to or more than the reference value. Thus, information for a screen for notification of the determined schedule is transmitted to the user terminals 10 of the participants (S74). Then, the name of the present schedule and the holding location are registered in the storage area allocated to the participants for the holding date and time in the personal schedule DB storage area 284 (S75). Then, the clear date and time examination processing terminates and the third scheduling processing in FIG. 22 also terminates to return to the main processing in FIG. 19, which will also terminate.

If the attendance flag is not “1” (No at S73), the schedule cannot be registered. Thus, another possible date and time is set as the holding date and time and the attendance confirmation processing is performed again to make an inquiry about attendance of the participants. Specifically, a value (for example, “1 (one)”) indicating a rejection (hereinafter referred to as a “rejection value”) is set in the rejection check field corresponding to the present holding date and time in the possible date and time storage area 235 (S76). Then, it is determined whether there is any other clear date and time among the possible dates and times for which the rejection value is not stored in the rejection check field in the possible date and time storage area 235 (S77). If there is such clear dates and times (Yes at S77), the earliest of these dates and times is set as the holding date and time (S78). Then, the processing returns to step S72 to perform the attendance confirmation processing (S72).

If, after the attendance confirmation processing, the attendance flag is “1” (Yes at S73), the determined schedule is notified (S74) and the schedule is stored into the personal schedule DB storage area 284 (S75), before the clear date and time examination processing terminates. Further, the third scheduling processing terminates to return to the main processing, which will also terminate.

If the attendance flag is not “1” (No at S73) and there is no clear date and time among the possible dates and times for which the rejection value is not set in the rejection check field in the possible date and time storage area 235 (No at S77), it is determined whether there is any cloudy date and time (S79). If there are any such cloudy dates and times (Yes at S79), the earliest of these dates and times is set as the holding date and time (S80). Then, the processing returns to step S72 to perform the attendance confirmation processing (S72). If, after the attendance confirmation processing, the attendance flag is “1” (Yes at S73), the determined schedule is notified (S74) and the schedule is stored into the personal schedule DB storage area 284 (S75) before the clear date and time examination processing terminates. Further, the third scheduling processing terminates to return to the main processing, which will also terminate.

If the attendance flag is not “1” (No at S73) and there is neither clear date and time nor cloudy date and time among the possible dates and times for which the rejection value is not set (No at S77, No at S79), it is determined whether a rejection value is stored in all the rejection check fields. In other words, it is determined whether all the possible dates and times have been examined (S81). If all the possible dates and times have not been examined (No at S81), there may be rainy dates and times that have not been examined, while clear and cloudy dates and times showed low attendance rates. Thus, the earliest date and time among the possible dates and times for which the rejection value is not set is set as the holding date and time (S82). Then, the processing returns to step S72 to perform the attendance confirmation processing (S72).

If, after the attendance confirmation processing, the attendance flag is “1” (Yes at S73), the determined schedule is notified (S74) and the schedule is stored into the personal schedule DB storage area 284 (S75) before the clear date and time examination processing terminates. Further, the third scheduling processing terminates to return to the main processing, which will also terminate.

If a rejection value is stored for all the possible dates and times (Yes at S81), the conference cannot be held at any of the possible dates and times. Thus, information to display a message screen to notify a cancellation of the new schedule is transmitted to the user terminal 10 of participants and the user terminal 11 of the drafter (S83) before the clear date and time examination processing terminates. Further, the third scheduling processing terminates to return to the main processing, which will also terminate.

Thus, if there is a plurality of possible dates and times, and there is any clear date and time among the possible dates and times, a clear date and time is preferentially set as the holding date and time. If there is a plurality of clear dates and times, the earliest among these clear dates and times is first set as the holding date and time.

As described above, in the case where “only one location is specified”, a date and time when the desired location is available is set as the holding date and time. Further, among the desired dates and times, dates and times when schedules of all the participants are available are set as possible dates and times, and one of the possible dates and times is determined as the holding date and time. If there is only one possible date and time, the location examination processing is performed in the same manner as in the case where “only one date and time and only one location are specified”. When there is a plurality of possible dates and times, the weather forecast is referenced. If there is any clear date and time, such a clear date and time is preferentially set as the holding date and time. If there is no clear date and time, the date and time corresponding to the smallest value calculated travel distance value among the calculated travel distance values is set as the holding date and time. If there are only dates and times corresponding to the calculated travel distance values larger than the reference value, or if the clear weather is not expected even if the holding location is outdoors, an inquiry is transmitted to the drafter.

Next, the second scheduling processing that is performed in the case where “only one date and time is specified” will be described with reference to flowcharts in FIGS. 24 to 27. In this case, only one desired date and time is specified, but the desired location is not necessarily specified as only one location. For example, one hour from 16:00 of Sep. 4, 2006 may be specified as the desired date and time, and no desired location may be specified.

First, the desired date and time is stored into the holding date and time storage area 231 as the “holding date and time” (S91). Then, the personal schedule DB storage area 284 is referenced to determine whether schedules of all the participants are available at the holding date and time (S92). If the schedules of all participants are not available (No at S92), information to display a message screen to indicate that the schedule cannot be fixed at the desired date and time is transmitted to the user terminal 11 of the drafter (S102). Then, the second scheduling processing terminates to return to the main processing in FIG. 19, which will also terminate.

If the schedules of all the participants are available (Yes at S92), the weather forecast of the holding date and time is acquired from the weather forecast DB storage area 283 (S93). Then, it is determined whether a rainy weather is forecast at the holding date and time (S94). If the rainy weather is not forecast (No at S94), there may be no need to consider the travel distance. Thus, the processing at step S95 to S105 will be performed. More specifically, a preceding location where each participant is immediately before the holding date and time is read from the personal schedule DB storage area 284 and stored into the preceding location storage area 236 (S95).

Then, a building having the largest number of the preceding locations of the participants is set as a candidate building, and stored into the candidate building storage area 240 (S96). If the same largest number of the preceding locations is located in a plurality of buildings, the candidate building may be determined according to a predetermined rule. If, for example, there is a building in which a required participant is located, the building may be set as the candidate building. If the drafter is a participant and there is a building in which the drafter is located, the building may be set as the candidate building. Further, a building in which a participant inputted first via the participant input field of the new schedule input screen 901 is located may be set as the candidate building.

Next, an unreserved (available) room is searched for among the rooms in the candidate building stored in the reservation status storage area 285 (S97). Then, if there is any available room (Yes at S98), the available room is stored into the holding location storage area 232 as the holding location (S103), the attendance confirmation processing is performed (S104, See FIG. 28) and the holding determination processing is performed (S105, See FIG. 29). Subsequently, the second scheduling processing terminates to return to the main processing, which will also terminate.

If there is no available room (No at S98), it is determined whether all the buildings stored in the preceding location storage area 236 have been examined (S99). A storage area to store a mark to indicate that the building has been examined may be provided in the RAM 23, for each of the buildings stored in the preceding location storage area 236. It may be determined whether all the buildings have been examined based on whether the mark is stored for all the buildings. Though not shown, the mark to indicate that the building has been examined may be stored after it is determined at step S98 that there is no available room. If not all buildings have been examined (No at S99), the building having the next largest number of the preceding locations of the participants is set as the candidate building (S101) and the processing returns to step S97 to search for an unreserved room among the rooms of the candidate building (S97).

The processing at step S97 to S101 is repeated until an available room is found. If all the buildings stored in the preceding location storage area 236 are examined (Yes at S99), information to display a message screen that indicates no location can be reserved for the desired date and time is transmitted to the user terminal 11 of the drafter (S100). Then, the second scheduling processing terminates to return to the main processing, which will also terminate.

Thus, if the weather of the desired date and time is not expected to be a rainy weather, a room available at the desired date and time in the building that has the preceding locations of the participants is set as the holding location.

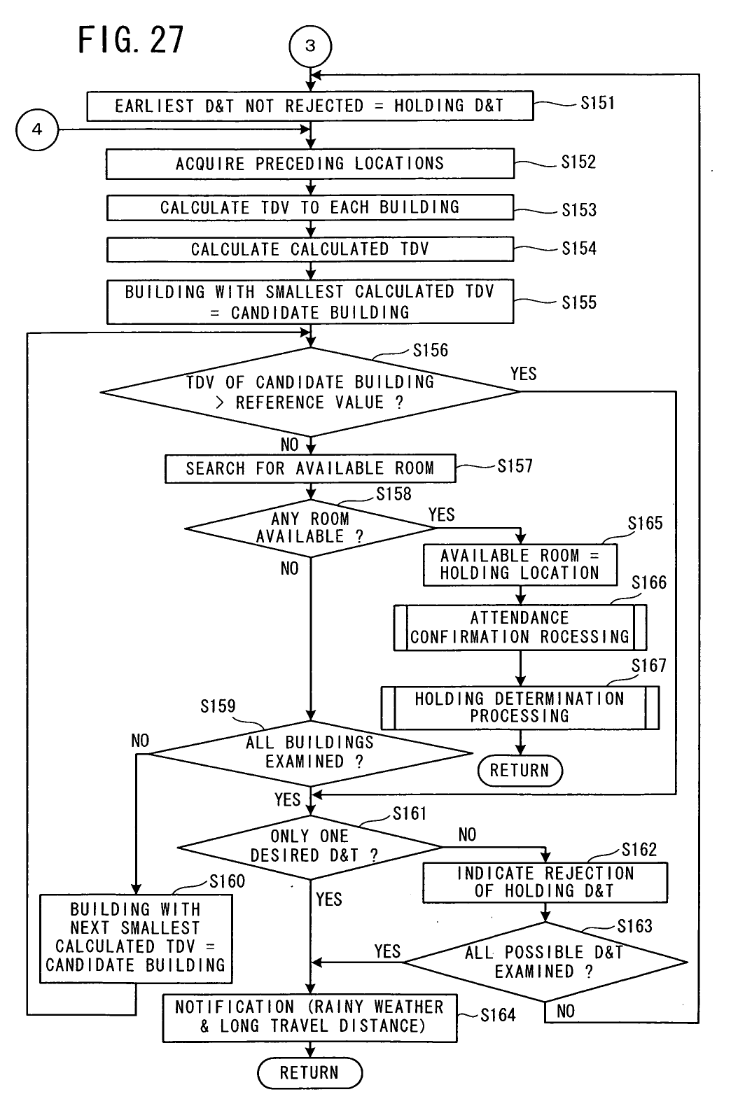

If it is determined that a rainy weather is expected at the holding date and time (Yes at S94), the processing proceeds to step S152 in FIG. 27. Here, the preceding locations of the respective participants are read from the personal schedule DB storage area 284 and stored into the preceding location storage area 236 (S152). Then, for each of the participants, travel distance values for travels from the preceding location to all locations stored in the location DB storage area 282 are read from the travel distance value storage area 286 and stored into the third travel distance value storage area 239 (S153). Then, the travel distance values of all the participants are totaled for each location and stored into the calculated travel distance value storage area 241 as the calculated travel distance value (S154).

The building having the smallest calculated travel distance value is stored into the candidate building storage area 240 as the candidate building (S155). Then, it is determined whether the travel distance values of all the participants for the candidate building stored in the third travel distance value storage area 239 are larger than the reference value (S156). If the travel distance values of all the participants are larger than the reference value (Yes at S156), the processing proceeds to step S161, because all the participants will have a long travel distance if this holding date and time is fixed.

Then, it is determined whether there is only one desired date and time, that is, the desired date and time is the present holding date and time only (S161). Here, the processing is performed after the second scheduling processing and the desired date and time is assumed to be the only date and time (here, one hour from 16:00 of Sep. 4, 2006, as an example) (Yes at S161). Thus, information to display a message screen is transmitted to the user terminal 11 of the drafter (S164). The screen indicates that a rainy weather is expected at the desired date and time and that some participant(s) will have a long travel distance at the desired date and time. Then, the second scheduling processing terminates to return to the main processing in FIG. 19, which will also terminate.

If the travel distance values of all participants are not larger than the reference value (No at S156), the reservation status storage area 285 is referenced to search for available rooms in the candidate building (S157). If there are any available rooms (Yes at S158), one of the available rooms is set as the holding location (S165). More specifically, if there is one available room, the room may be set as the holding location, but if there is a plurality of available rooms, the available room to be set as the holding location may be determined according to a predetermined rule. For example, an order of priority may be stored in the location DB storage area 282 beforehand, and the room may be selected according to the order stored in the location DB storage area 282. Alternatively, the room found first at step S157 may be selected. Because the holding date and time and the holding location are fixed at this step, the attendance confirmation processing is performed (S166, See FIG. 28) and the holding determination processing is performed (S167, See FIG. 29). Subsequently, the second scheduling processing terminates to return to the main processing, which will also terminate.

If there is no available room (No at S158), it is determined whether all the buildings have been examined (S159). For this determination, storage areas for marking may be provided in the RAM 23 for all the buildings. If it is determined that the candidate building has no available room, a value as a mark to indicate “no available room” is stored into the storage area for the candidate building (No at S158). If not all buildings have been examined (No at S159), the building having the next smallest calculated travel distance value, that is, the building having the smallest calculated travel distance value among the buildings not marked by the “no available room” value, is set as the candidate building (S160). Then, after returning to step S156, it is determined whether the travel distance values of all the participants for the candidate building are larger than the reference value (S156). If the travel distance values of all the participants are not larger than the reference value (No at S156), unreserved rooms in the candidate building are searched for (S157).

The processing at steps S156 to S160 is repeated in this manner and if available rooms are found (Yes at S158), one of the available rooms is set as the holding location (S165), the attendance confirmation processing is performed (S166, See FIG. 28) and the holding determination processing is performed (S167, See FIG. 29). Subsequently, the second scheduling processing terminates to return to the main processing, which will also terminate.

If all buildings have been examined (Yes at S159), it is determined whether there is only one desired date and time, that is, the desired date and time is the present holding date and time only (S161). Here, the processing is performed after the second scheduling processing and the desired date and time is assumed to be the only date and time (Yes at S161). Thus, information to display a message screen is transmitted to the user terminal 11 of the drafter (S164). The screen indicates that a rainy weather is expected at the desired date and some participant(s) will have a long travel distance at the desired date and time. Then, the second scheduling processing terminates to return to the main processing, which will also terminate.

Thus, if the weather is a rainy weather at the desired date and time, an available room is searched for in the buildings in an ascending order of an overall travel distance in consideration of the travel distances from the preceding locations of the participants, and an available room is set as the holding location.

As described above, in the case where “only one date and time is specified”, the weather forecast for the desired date and time is referenced. If a rainy weather is expected, the building is selected in an ascending order of the overall travel distance in consideration of the travel distances from the preceding locations of the participants. If a rainy weather is not expected, the building having the largest number of the preceding locations of the participants is preferentially selected.

Next, the fourth scheduling processing that is performed in the case where “neither only one date and time nor only one location is specified” will be described with reference to flowcharts in FIGS. 25 to 27. In this case, for example, one hour from 10:00 of Sep. 4, 2006, one hour from 14:00 of Sep. 4, 2006, and one hour from 16:00 of Sep. 4, 2006 may be set as the desired dates and times and no desired location may be specified.

As shown in FIG. 25, the schedules of the desired dates and times of all the participants are referenced from the personal schedule DB storage area 284, and dates and times at which all the participants are available are stored into the possible date and time storage area 235 as possible dates and times (S111). Then, it is determined whether there is any possible date and time (S112). If no date and time is stored in the possible date and time storage area 235 (No at S112), information to display a message screen is transmitted to the user terminal 11 of the drafter (S113). The screen indicates that all the participants are not available at the desired date and time. Then, the fourth scheduling processing terminates to return to the main processing in FIG. 19, which will also terminate.

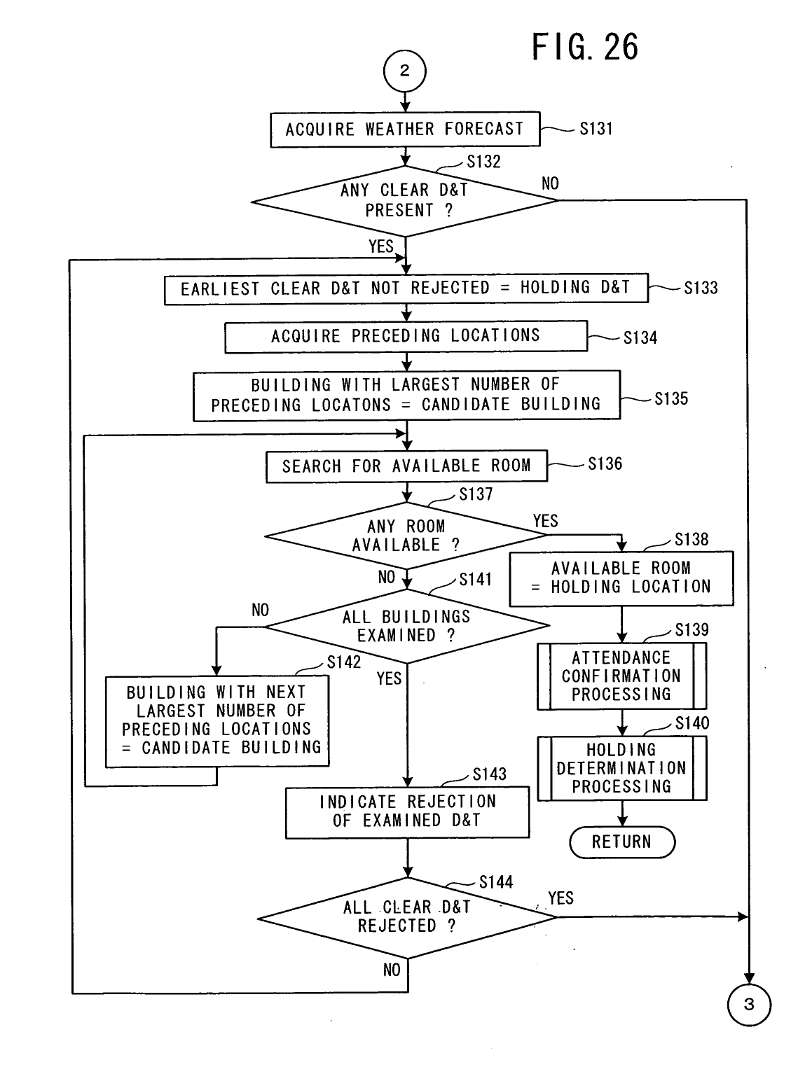

If there is any possible date and time (Yes at S112), it is determined whether there is only one possible date and time (S114). If there is only one possible date and time (Yes at S114), the date and time is stored in the holding date and time storage area 231 as the holding date and time (S115). Because the holding date and time is fixed to one date and time, processing to determine the holding location will be performed (S116 to S124 in FIG. 25 and S152 to S164 in FIG. 27). If there is more than one possible date and time (No at S114), processing to determine the holding date and time and the holding location will be performed (S131 to S144 in FIG. 26 and S151 to S164 in FIG. 27).

First, a case when there is only one possible date and time (Yes at S114) will be described. After the only one possible date and time is set as the holding date and time (S115), the weather forecast for the possible date and time is acquired from the weather forecast DB storage area 283 and stored into the weather field of the possible date and time storage area 235 (S116). Then, it is determined whether the weather at the possible date and time is clear (S117).

If information indicating a clear weather is stored in the weather field of the possible date and time storage area 235, it is determined that the possible date and time is a clear date and time (Yes at S117). In such a case, the preceding locations of the respective participants are read from the personal schedule DB storage area 284 and stored into the preceding location storage area 236 (S118). The building having the largest number of the preceding locations among all the buildings is stored into the candidate building storage area 240 as the candidate building (S119).

Then, the reservation status storage area 285 is referenced to search for available rooms among the rooms of the candidate building (S120). If there is any available room (Yes at S121), the available room is stored into the holding location storage area 232 as the holding location (S125), the attendance confirmation processing is performed (S126, See FIG. 28) and the holding determination processing is performed (S127, See FIG. 29). Subsequently, the second scheduling processing terminates to return to the main processing, which will also terminate.

If there is no available room (No at S121), it is determined whether all the buildings stored in the preceding location storage area 236 have been examined (S122). A storage area to store a mark to indicate that the building has been examined may be provided in the RAM 23, for each of the buildings stored in the preceding location storage area 236. It may be determined whether all the buildings have been examined based on whether the marks are stored for all the buildings. Though not shown, the mark to indicate that the building has been examined may be stored after it is determined at step S121 that there is no available room.

If not all the buildings have been examined (No at S122), the building having the next largest number of the preceding locations of the participants is set as the candidate building (S124) and the processing returns to step S120. Then, available rooms among the rooms of the candidate building are searched for (S120). The processing at steps S119 to S124 is repeated until an available room is found. If all buildings stored in the preceding location storage area 236 are examined (Yes at S122), information to display a message screen to indicate that no location can be reserved for the desired date and time is transmitted to the user terminal 11 of the drafter (S123). Then, the fourth scheduling processing terminates to return to the main processing, which will also terminate.

If information indicating a clear weather is not stored in the weather field of the possible date and time storage area 235, it is determined that the desired date and time is not a clear date and time (No at S117). Then, the processing proceeds to step S152 shown in FIG. 27. Then, after the processing at steps S152 to S167 is performed, the fourth scheduling processing terminates to return to the main processing, which will also terminate. Details of the processing at steps S152 to S167 is described above in detail in the case where “only one date and time is specified” and thus, a description thereof is not repeated here.

Next, a case when it is determined at step S114 in FIG. 25 that there is more than one possible date and time (No at S114) will be described. In this case, the processing proceeds to step S131 shown in FIG. 26. Then, the weather forecasts for the possible dates and times are acquired from the weather forecast DB storage area 283 and stored into the weather field of the possible date and time storage area 235 (S131).

Then, it is determined whether there is any clear date and time among the weathers at the possible dates and times (S132). If there are clear dates and times (Yes at S132), the earliest date and time among the clear dates and times for which the rejection value is not stored in the rejection check field of the possible date and time storage area 235 is set as the holding date and time (S133). Then, the preceding locations of the participants are respectively read from the personal schedule DB storage area 284 and stored into the preceding location storage area 236 (S134). Then, the building having the largest number of the preceding locations is stored into the candidate building storage area 240 as the candidate building (S135).

Then, the reservation status storage area 285 is referenced to search for unreserved rooms among the rooms of the candidate building (S136). If there is any available room (Yes at S137), the available room is stored into the holding location storage area 232 as the holding location (S138). Subsequently, the attendance confirmation processing is performed (S139, See FIG. 28), the holding determination processing is performed (S140, See FIG. 29), and the fourth scheduling processing terminates to return to the main processing in FIG. 19, which will also terminate.

If there is no available room (No at S137), it is determined whether all the buildings stored in the preceding location storage area 236 have been examined (S141). A storage area to store a mark to indicate that the building has been examined may be provided in the RAM 23, for each of the buildings stored in the preceding location storage area 236. It may be determined whether all the buildings have been examined based on whether the marks are stored for all the buildings. Though not shown, the mark to indicate that the building has been examined may be stored after it is determined at step S137 that there is no available room. If not all the buildings have been examined (No at S141), the building having the next largest number of the preceding locations of the participants is set as the candidate building (S142), and the processing returns to step S136. Then, unreserved rooms among the rooms of the candidate building are searched for (S136).

The processing at steps S136, S137, S141, and S142 is repeated until an available room is found. If all the buildings stored in the preceding location storage area 236 have been examined (Yes at S141), a value indicating a rejection is stored in the rejection check field of the holding date and time in the possible date and time storage area 235 (S143). Then, it is determined whether the value indicating a rejection is stored for all the clear dates and times in the rejection check fields in the possible date and time storage area 235 (S144). If the value indicating a rejection is not stored for all the clear dates and times in the rejection check fields (No at S144), the processing returns to step S133 to perform the processing of another clear date and time (S133 to S143).

If the rejection value is stored for all the clear dates and times in the rejection check fields (Yes at S144), an available room cannot be reserved for any of the clear dates and times. Thus, the processing proceeds to step S151 shown in FIG. 27. Subsequently, the holding date and time is determined from dates and times other than the clear dates and times, and the holding location is also determined (S151 to S167). Specifically, the earliest date and time among the possible dates and times corresponding to which the rejection value is not stored is determined as the holding date and time (S151).

The processing after step S151 is described above in detail in the case where “only one date and time is specified”. Thus, a description thereof is not repeated here. However, in the present case, it is determined at step S161 that the number of desired dates and times is not one (No at S161). Thus, after a value indicating a rejection is stored into the rejection check field of the holding date and time in the possible date and time storage area 235 (S162), it is determined whether a value indicating a rejection is stored in the rejection check fields for all the possible dates and times (S163). If there is any date and time to which the rejection value is not stored (No at S163), the processing returns to step S151, and the earliest date and time among the possible dates and times for which the rejection value is not stored is determined as the holding date and time (S151).

Then, the processing for the holding date and time is performed (S152 to S161, S165, and S166). Then, if the rejection value is stored for all the possible dates and times (Yes at S163), information to display a message screen is transmitted to the user terminal 11 of the drafter (S164). The screen indicates that a rainy weather is forecast for the desired dates and times and some participant(s) will have a long travel distance at the desired dates and times.

As described above, in the case where “neither only one date and time nor only one location is specified”, possible dates and times are determined from dates and times when all the participants are available. If there is only one possible date and time, the weather forecast is referenced. If the possible date and time is a clear date and time, an available room is searched for in the buildings in a descending order of the number of the preceding locations of the participants in the building to determine the holding location. If there is no clear date and time, an available room is searched for in the buildings in an ascending order of an overall travel distance in consideration of the travel distances from the preceding locations of the participants to determine the holding location. If there is a plurality of possible dates and times, the holding date and time is determined by giving priority to clear dates and times.

Thus, the weather forecast is considered when the date and time or the location of a schedule is determined. As a result, a location that requires a long travel distance may not be determined as the holding location when a rainy weather is expected, or a rainy date and time may not be selected as the holding date and time while a clear date and time is available.

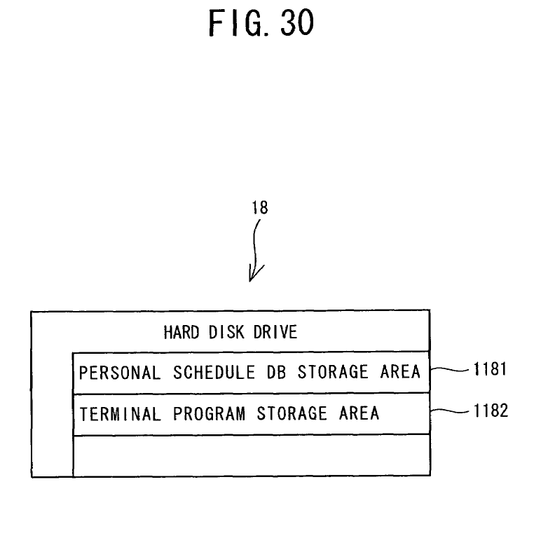

Next, the second exemplary embodiment will be described with reference to FIGS. 30 to 46. In the second embodiment, processing of a schedule arrangement is performed in the user terminal 10 based on desired information inputted by a user through the user terminal 10. In the second embodiment, it is assumed that input into the desired holding location field in the new schedule input screen 901 shown in FIG. 15 is required.

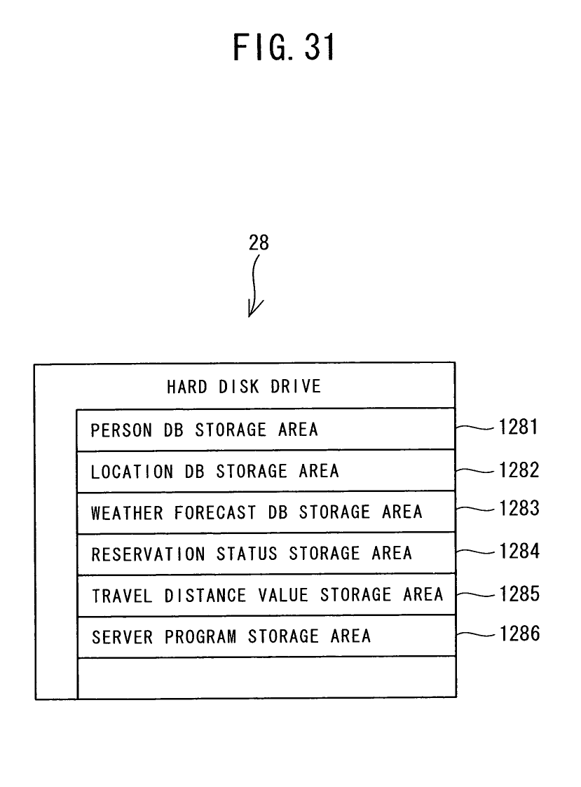

First, storage areas of the hard disk drive 18 provided in the user terminal 10 and the storage areas of the hard disk drive 28 provided on the server 20 will be described with reference to FIGS. 30 and 31. Here, only storage areas related to the processing of a schedule arrangement will be described, but other storage areas that are not described may also be provided in each hard disk drive.

As shown in FIG. 30, the hard disk drive 18 of the user terminal 10 is provided with a personal schedule DB storage area 1181 and a terminal program storage area 1182. The personal schedule DB storage area 1181 stores schedules of a plurality of users whose schedules are managed by the processing in the present embodiment. The terminal program storage area 1182 stores a terminal program operable on the user terminal 10. The terminal program may cause the CPU 101 to arrange a schedule. Specifically, in order to arrange a schedule, the CPU 101 causes the new schedule input screen 901 (See FIG. 15) to be displayed to allow a user to input a new schedule and makes an inquiry about an availability of the schedule at the user terminal 10 of a person inputted as a participant. The CPU 101 also acquires various kinds of information from the server 20.

While personal schedules of all users are stored in the hard disk drive 28 of the server 20 in the first embodiment, only personal schedules of each user are stored in the personal schedule DB storage area 1181 of the user terminal 10 in the second embodiment. The schematic view shown in FIG. 8 shows only personal schedules for one person, among personal schedules of all users stored in the personal schedule DB storage area 284 in the first embodiment. Therefore, a schematic view of the personal schedule DB storage area 1181 of the present embodiment may be similar to FIG. 8, and a description thereof is only cited and not repeated here.

As shown in FIG. 31, the hard disk drive 28 of the server 20 is provided with a person DB storage area 1281, a location DB storage area 1282, a weather forecast DB storage area 1283, a reservation status storage area 1284, a travel distance value storage area 1285, and a server program storage area 1286. The location DB storage area 1282 is the same as the location DB storage area 282 in the first embodiment shown in FIG. 6. The weather forecast DB storage area 1283 is the same as the weather forecast DB storage area 283 shown in FIG. 7. The travel distance value storage area 1285 is the same as the travel distance value storage area 286 shown in FIG. 9. Thus, a description of these storage areas is only cited and not repeated here.

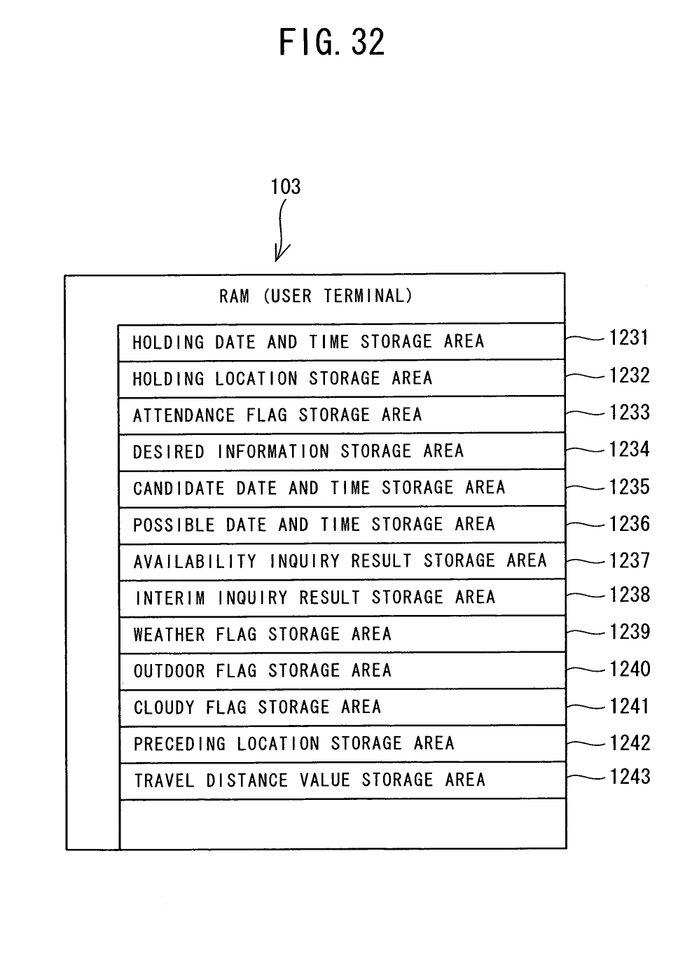

Next, storage areas provided in the RAM 103 of the user terminal 10 will be described with reference to FIGS. 32 to 34. As shown in FIG. 32, the RAM 103 is provided with a holding date and time storage area 1231, a holding location storage area 1232, an attendance flag storage area 1233, a desired information storage area 1234, a candidate date and time storage area 1235, a possible date and time storage area 1236, an availability inquiry result storage area 1237, an interim inquiry result storage area 1238, a weather flag storage area 1239, a outdoor flag storage area 1240, a cloudy flag storage area 1241, a preceding location storage area 1242, and a travel distance value storage area 1243. Though not shown, other storage areas may also be provided in the RAM 103. The user terminal 10 is controlled so that the above information is stored into a predetermined storage area of the hard disk drive 18 when the user terminal 10 is turned off, and subsequent processing may be performed when the user terminal 10 is activated next time.

In the holding date and time storage area 1231, the date and time determined as a date and time for holding a conference may be stored as the holding date and time. In the holding location storage area 1232, a code of location determined as a location for holding a conference may be stored as the holding location. In the attendance flag storage area 1233, an attendance flag indicating an attendance status of the conference may be stored, based on attendance responses from the participants. In the desired information storage area 1234, desired information transmitted from the user terminal 10 may be stored.

In the candidate date and time storage area 1235, a date(s) and time(s) about which an inquiry is to be made may be stored in the processing of arranging a schedule. The inquiry may be made at the user terminals 10 of other participants concerning an availability of a schedule. In the possible date and time storage area 1236, a date(s) and time(s) among the desired dates and times (dates and times inputted via the new schedule input screen 901) at which all the participants can attend (other schedules are not registered) may be stored in the processing of arranging a schedule.

In the availability inquiry result storage area 1237, results of availability inquiries of a schedule at the user terminals 10 of other participants may be stored. More specifically, results of “unoccupied” or “occupied” for the candidate dates and times may be stored. In the interim inquiry result storage area 1238, responses concerning holding of the schedule at the holding date and time and at the holding location may be stored. In the weather flag storage area 1239, a weather flag may be stored. In the outdoor flag storage area 1240, an outdoor flag may be stored. In the cloudy flag storage area 1241, a cloudy flag may be stored. In the preceding location storage area 1242, a preceding location of each participant may be stored. In the travel distance value storage area 1243, travel distance values between the holding location and the respective preceding locations of the participants may be stored.

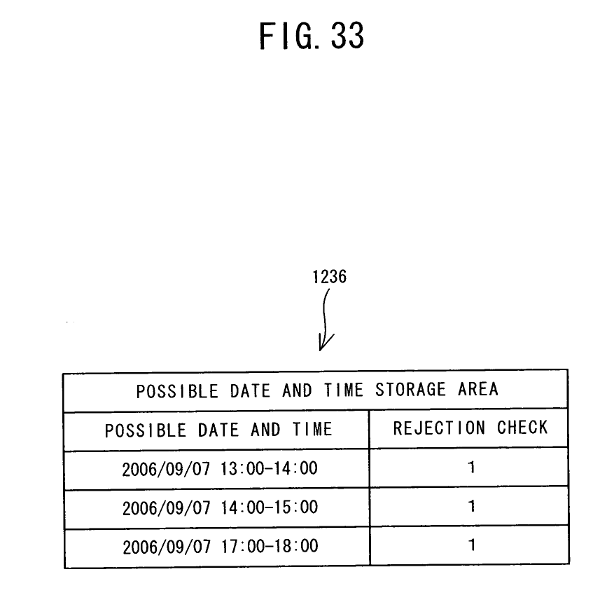

Next, the possible date and time storage area 1236 will be described with reference to FIG. 33. As shown in FIG. 33, the possible date and time storage area 1236 has a possible date and time field and rejection check field. In the possible date and time field, among the desired dates and times, dates and times when schedules of all the participants are unoccupied (available) may be stored. In the rejection check field, if a date and time is examined and is not chosen as the holding date and time, a value (for example, “1”) indicating that the date and time has not been chosen (rejected) may be stored as a rejection value.

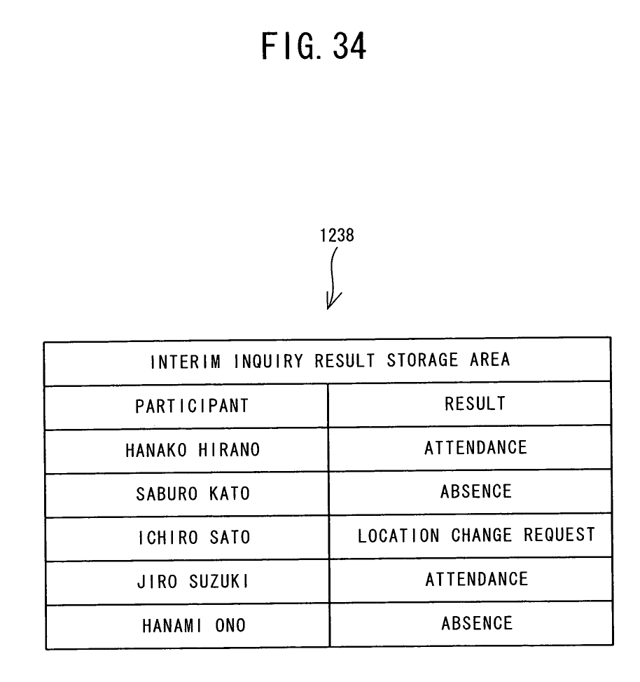

Next, the interim inquiry result storage area 1238 will be described with reference to FIG. 34. The interim inquiry result storage area 1238 has a participant field and result field. Inquiry results for each participant may be stored in the interim inquiry result storage area 1238. If the holding location is outdoors, the inquiry results may include three types of “attendance”, “absence”, and “location change request”. If the holding location is indoors, the inquiry result may include two types of “attendance” and “absence”.

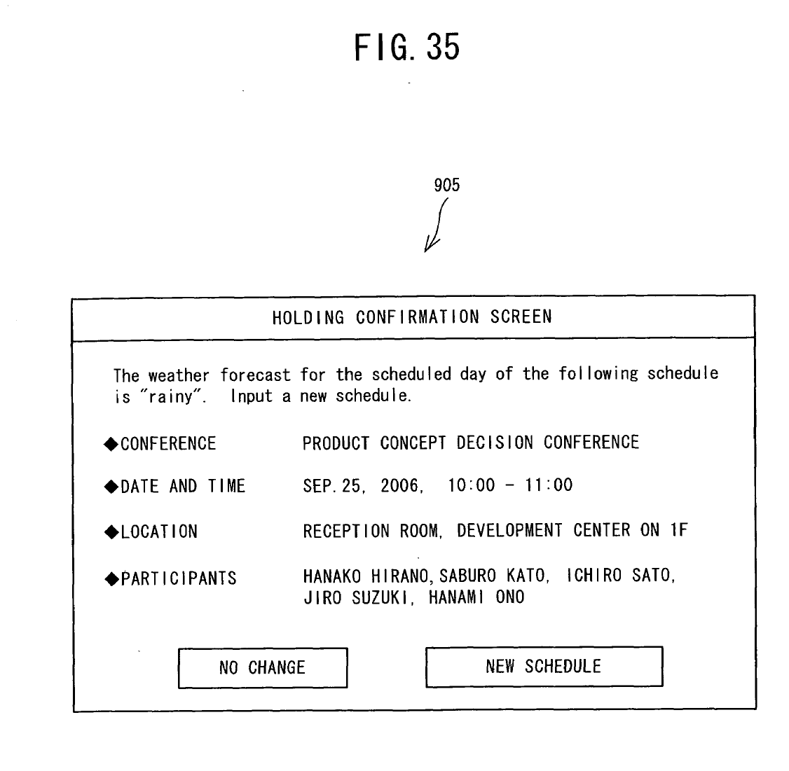

Next, a holding confirmation screen 905 will be described with reference to FIG. 35. The holding confirmation screen 905 may be displayed in the user terminal 10 of the drafter if a rainy weather is forecast for the holding date and time a predetermined time prior to the holding date and time of a registered schedule. For example, the holding confirmation screen 905 may be displayed at 10:00 am three days before or 36 hours before the holding date and time. As shown in FIG. 35, the holding confirmation screen 905 shows a message indicating that a rainy weather is forecast for the holding date and time, a conference name, a date and time, a location, and participants as a content of the schedule. Further, a “No change” button and a “New schedule” button are displayed. Selecting the “No change” button maintains the schedule stored in the personal schedule DB storage area 1181 as it is, and selecting the “New schedule” button displays the new schedule input screen 901.

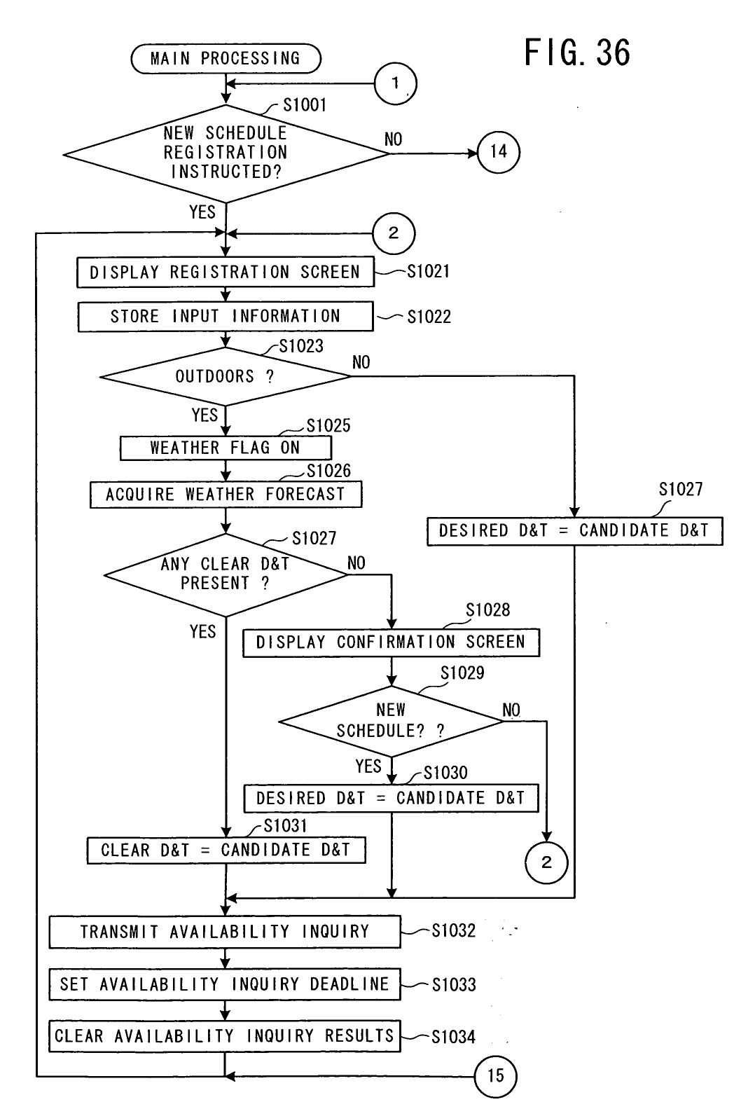

Next, main processing to be performed in the user terminal 10 will be described with reference to flowcharts of FIGS. 36 to 47. The main processing is started when the terminal program is started and executed by the CPU 101 in the user terminal 10. In the main processing, determination processing at steps S1001 to S1008 shown in FIGS. 36 to 40 is repeatedly performed, in which if conditions are met in each piece of the determination processing, corresponding processing is performed. The user terminal 10 may arrange a schedule in the user terminal 10 itself. The user terminal 10 may also receive an inquiry from another user terminal 10 and perform processing to respond to the inquiry. Processing of both types may be performed in the user terminal 10. In the following description in the present embodiment, a user terminal 10 of the drafter into which a new schedule is inputted is called a “user terminal 11”, and a user terminal 10 of a user who is specified as a participant in the new schedule and that receives the inquiry is called a “user terminal 12”.

In a schedule arrangement, processing differs significantly depending on whether the holding location is indoors or outdoors. Thus, processing in the user terminal 11 of the drafter and the user terminal 12 of the participant will be first described with a first example in which the holding location is indoors. Then, processing in the user terminal 11 of the drafter and the user terminal 12 of the participant will be described with a second example in which the holding location is outdoors.

As shown in FIG. 36, when a registration of a new schedule is instructed in the user terminal 11 of the drafter (Yes at S1001), the new schedule input screen 901 (See FIG. 15) is displayed (S1021). If the “Register” button in the screen is selected, input information is stored into the desired information storage area 1234 as the desired information (S1022). At this step, the desired location is stored into the holding location storage area 1232 as the holding location.

Then, it is determined whether the holding location is outdoors by referencing the location DB storage area 1282 (S1023). Because the holding location is indoors in the first example (No at S1023), the desired date and time stored in the desired information storage area 1234 is stored into the candidate date and time storage area 1235 as the candidate date and time (S1027). Then, availability inquiry information is transmitted to the user terminals 12 of the participants (S1032). The availability inquiry information contains the candidate date and time. Then, a date and time indicating an availability inquiry deadline, that is, a date and time after a predetermined time (for example, two days) from the current date and time is stored into a predetermined storage area (not shown) in the RAM 103 (S1033). Then, the availability inquiry result storage area 1237 is cleared (S1034). Then, the processing returns to step S1001.

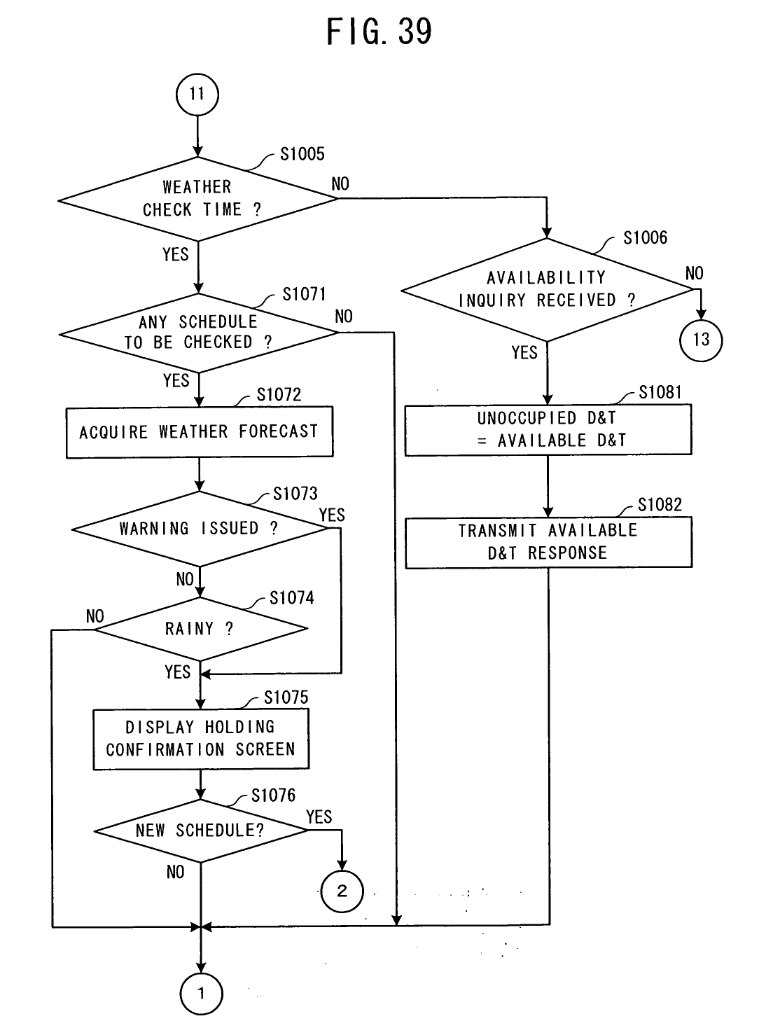

The user terminal 12 of the participant to which the availability inquiry information is transmitted receives the availability inquiry information (Yes at S1006 in FIG. 39). Then, the schedule of the candidate date and time is read from the personal schedules stored in the personal schedule DB storage area 1181 of the hard disk drive 18 of the user terminal 12, and unoccupied dates and times are set as available dates and times (S1081). Subsequently, available-date-and-time response information containing the available dates and times is transmitted to the user terminal 11 of the drafter (S1082).

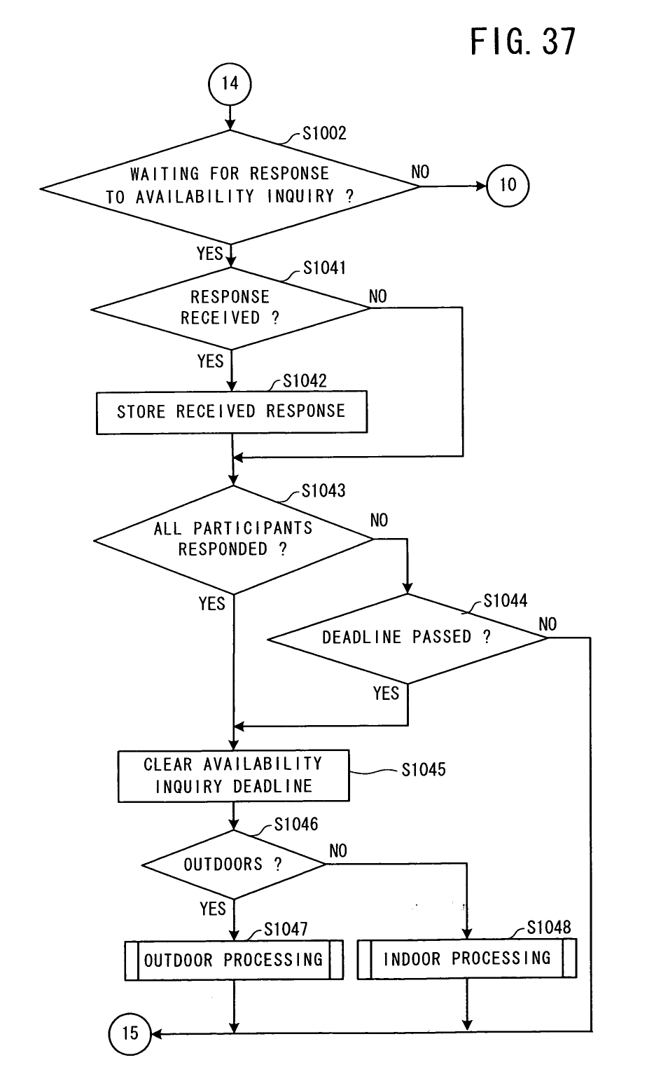

Meanwhile, it is determined in the user terminal 11 of the drafter that the user terminal 11 is waiting for a response to an availability inquiry (Yes at S1002 in FIG. 37), because the availability inquiry deadline is stored. Then, it is determined whether the available-date-and-time response information has been received from the user terminal 12 of the participant (S1041). If no available-date-and-time response information has been received (No at S1041), the processing proceeds to step S1043.

Then, it is determined whether the available-date-and-time response information has been received from all the participants (S1043). For this determination, the number of data pieces stored in the availability inquiry result storage area 1237 and the number of the participants stored in the desired information storage area 1234 may be compared. If the number of data pieces is smaller than the number of the participants, it may be determined that the available-date-and-time response information has not been received from all the participants (No at S1043). Thus, it is determined whether the availability inquiry deadline has passed (S1044). If the availability inquiry deadline has not passed (No at S1044), the processing returns to step S1001 in FIG. 36.

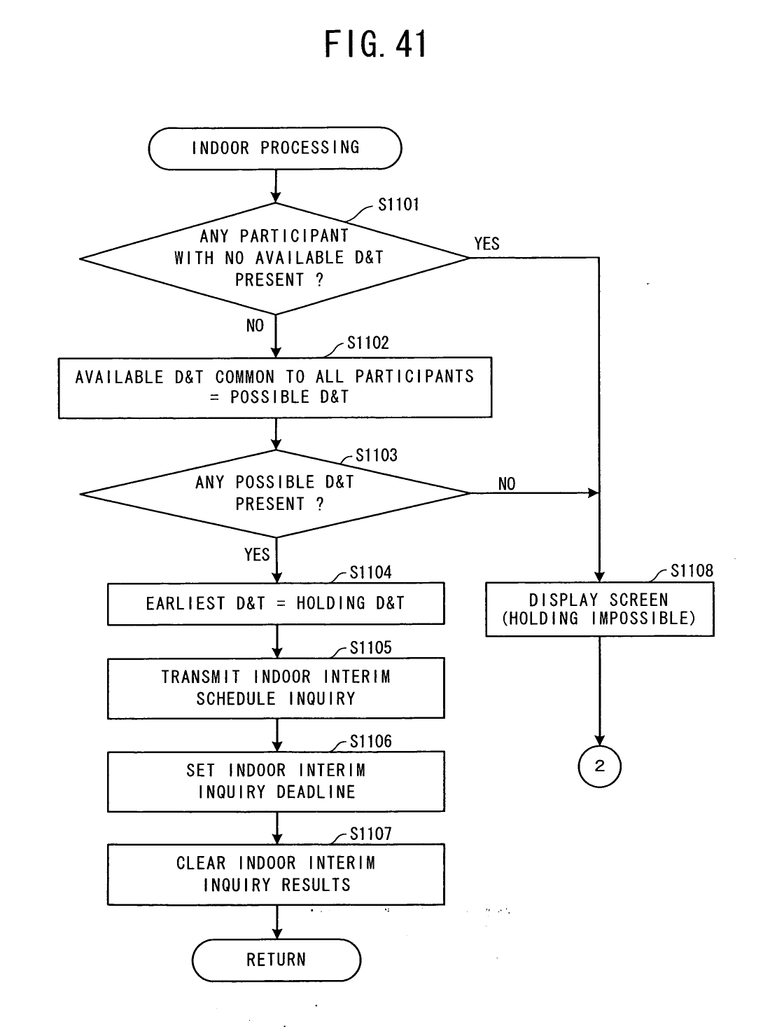

Then, processing at steps S1001, S1002, and S1041 to S1044 is repeated and when the available-date-and-time response information is received from all the participants (Yes at S1043), the availability inquiry deadline is cleared (S1045). If the availability inquiry deadline has passed (Yes at S1044), even if the available-date-and-time response information has not been received from all the participants (No at S1043), the availability inquiry deadline is cleared (S1045). Then, because the holding location is indoors in the first example (No at S1046), indoor processing is performed (S1048, See FIG. 41).

As shown in FIG. 41, in the indoor processing, the availability inquiry result storage area 1237 is referenced to determine whether there is any participant who has no available date and time (S1101). If there is any participant who has no available date and time (Yes at S1101), a schedule cannot be fixed at the desired date and time. Thus, a screen including a message to indicate that there is a participant who has no available date and time is displayed on the display 14 of the user terminal 11 of the drafter (S1108). Then, the processing returns to step S1021 shown in FIG. 36 to display the new schedule input screen 901 (See FIG. 15). Therefore, the drafter may input desired information of a new schedule considering the above result.

If there is no participant who has no available date and time (No at S1101), the availability inquiry result storage area 1237 is referenced to extract available dates and times common to all participants. The extracted available dates and times are stored into the possible date and time field of the possible date and time storage area 1236 as the possible dates and times (S1102). Then, whether o there is any possible date and time is determined (S1103). If no date and time is stored in the possible date and time field, that is, there is no possible date and time (No at S1103), a schedule cannot be fixed at the desired date and time. Thus, a screen including a message to indicate that there is a participant who has no available date and time is displayed in the display 14 of the user terminal 11 of the drafter (S108). Then, the processing returns to step S1021 shown in FIG. 36 to display the new schedule input screen 901 (See FIG. 15) (S1021). Therefore, the drafter may input desired information of a new schedule considering the above result.

If there are possible dates and times (Yes at S1103), the earliest date and time among the possible dates and times is stored into the holding date and time storage area 1231 as the holding date and time (S1104). Then, indoor interim schedule inquiry information is transmitted to the user terminals 12 of the participants (S1105). The indoor interim schedule inquiry information includes the holding date and time and the holding location, and makes an inquiry as to whether the holding date and time and the holding location are suitable for the participant. Then, a date and time indicating an indoor interim inquiry deadline, that is, a date and time after a predetermined time (for example, two days) from the current date and time is stored in a predetermined storage area (not shown) in the RAM 103 (S1106). Then, the interim inquiry result storage area 1238 is cleared (S1107). Then, the indoor processing shown in FIG. 41 terminates to return to step S1001 shown in FIG. 36.

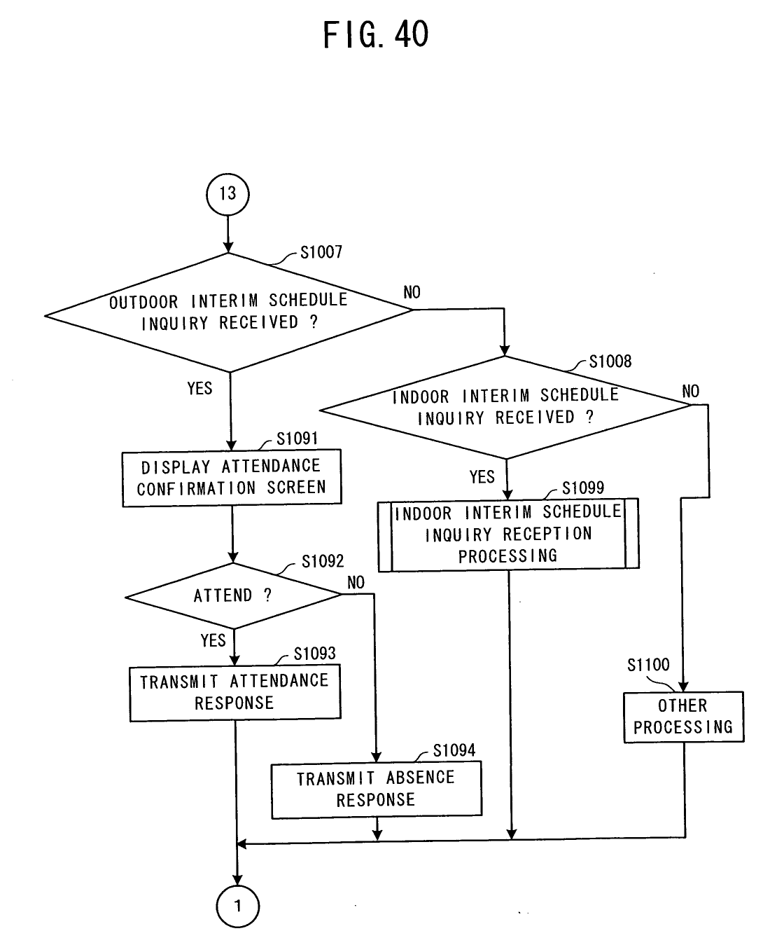

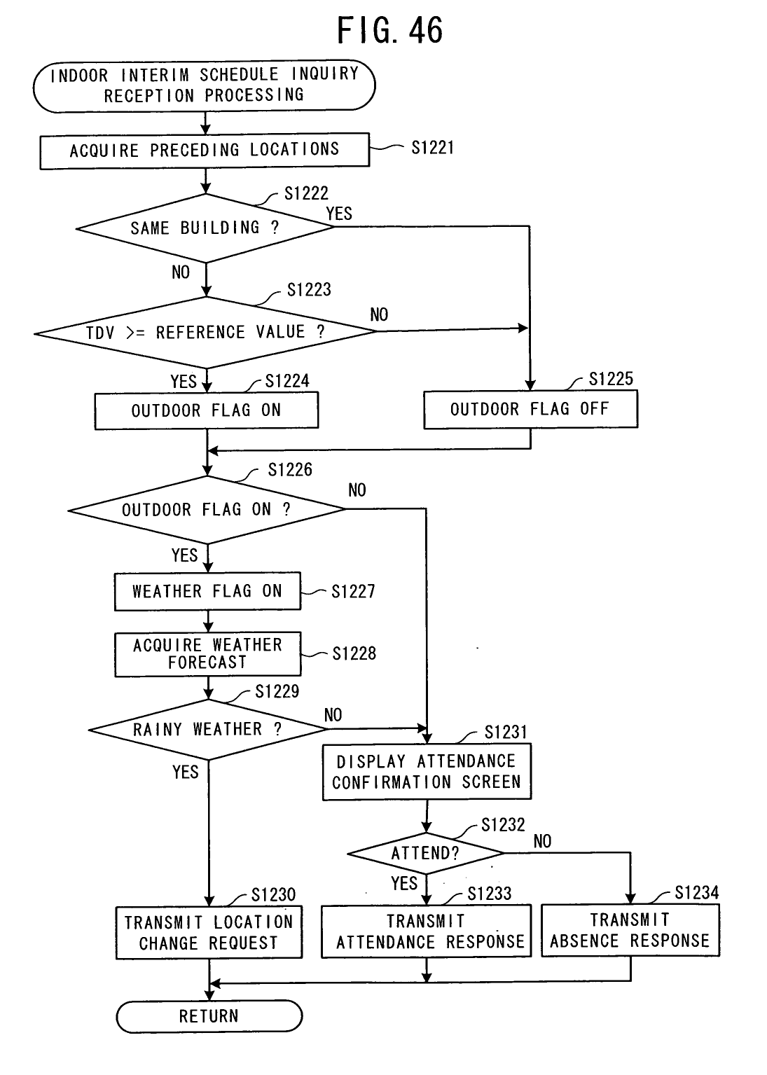

If the indoor interim schedule inquiry information is received (Yes at S1008 in FIG. 40) at the user terminal 12 of the participant to which the indoor interim schedule inquiry information has been transmitted, indoor interim schedule inquiry reception processing is performed (S1099, See FIG. 46). As shown in FIG. 46, in the indoor interim schedule inquiry reception processing, the preceding location of the participant (user) is read from the personal schedule DB storage area 1181 of the hard disk drive 18 of the user terminal 12, and stored into the preceding location storage area 1242 of the RAM 103 (S1221).

Then, it is determined whether the building of the preceding location is the same building as the building of the holding location (S1222). If the building of the preceding location and the building of the holding location are the same (Yes at S1222), there is no need to travel outdoors. Thus, a value “0 (zero)” is stored in the outdoor flag to set the flag OFF (S1225). If the building of the preceding location and the building of the holding location are not the same (No at S1222), the travel distance value storage area 1285 is referenced. The travel distance value for a travel between the building of the preceding location and the building of the holding location is read and stored into the travel distance value storage area 1243.

Then, it is determined whether the travel distance value is equal to or larger than a reference value (S1223). If the travel distance value is smaller than the reference value (No at S1223), the buildings are not so far away from each other that the weather should be considered. Thus, a value “0” is stored in the outdoor flag to set the flag OFF (S1225). If the travel distance value is equal to or larger than the reference value (Yes at S1223), the buildings are so far away that the weather should be considered. Thus, a value “1 (one)” is stored in the outdoor flag to set the flag ON (S1224).

Next, it is determined whether the outdoor flag is ON (S1226). If the outdoor flag is not ON (No at S1226), there may be no need to consider the weather. In such a case, the attendance confirmation screen 903 (See FIG. 17) is displayed (S1231). Then, input from the user who is a participant is accepted. If the “Attend” button is selected (Yes at S1232), an indoor attendance response information indicating attendance is transmitted to the user terminal 11 of the drafter (S1233). If the “Not attend” button is selected (No at S1232), instead of the “Attend” button, an indoor attendance response information indicating absence is transmitted to the user terminal 11 of the drafter (S1234). Then, the processing returns to step S1001 in the main processing shown in FIG. 36.

If the outdoor flag is ON (Yes at S1226), the weather may need to be considered. Thus, a value “1 (one)” is stored in the weather flag to set the flag ON (S1227), and the weather forecast at the holding date and time is acquired from the server 20 (S1228). It is determined whether the acquired weather forecast indicates a rainy weather (S1229). If a rainy weather is not forecast, traveling outdoors may not cause any trouble. Thus, the processing proceeds to step S1231 to display the attendance confirmation screen 903 (See FIG. 17) (S1231). If the “Attend” button is selected (Yes at S1232), an indoor attendance response information indicating attendance is transmitted to the user terminal 11 of the drafter (S1233). If the “Not attend” button is selected (No at S1232), instead of the “Attend” button, an indoor attendance response information indicating absence is transmitted to the user terminal 11 of the drafter (S1234). Then, the processing returns to step S1001 in the main processing shown in FIG. 36.

If the acquired weather forecast indicates a rainy weather (Yes at S1229), “Indoor attendance response indicating location change request” information is transmitted to the user terminal 11 of the drafter (S1230). Then, processing returns to S1001 in the main processing shown in FIG. 36.

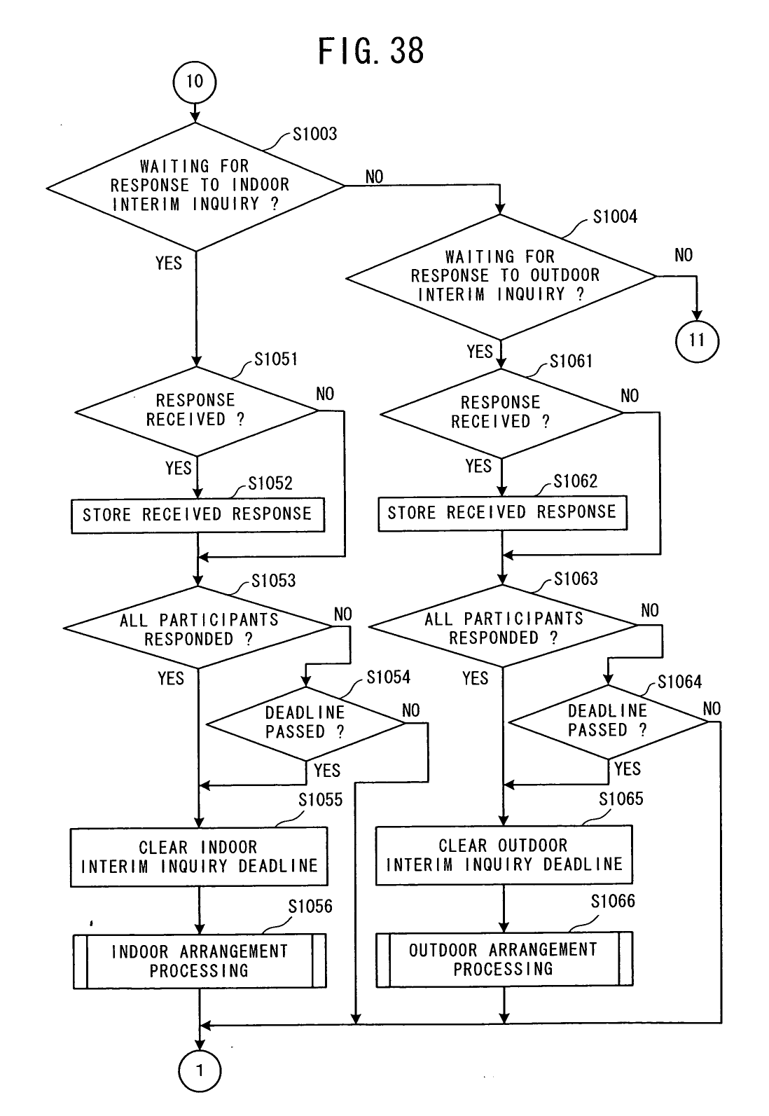

In such a manner, the indoor attendance response information is transmitted from the user terminal 12 of the participant to the user terminal 11 of the drafter. In the meantime, it is determined in the user terminal 11 of the drafter that the user terminal 11 is waiting for a response to an indoor interim inquiry (Yes at S1003 in FIG. 38), because the indoor interim inquiry deadline is stored. Thus, it is determined whether the indoor attendance response information has been received (S1051). If the indoor attendance response information has been received (Yes at S1051), the received response, that is, a value indicating either one of “attendance”, “absence”, and “location change request” is stored into the interim inquiry result storage area 1238 (S1052). If no indoor attendance response information has been received (No at S1051), the processing proceeds to step S1053.

Then, it is determined whether the indoor attendance response information has been received from all the participants (S1053). For this determination, the number of data pieces stored in the interim inquiry result storage area 1238 and the number of the participants stored in the desired information storage area 1234 may be compared. If the number of data pieces is smaller than the number of the participants, it may be determined that the indoor attendance response information has not been received from all the participants (No at S1053). Thus, it is determined whether the indoor interim inquiry deadline has passed (S1054). If the indoor interim inquiry deadline has not passed (No at S1054), the processing returns to step S1001 in FIG. 36.

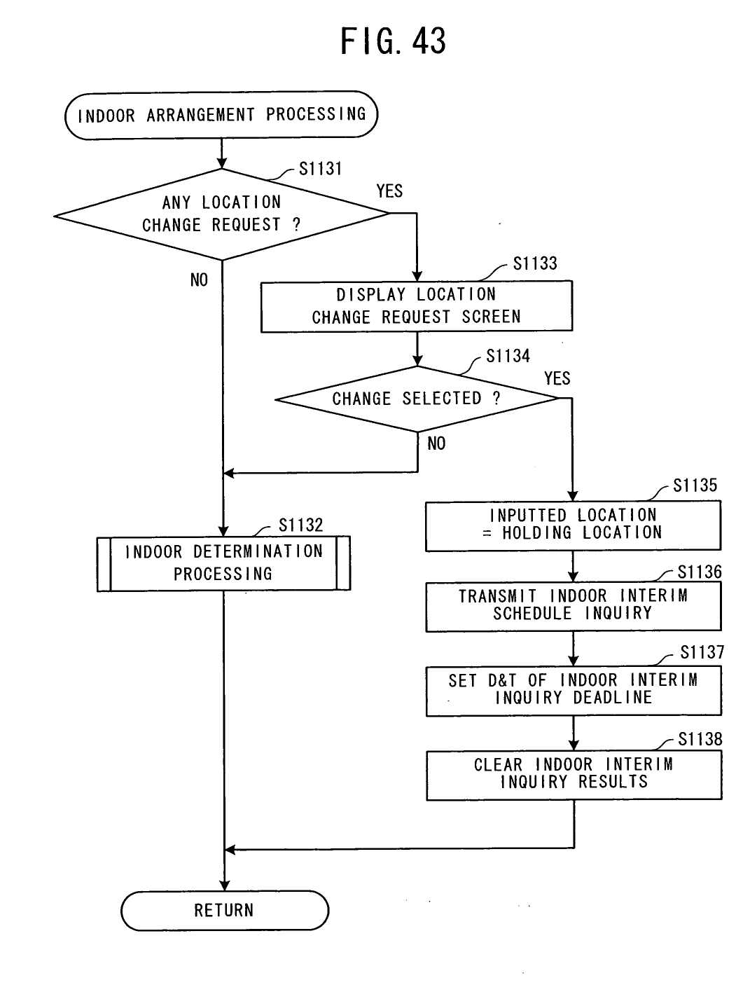

Then, the processing at steps S1001 to S1003 and S1051 to S1054 is repeated, and if the indoor attendance response information has been received from all the participants (Yes at S1053), the indoor interim inquiry deadline is cleared (S1055). If the indoor interim inquiry deadline has passed (Yes at S1054) while the indoor inquiry response information has not been received from all the participants (No at S1053), the indoor interim inquiry deadline is cleared (S1055). Then, indoor arrangement processing is performed (S1056, See FIG. 43).

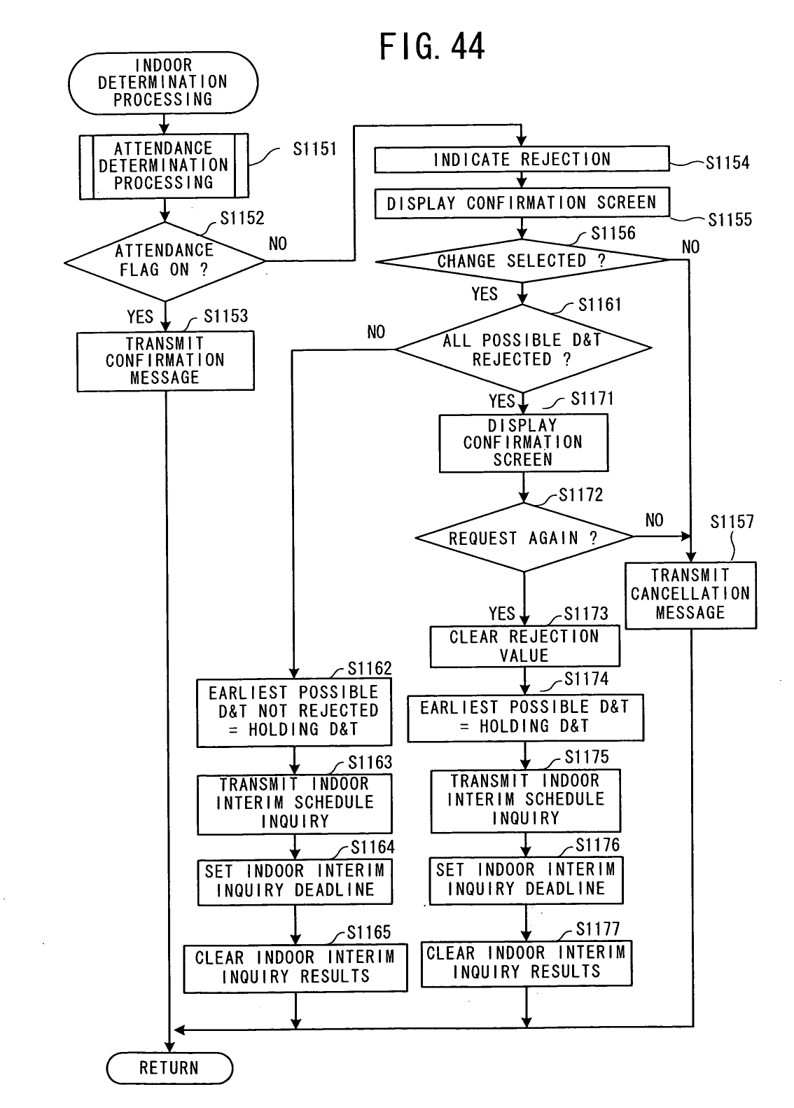

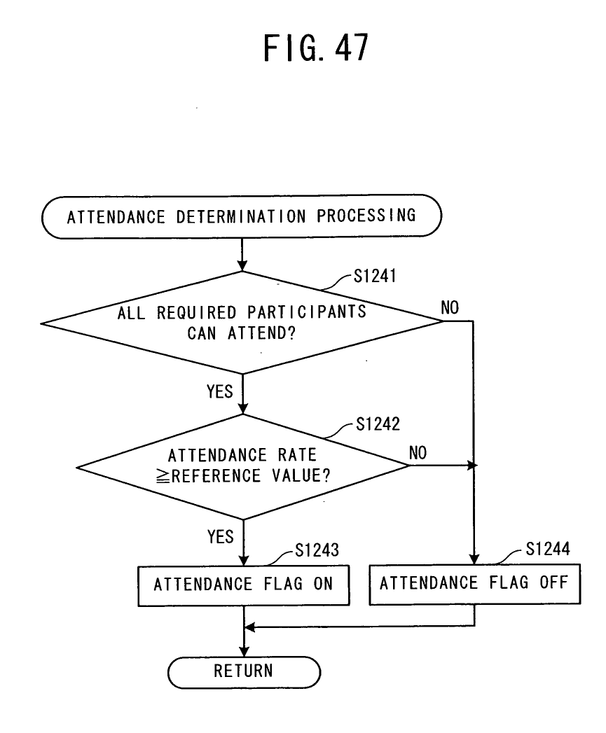

As shown in FIG. 43, in the indoor arrangement processing, the interim inquiry result storage area 1238 is referenced to determine whether there is any location change request (S1131). If there is no location change request (No at S1131), the present holding date and time may be fixed. In such a case, indoor determination processing is performed (S1132, see FIG. 44) before returning to step S1001 in the main processing shown in FIG. 36. As shown in FIG. 44, attendance determination processing is first performed in the indoor determination processing (S1151, FIG. 47).

As shown in FIG. 47, in the attendance determination processing, the interim inquiry result storage area 1238 is referenced to determine whether all the required participants have responded indicating “attendance” (S1241). If all the required participants have not responded indicating “attendance” (No at S1241), the schedule cannot be registered. Therefore, a value “0 (zero)” is stored in the attendance flag to set the flag OFF (S1244). Then, the processing returns to the indoor determination processing in FIG. 44.

If all the required participants have responded indicating “attendance” (Yes at S1241), the interim inquiry result storage area 1238 is referenced to calculate an attendance rate. It is then determined whether the attendance rate is equal to or more than a reference value (S1242). The reference value may be inputted in the attendance condition field of the new schedule input screen 901 (See FIG. 15). If no value is inputted in this field, a predetermined value, for example, 80% may be used as the reference value. If the attendance rate is less than the reference value (No at S1242), a value “0” is stored in the attendance flag to set the flag OFF (S1244), and the attendance determination processing is terminated. If the attendance rate is equal to or more than the reference value (Yes at S1242), a value “1 (one)” is stored in the attendance flag to set the flag ON (S1243), and the attendance determination processing is terminated to return to the indoor determination processing in FIG. 44.

As shown in FIG. 44, in the indoor determination processing after the attendance determination processing (S1151), it is determined whether the attendance flag is ON (S1152). If the attendance flag is ON (Yes at S1152), the schedule may be fixed. Accordingly, determination information indicating a content of the schedule is transmitted to the user terminals 12 of the participants (S1153). In the user terminal 12 of the participant, though not shown in the main processing, reception processing of the determination information may be performed in the other processing step (FIG. 40, S1100). More specifically, a determination information screen (not shown) showing the content of the schedule may be displayed on the display 14 and the schedule may be stored into the personal schedule DB storage area 1181 of the hard disk drive 18.

If the attendance flag is not ON (No at S1152), a rejection value is stored into the rejection check field corresponding to the possible date and time field of the possible date and time storage area 1236 (See FIG. 33) in which the present holding date and time is stored (S1154). Then, confirmation screen for change or cancellation (not shown) is displayed (S1155). In the confirmation screen, a conference name, a date and time, a location, and participants are displayed as a content of the schedule. In addition, a “Change” button and a “Cancel” button are displayed along with a message that a required participant cannot attend or the attendance rate is lower than the reference value.

If the “Change” button is selected (Yes at S1156), the schedule will be reexamined by setting another possible date and time. If the “Cancel” button is selected (No at S1156), information to display a message indicating that the schedule has been canceled is transmitted to the user terminals 12 of the participants (S1157). Though not shown in the main processing, after the information being received, the content of the schedule and text notifying that the schedule has been canceled are displayed on the display 14 in the other processing step (FIG. 40, S1100) of the user terminal 12 of the participant.

A case in which the “Change” button is selected (Yes at S1156) will be described below. First, the rejection check field of the possible date and time storage area 1236 is referenced to determine whether there is any possible date and time for which the rejection value is not stored (S1161). If the rejection value is not stored in all of the rejection check fields (No at S1161), there are still possible dates and times to be examined. Therefore, the earliest date and time among the possible dates and times for which the rejection value is not stored is stored into the holding date and time storage area 1231 as the holding date and time (S1162). Then, the indoor interim schedule inquiry information is again transmitted to the user terminals 12 of the participants (S1163). Then, the date and time indicating the indoor interim inquiry deadline is stored in a predetermined storage area (not shown) of the RAM 103 (S1164), and the interim inquiry result storage area 1238 is cleared (S1165). Then, the processing returns to step S1001 in the main processing shown in FIG. 36.

If the rejection value is stored in all the rejection check fields (Yes at S1161), a confirmation screen for re-request or cancellation (not shown) is displayed (S1171). In the confirmation screen, a conference name, a date and time, a location, and participants are displayed as a content of the schedule. In addition, a “Request again” button and a “Cancel” button are displayed along with a message indicating that the schedule cannot be arranged at all possible dates and times. If the “Request again” button is selected (Yes at S1172), the rejection check field of the possible date and time storage area 1236 is cleared (S1173), and the earliest date and time among the possible dates and times is set as the holding date and time (S1174). Then, the indoor interim schedule inquiry information is transmitted again to the user terminals 12 of the participants (S1175). The date and time indicating the indoor interim inquiry deadline is stored in a predetermined storage area (not shown) of the RAM 103 (S1176), and the interim inquiry result storage area 1238 is cleared (S1177). Then, the indoor determination processing terminates and returns to step S1001 in the main processing shown in FIG. 36.

If the “Cancel” button is selected (No at S1172), information to display a message indicating that the schedule has been canceled is transmitted to the user terminals 12 of the participants (S1157). In the user terminal 12 of the participant, though not shown in the main processing, after the information is received, the content of the schedule and text notifying that the schedule has been canceled are displayed on the display 14 in the other processing step (S1100). Then, the indoor determination processing terminates and returns to S1001 in the main processing shown in FIG. 36.

A case in which a “location change request” is made (Yes at S1131 in FIG. 43) in the indoor arrangement processing will be described with reference to FIG. 43. In this case, as shown in FIG. 43, a location change request screen (not shown) indicating that a location change request has been made is displayed (S1133). The location change request screen shows the content of the schedule, results of the interim inquiries of all the participants, and a message indicating that a location change request has been made. Further, a “Change” button, a “Register” button, and a selection field of a new desired location are provided.

If the “Register” button is selected (No at S1134), instead of the “Change” button, the indoor determination processing is performed (S1132). If, on the other hand, a new desired location is selected in the selection field and the “Change” button is selected (Yes at S1134), the holding location in the holding location storage area 1232 is changed to the newly selected location (S1135). Then, the indoor interim schedule inquiry information is transmitted to the user terminals 12 of the participants with the new holding location (S1136). The indoor interim inquiry deadline is stored in a predetermined storage area (not shown) of the RAM 103 (S1137) and the interim inquiry result storage area 1238 is cleared (S1138). Then, the indoor determination processing terminates and returns to step S1001 in the main processing shown in FIG. 36.

As described above with the first example, if an indoor location is selected as the holding location, inquiries about available dates and times and attendance are made at the user terminals 12 of the participants. If all required participants respond indicating “attendance” and the attendance rate is equal to or more than the reference value, the schedule may be fixed. Then, the determined schedule is stored into the respective personal schedule DB storage areas 1181 of the user terminals 12 of the participants.

Next, processing to be performed in the user terminal 11 of the drafter and the user terminal 12 of the participant will be described, using the second example in which the holding location is outdoors.

As shown in FIG. 36, when a registration of a new schedule is instructed in the user terminal 11 of the drafter (Yes at S1001), the new schedule input screen 901 (See FIG. 15) is displayed (S1021). Subsequently, if the “Register” button is selected, the input information is stored into the desired information storage area 1234 as the desired information (S1022). Then, it is determined whether the holding location is outdoors by referencing the location DB storage area 1282 (S1023). In the second example, the holding location is outdoors (Yes at S1023) In such a case, a value “1 (one)” is stored in the weather flag to set the flag ON (S1025). Then, the weather forecast for the desired dates and times is acquired from the weather forecast DB storage area 1283 of the server 20 (S1026) to determine whether there is any date and time of a clear weather (clear date and time) (S1027).

If there is any clear date and time (Yes at S1027), the clear date and time is stored into the candidate date and time storage area 1235 as the candidate date and time (S1031). Then, the processing proceeds to step S1032. If there is no clear date and time (No at S1027), a confirmation screen (not shown) is displayed (S1028). Here, a message is displayed to indicate that the holding location is outdoors and a clear weather is not forecast. Further, a “No change” button and a “Change” button are provided. If the “No change” button is selected (No at S1029), the schedule should be registered even if the weather is not a clear weather. Thus, the desired date and time stored in the desired information storage area 1234 is stored into the candidate date and time storage area 1235 as the candidate date and time (S1030). Then, the processing proceeds to step S1032. If the “Change” button is selected (Yes at S1029), the processing returns to step S1021 to display the new schedule input screen 901 (S1021).

At step S1032, availability inquiry information is transmitted to the user terminals 12 of the participants (S1032). The availability inquiry information contains the candidate date and time. Then, a date and time indicating an availability inquiry deadline, that is, the date and time after a predetermined time (for example, two days) from the current date and time is stored in a predetermined storage area (not shown) of the RAM 103 (S1033). Further, the availability inquiry result storage area 1237 is cleared (S1034). Then, the processing returns to step S1001.

In the user terminal 12 of the participant to which the availability inquiry information has been transmitted, the availability inquiry information is received (Yes at S1006 in FIG. 39). Then, the schedule of the candidate date and time is read from personal schedules stored in the personal schedule DB storage area 1181 of the hard disk drive 18 of the user terminal 12. Then, unoccupied dates and times are set as available dates and times (S108) and available-date-and-time response information containing the available dates and times is transmitted to the user terminal 11 of the drafter (S1082).

Meanwhile, it is determined in the user terminal 11 of the drafter that the user terminal 11 is waiting for a response to an availability inquiry (Yes at S1002 in FIG. 37), because the availability inquiry deadline is stored. Thus, it is determined whether the available-date-and-time response information has been received from the user terminal 12 of the participant (S1041). If the available-date-and-time information has been received (Yes at S1041), the received response, that is, the available dates and times are stored into the availability inquiry result storage area 1237 (S1042). If no available-date-and-time information has been received, the processing proceeds to step S1043.

Then, it is determined whether the available-date-and-time response information has been received from all the participants (S1043). Specifically, the number of data pieces stored in the availability inquiry result storage area 1237 and the number of the participants stored in the desired information storage area 1234 may be compared. If the number of data pieces o is smaller than the number of the participants, it may be determined that the available-date-and-time information has not been received from all the participants (No at S1043). Thus, it is determined whether the availability inquiry deadline has passed (S1044). If the availability inquiry deadline has not passed (No at S1044), the processing returns to step S1001.

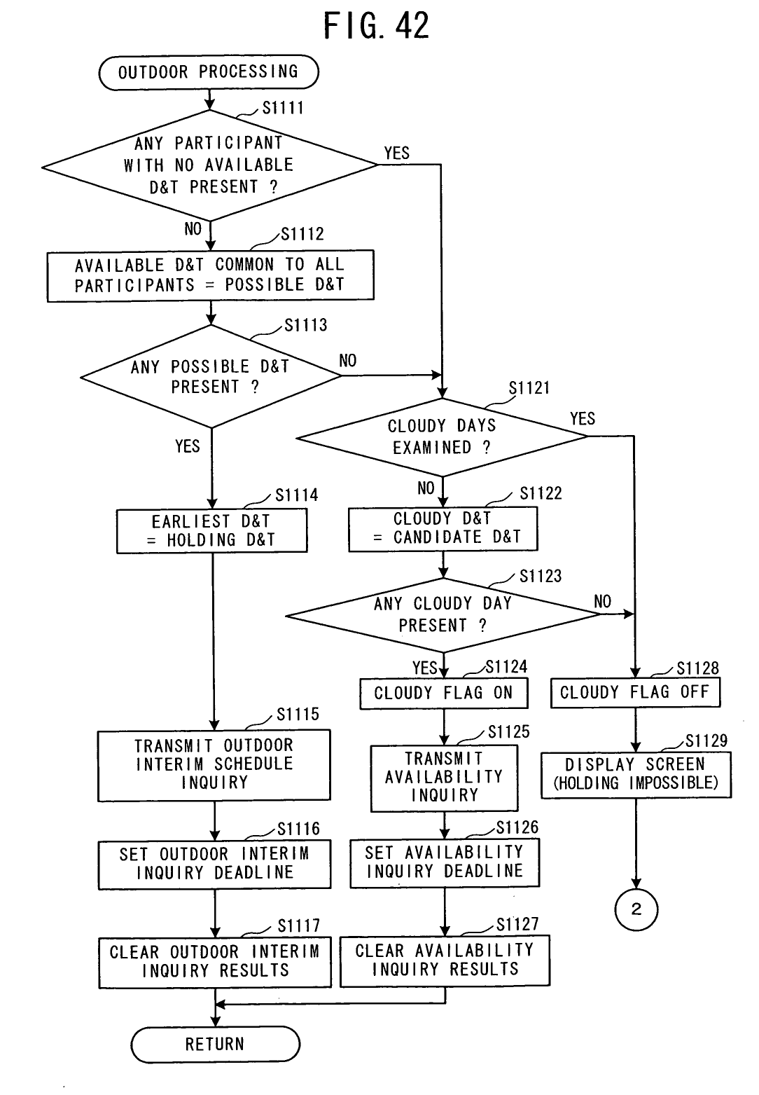

Then, the processing at steps S1001, S1002 and S1041 to S1044 is repeated and when the available-date-and-time response information is received from all the participants (Yes at S1043), the availability inquiry deadline is cleared (S1045). If the availability inquiry deadline has passed (Yes at S1044), while the available-date-and-time response information has not been received from all the participants (No at S1043), the availability inquiry deadline is cleared (S1045). Because the holding location is outdoors in the second example (Yes at S1046), outdoor processing will be performed (S1047, See FIG. 42).

As shown in FIG. 42, in the outdoor processing, the availability inquiry result storage area 1237 is referenced to determine whether there is any participant who has no available date and time (S1111). If there is no participant who has no available date and time (No at S1111), the availability inquiry result storage area 1237 is referenced to extract available dates and times common to all participants. The extracted dates and times are stored into the possible date and time fields of the possible date and time storage area 1236 as the possible date and time (S1112). Then, it is determined whether there is any possible date and time (S1113).

If there are possible dates and times (Yes at S1113), the earliest date and time among the possible dates and times is stored into the holding date and time storage area 1231 as the holding date and time (S1114). Then, outdoor interim schedule inquiry information is transmitted to the user terminals 12 of the participants (S1115). The outdoor interim schedule inquiry information contains the holding date and time and the holding location, and an inquiry as to whether the holding date and time and the holding location are suitable for each participant. Then, the date and time indicating an outdoor interim inquiry deadline, that is, the date and time after a predetermined time (for example, two days) from the current date and time is stored in a predetermined storage area (not shown) in the RAM 103 (S1116). Then, the interim inquiry result storage area 1238 is cleared (S1117). Then, the outdoor processing terminates to return to step S1001 shown in FIG. 36.

As shown in FIG. 40, if the outdoor interim schedule inquiry information is received at the user terminal 12 of the participant to which the outdoor interim schedule inquiry information has been transmitted (Yes at S1007), the attendance confirmation screen 903 (See FIG. 17) is displayed (S1091). Then, input from the user, who is the participant, is accepted. If the “Attend” button is selected (Yes at S1092), outdoor attendance response information indicating attendance is transmitted to the user terminal 11 of the drafter (S1093). If the “Not attend” button is selected (No at S1092), instead of the “Attend” button, outdoor attendance response information indicating absence is transmitted to the user terminal 11 of the drafter (S1094). Then, the processing returns to step S1001 in the main processing shown in FIG. 36.

In this manner, the outdoor attendance response information is transmitted from the user terminals 12 of the participants to the user terminal 11 of the drafter. In the meantime, it is determined in the user terminal 11 of the drafter that the user terminal 11 is waiting for a response to an outdoor interim inquiry (Yes at S1004 in FIG. 38), because the user terminal 11 of the drafter has the date and time of outdoor interim inquiry deadline stored. Thus, it is determined whether the outdoor attendance response information has been received (S1061). If the outdoor attendance response information has been received (Yes at S1061), the received response, that is, a value indicating “attendance”, “absence”, or “location change request” is stored into the interim inquiry result storage area 1238 (S1062). If no outdoor attendance response information has been received, the processing proceeds to step S1063.

Then, it is determined whether the outdoor attendance response information has been received from of all the participants (S1063). More specifically, the number of data pieces stored in the interim inquiry result storage area 1238 and the number of participants stored in the desired information storage area 1234 may be compared. If the number of data pieces is smaller than the number of the participants, it is determined that the outdoor attendance response information has not been received form all the participants (No at S1063). Thus, it is determined whether the outdoor interim inquiry deadline has passed (S1064). If the outdoor interim inquiry deadline has not passed, the processing returns to step S1001 in the main processing shown in FIG. 36.

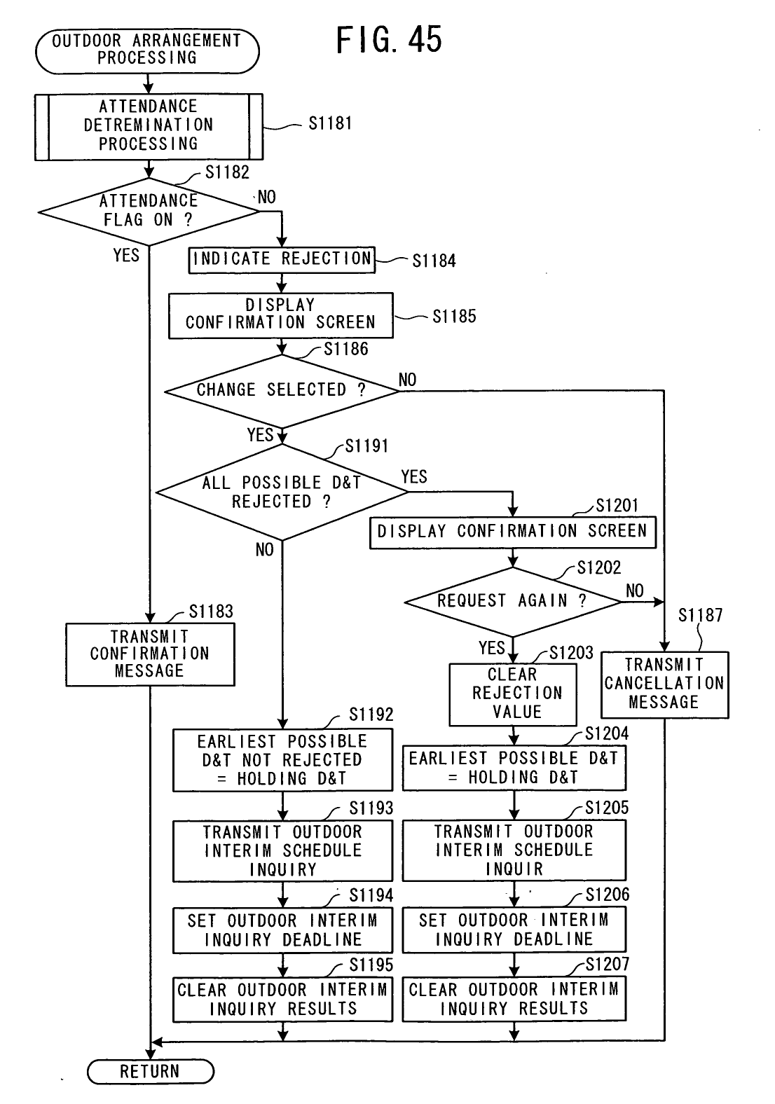

Then, the processing at steps S1001 to S1004 and S1061 to S1064 is repeated and when the outdoor attendance response information has been received from all the participants (Yes at S1063), the outdoor interim inquiry deadline is cleared (S1065). If the outdoor interim inquiry deadline has passed (Yes at S1064) while the outdoor interim inquiry response information has not been received from all the participants (No at S1063), the outdoor interim inquiry deadline is cleared (S1065). Then, outdoor arrangement processing will be performed (S1066, See FIG. 45).

In the outdoor arrangement processing, as shown in FIG. 45, the attendance determination processing is performed (S1181, See FIG. 47). Because the attendance determination processing is described above, a description thereof is only cited and not repeated in detail here. In sum, if a required participant cannot attend or the attendance rate is lower than the reference value, the attendance flag is set OFF, while if all the required participants can attend and the attendance rate is equal to higher than the reference value, the attendance flag is set ON.

After the attendance determination processing (S1181), it is determined whether the attendance flag is ON (S1182). If the attendance flag is ON (Yes at S1182), the schedule is fixed and determination information showing the content of the schedule is transmitted to the user terminals 12 of the participants (S1183). In the user terminal 12 of the participant, though not shown in the main processing, after the determination information is received, reception processing is performed in the other processing step (S1110 in FIG. 40). More specifically, a determination information screen (not shown) containing the content of the schedule is displayed in the display 14 and the schedule is stored into the personal schedule DB storage area 1181 of the hard disk drive 18.

If the attendance flag is not ON (No at S1182), in the possible date and time storage area 1236 (See FIG. 33), a rejection value is stored into the rejection check field corresponding to the possible date and time field in which the holding date and time is stored (S1184). Then, a confirmation screen for a change or cancellation (not shown) is displayed (S1185). In the confirmation screen, a conference name, a date and time, a location, and participants are displayed as the content of the schedule. In addition, a “Change” button and a “Cancel” button are displayed along with a message indicating that a required participant cannot attend or the attendance rate is lower than the reference value.

If the “Change” button is selected (Yes at S1186), the schedule will be reexamined with another possible date and time. If the “Cancel” button is selected (No at S1186), information to display a message indicating that the schedule has been canceled to the user terminals 12 of the participants (S1187). In the user terminal 12 of the participant, though not shown in the main processing, after the information being received, the content of the schedule and text notifying that the schedule has been canceled are displayed on the display 14 in the other processing step (S1110 in FIG. 40).

A case in which the “Change” button is selected (Yes at S1186) will be described below. First, the rejection check field of the possible date and time storage area 1236 is referenced to determine whether there is any possible date and time for which the rejection value is not stored (S1191). If the rejection value is not stored in all the rejection check fields (No at S1191), there may still be possible dates and times to be examined. Thus, the earliest date and time among the possible dates and times for which the rejection value is not stored is stored into the holding date and time storage area 1231 as the holding date and time (S1192). Then, outdoor interim schedule inquiry information is again transmitted to the user terminals 12 of the participants (S1193). Then, an outdoor interim inquiry deadline is stored in a predetermined storage area (not shown) of the RAM 103 (S1194) and the interim inquiry result storage area 1238 is cleared (S1195). Then, the processing returns to step S1001 in the main processing shown in FIG. 36.

If a rejection value is stored in all the rejection check fields (Yes at S1191), a confirmation screen for a request or cancellation (not shown) is displayed (S1201). In the confirmation screen, a conference name, a date and time, a location, and participants are displayed as the content of the schedule. Further, a “Request again” button and a “Cancel” button are displayed along with a message indicating that the schedule cannot be arranged at all possible dates and times.

If the “Request again” button is selected (Yes at S1202), the rejection check field of the possible date and time storage area 1236 is cleared (S1203). The earliest date and time among the possible dates and times is set as the holding date and time (S1204), and outdoor interim schedule inquiry information is again transmitted to the user terminals 12 of the participants (S1205). Then, an outdoor interim inquiry deadline is stored in a predetermined storage area (not shown) of the RAM 103 (S1206) and the interim inquiry result storage area 1238 is cleared (S1207). Then, the outdoor determination processing terminates and returns to step S1001 in the main processing shown in FIG. 36.

If the “Cancel” button is selected (No at S1202), information to display a message indicating that the schedule has been canceled is transmitted to the user terminals 12 of the participants (S1187). In the user terminal 12 of the participant, though not shown in the main processing, after the information being received, the content of the schedule and text notifying that the schedule has been canceled are displayed on the display 14 in the other processing step (S1110 in FIG. 40). Then, the indoor determination processing terminates and returns to S1001 in the main processing shown in FIG. 36.

In the outdoor processing shown in FIG. 42, if there is a participant who has no available date and time (Yes at S1111) or no date and time is stored in the possible date and time field and thus, there is no possible date and time (No at S1113), the schedule cannot be set at a clear date and time. Therefore, it is determined whether dates and times at which cloudy weathers are forecast have been examined, based on whether the cloudy flag is ON (S1121). Because the initial value of the cloudy flag is OFF, it is determined that cloudy days have not been examined (No at S1121). In such a case, a cloudy date and time among the desired dates and times is set as the candidate date and time (S1122). Then, it is determined whether there is any cloudy date and time, that is, there is a candidate date and time (S1123). If there is no cloudy date and time (No at S1123), the processing proceeds to step S1128.

If there is any cloudy date and time (Yes at S1123), a value “1 (one)” is stored in the cloudy flag to set the flag ON (S1124). Then, the availability inquiry information is transmitted to the user terminals 12 of the participants (S1125). The date and time indicating an availability inquiry deadline is stored in a predetermined storage area (not shown) of the RAM 103 (S1126), and the availability inquiry result storage area 1237 is cleared (S1127). Then, the outdoor processing terminates and returns to step S1001 shown in FIG. 36.

At the user terminal 12 of the participant to which the availability inquiry information has been transmitted, the availability inquiry information is received (Yes at S1006 in FIG. 39). The schedule of the candidate date and time is read from personal schedules stored in the personal schedule DB storage area 1181 of the hard disk drive 18 of the user terminal 12. Then, unoccupied dates and times are set as the available dates and times (S1081), and the available-date-and-time response information containing the available dates and times is transmitted to the user terminal 11 of the drafter (S1082).

In the outdoor processing shown in FIG. 42, if the cloudy flag is ON, that is, cloudy dates and times have already been examined (Yes at S1121), a value “0 (zero)” is stored in the cloudy flag to set the flag OFF (S1128), and a screen indicating that the schedule cannot be arranged (not shown) is displayed (S1129). In the screen, a message indicating that the weathers at the desired dates and times are expected to be bad, or some participants are not available or the like is displayed. Then, the processing returns to step S1021 in the main processing shown in FIG. 36 and the new schedule input screen 901 is displayed (S1021).

As described above, if an outdoor location is selected as the holding location, the holding date and time is determined by giving priority to dates and times with a clear weather, and inquiries about available dates and times and about attendance are made at the user terminals 12 of the participants. If all the required participants can attend the conference and the attendance rate is equal to or higher than the reference value, the schedule may be fixed and stored into the personal schedule DB storage area 1181 of the user terminal 12 of each participant.

In the second embodiment, it is determined whether the current time is a weather check time in the main processing (FIG. 39, S1005). The weather check time is a predetermined time and, for example, 9:00 am. If the current time is the weather check time (Yes at S1005), the personal schedule DB storage area 1181 is referenced to determine whether there is a schedule to be subjected to a weather check (S1071). This determination may be made based on whether the schedule is self-drafted and the holding date and time is within a predetermined time (for example, two days). If there is no schedule to be subjected to a weather check (No at S1071), the processing returns to step S1001 in FIG. 36 If there is a schedule to be subjected to a weather check (Yes at S1071), the weather forecast at the holding date and time of the schedule is acquired from the server 20 (S1072).

If any warning has been issued (Yes at S1073) or a rainy weather is forecast (No at S1073, Yes at S1074), the holding confirmation screen 905 (See FIG. 35) is displayed (S1075). If the “No change” button is selected (No at S1076), there may be no need to do anything. Thus, the processing returns to step S1001 in FIG. 36. If the “New schedule” button is selected (Yes at S1076), the processing returns to step S1021 in FIG. 36 and the new schedule input screen 901 is displayed (S1021).

Though not shown, information to display a message indicating that the schedule has been deleted is transmitted to the user terminals 12 of the participants, and the schedule is deleted from the personal schedule DB storage area 1181 of the drafter. When the information is received by the user terminal 12 of the participant, a message indicating that the schedule has been deleted is displayed in the other processing step of S1100 in FIG. 40. Further, the schedule is deleted from the personal schedule DB storage area 1181 of the participant.

As described above, when the holding date and time of a schedule approaches, the weather forecast on that day is referenced. Therefore, even if the weather forecast is changed after the schedule was registered, steps can be taken against the change.

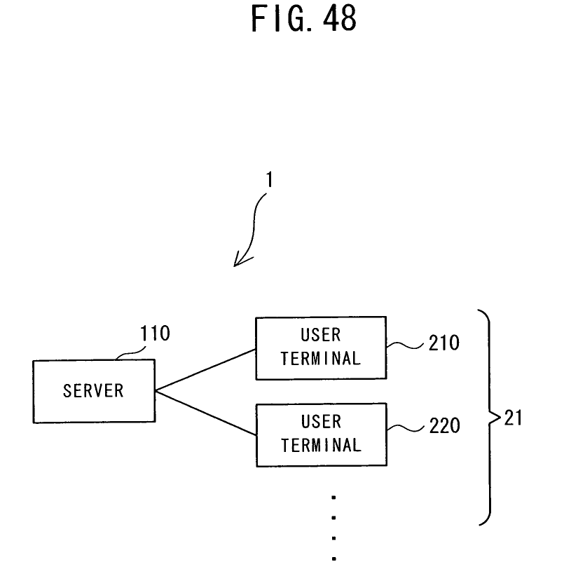

Next, the scheduling system 1 according to the third exemplary embodiment will be described with reference to FIGS. 48 to 68. As described in detail below, of a server 110 and user terminals 21 connected via a network in a scheduling system 1 of the third embodiment, the user terminals 21 have a main scheduling function.

First, an outline configuration of the scheduling system 1 according to the third embodiment will be described with reference to FIGS. 48 to 50. As shown in FIG. 48, the scheduling system 1 includes the server 110 and a plurality of the user terminals 21, such as user terminals 210, 220, and the like, connected to the server 110 via a network. In the scheduling system 1, a user 200 of the user terminal 21 may access the server 110 from the user terminal 21 via the network and acquire necessary data to perform processing of arranging a schedule in the user terminal 21.

When a term “user terminals 21” or a “user terminal 21” is used hereinafter, the plurality of the user terminals 210, 220, . . . including all other user terminals is generically called or an unspecified user terminal is indicated. When a term “user terminal 210” is used hereinafter, some specific “user terminal 210” is indicated. It is also assumed that each of the user terminals 21 has a specified user, the “user 200” indicates a user of the user terminal 21 that is not specified, and a “user 201” indicates “the user 201 of the user terminal 210”.

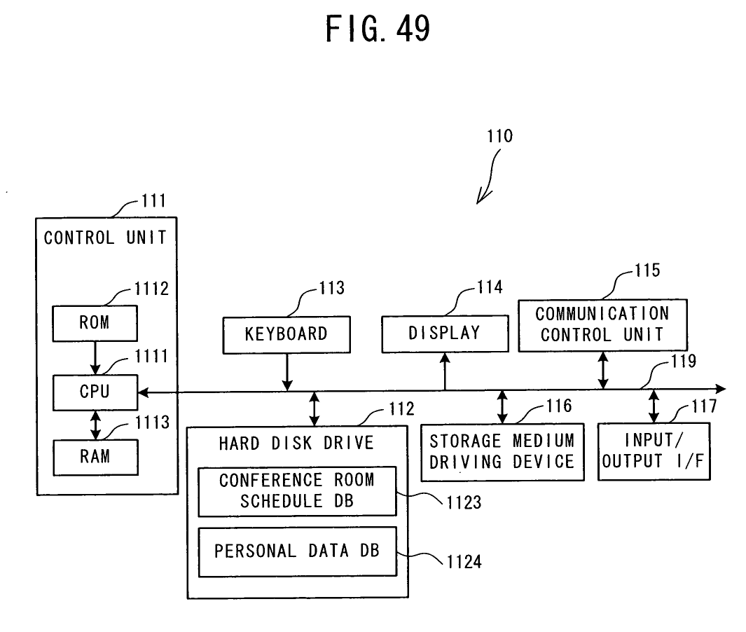

Next, an electrical configuration of the server 110 will be described with reference to a block diagram of FIG. 49. As shown in FIG. 49, the server 110 is provided with a control unit 111 including a CPU 1111 to manage control of the server 110, a ROM 1112 storing BIOS and the like, and a RAM 1113 having storage areas to temporarily store various kinds of data. The ROM 1112 and the RAM 1113 are each connected to the CPU 1111. The CPU 1111 is further connected via a data bus 119 to a hard disk drive 112 described later, a keyboard 113 through which various kinds of data are inputted, a display 114 to display various kinds of data, a communication control unit 115 to control communication performed with the user terminal 20 via the network, a storage media driving device 116 to drive a storage medium such as a CD-ROM, and an input and output interface (I/F) 117 to mediate exchange of data.

The hard disk drive 112 of the server 110 has a plurality of storage areas. One of these storage areas includes a conference room schedule database 1123 storing data of conference rooms described later. Another storage area includes a personal data database 1124 storing personal information such an identification code, a name, a section, a post, a telephone number, and an e-mail address for each of all the users 200 of the user terminals 21. Further, though not shown, various kinds of programs to be executed by the CPU 1111 are stored in other storage areas.

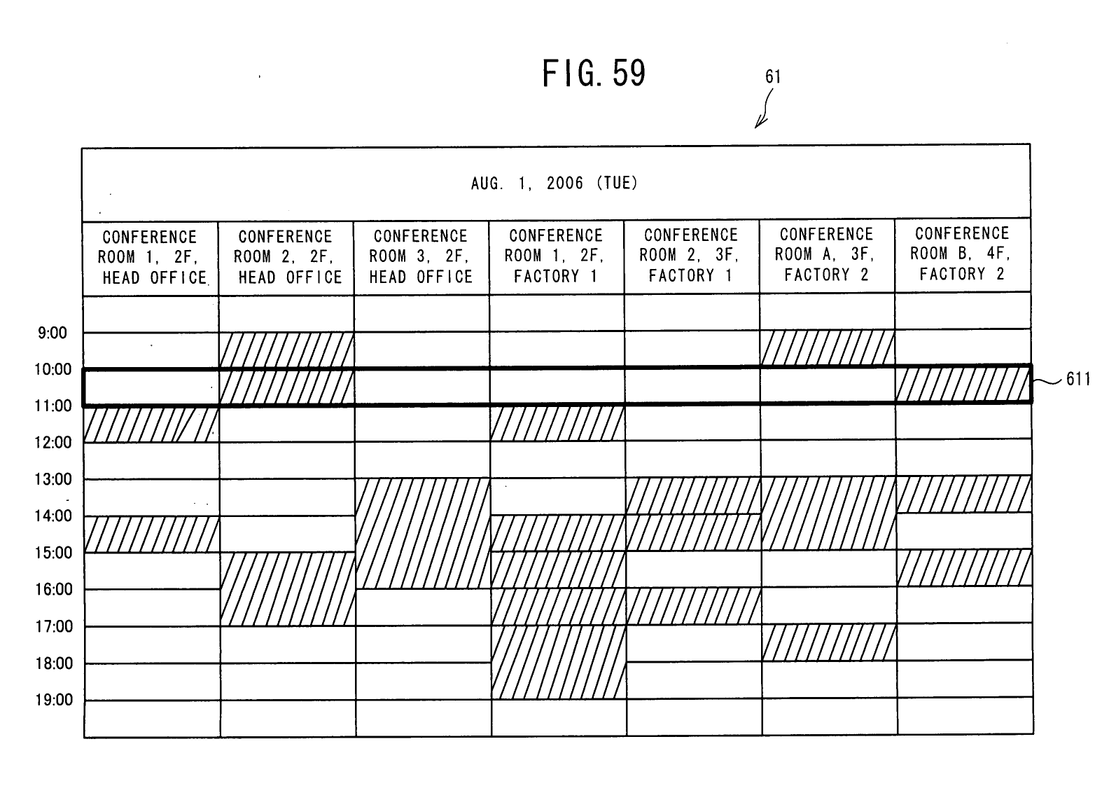

Conference room data stored in the conference room schedule database 1123 will be described with reference to FIG. 59. In the conference room schedule database 1123, conference room data is stored for each conference room managed by the server 110. The conference room data may include, for example, a name of the conference room, a location, a reserved date and time, a person who registered the reservation, a classification of an event such as a “conference” and a “seminar”, and participants of the event. FIG. 59 shows a state in which conference room data of Aug. 1, 2006 is displayed in a conference room reservation status display screen 61, which is an example of conference room data display screen. The conference room data of the day may be specified using the keyboard 113 of the server 110 or a keyboard 213 (described later) of the user terminal 21 connected to the server 110 via the network.

In the conference room data in this example, “Conference Room 1 on 2F, Head Office”, “Conference Room 2 on 2F, Head Office”, “Conference Room 3 on 2F, Head Office”, “Conference Room 1 on 2F, Factory 1”, “Conference Room 2 on 3F, Factory 1”, “Conference Room A on 3F, Factory 2”, and “Conference Room Bon 4F, Factory 2” are registered as the names. As the locations corresponding to the names, “2F in Head Office”, “2F in Head Office”, “2F in Head Office”, “2F in Factory 1”, “3F in Factory 1”, “3F in Factory 2”, and “4F in Factory 2” are registered, respectively. In the conference room data of “Conference Room 1 on 2F, Head Office”, for example, data of “11:00-12:00 of Aug. 1, 2006” and “14:00-15:00 of Aug. 1, 2006” is included as the reserved dates and times. In addition, though not shown, data on the person who registered the reservation, the classification of the event such as a “conference” and a “seminar”, the participants of the event, and details of the reservation may also be included corresponding to these reservations.

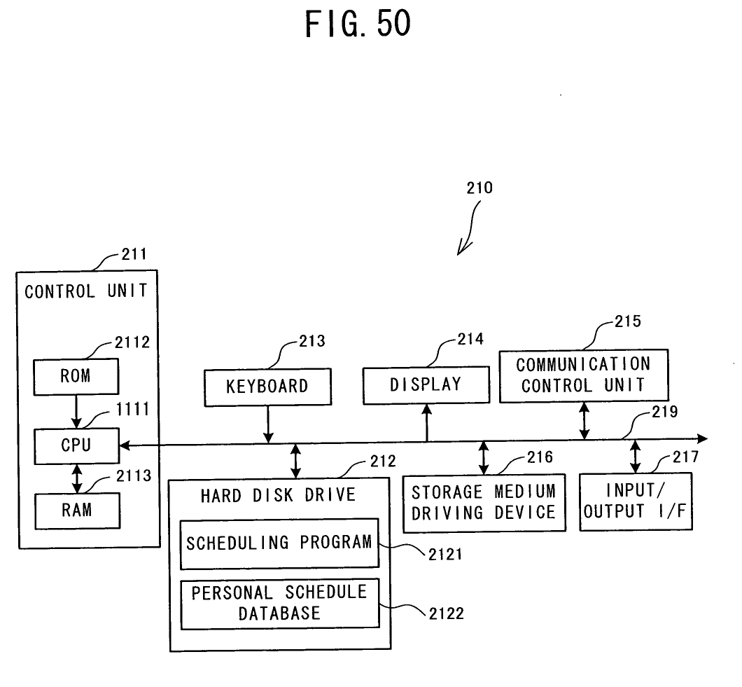

Next, an electrical configuration of the user terminal 210, which is one of the plurality of user terminals 21, will be described with reference to the block diagram in FIG. 50. Each of the user terminals 21 has the same configuration as the configuration of the user terminal 210 described below. As shown in FIG. 50, like the server 110, the user terminal 210 is provided with a control unit 211 including a CPU 2111 to manage control of the user terminal 210, a ROM 2112 storing BIOS and the like, and a RAM 2113 having storage areas to temporarily store various kinds of data. The ROM 2112 and the RAM 2113 are each connected to the CPU 2111.

The CPU 2111 is further connected via a data bus 219 to a hard disk drive 212 described later, a keyboard 213 through which various kinds of data are inputted, a display 214 to display various kinds of data, a communication control unit 215 to control communication performed with the server 110 via a network, a storage media driving device 216 to drive a storage medium such as a CD-ROM, and an input and output interface (I/F) 217 to mediate exchange of data.

The hard disk drive 212 of the user terminal 210 has a plurality of storage areas. One of these storage areas stores a scheduling program 2121 for performing processing of arranging a schedule after receiving inputs from the user 201 through the keyboard 213 or a notification from the other user terminal 220 and the like. The scheduling program 2121 will be described in detail later. Another storage area includes a personal schedule database 2122 storing personal schedule data of the user 201 of the user terminal 210. Further, though not shown, the hard disk drive 212 is provided with storage areas for storing various programs executed by the CPU 2111, a response storage area described later, a check-date-and-time storage area and the like.

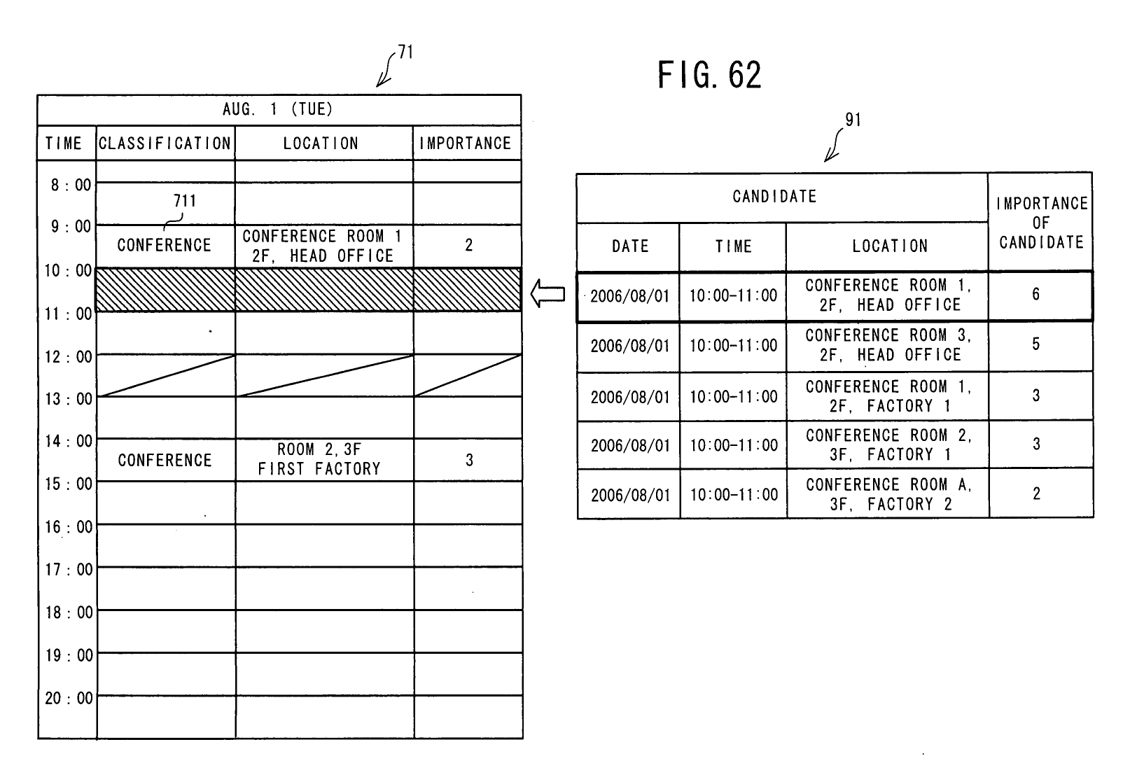

Personal schedule data stored in the personal schedule database 2122 will be described with reference to FIG. 62. In the personal schedule database 2122, schedule data including, for example, an identification code of the user 201 of the user terminal 210, a name of the user 201, a date and time of an event, a classification of the event such as a “conference” and a “seminar”, a location of the event, and participants of the event, may be registered. FIG. 62 shows a state in which schedule data of the user 201 on Aug. 1, 2006 is displayed in a schedule table 71, which is an example of a personal schedule data display screen. The schedule data of the day may be specified using the keyboard 213 of the user terminal 210.

In this example, though not shown, an employee code specific to the user 201 may be included as the identification code, and “A”, which is the name of the user 201, may be included as the name. Regarding a conference 711 shown in FIG. 62, “9:00-10:00 of Aug. 1, 2006” is registered as the date and time of the event, “Conference” is registered as the classification of the event, and “Conference Room 1 on 2F, Head Office” is registered as the location of the event. Further, participants “C, D, and E” are registered as the participants (not shown). In addition, a name of the event, such as “Regular meeting” and “Board meeting” may also be registered.

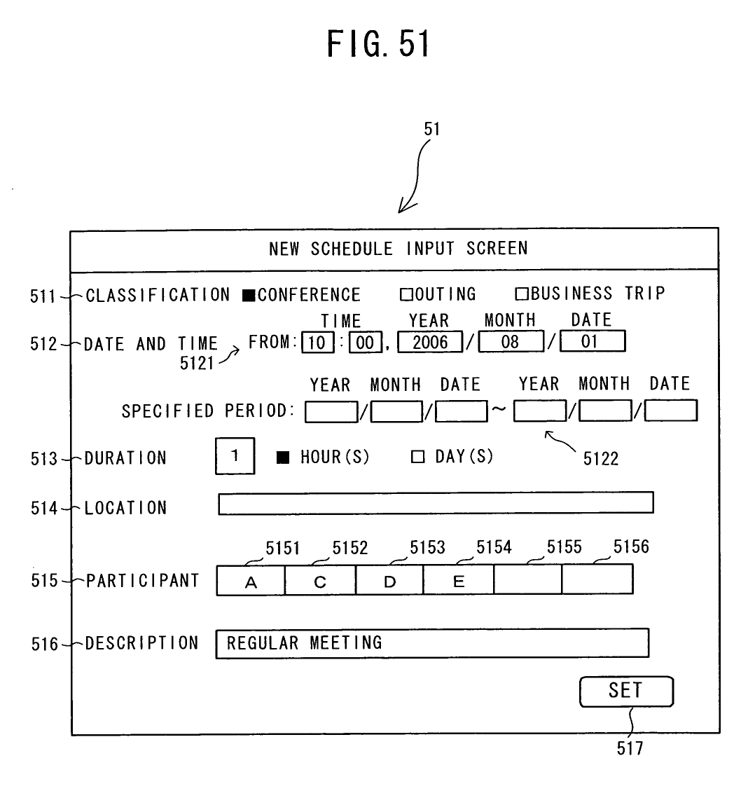

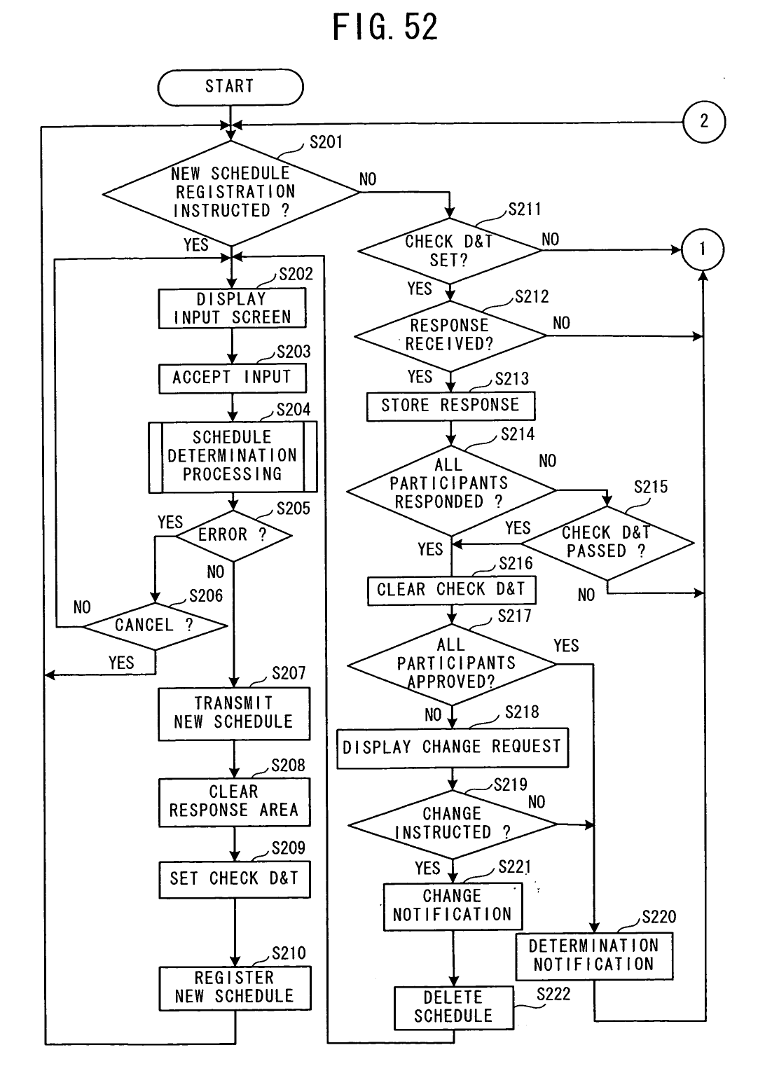

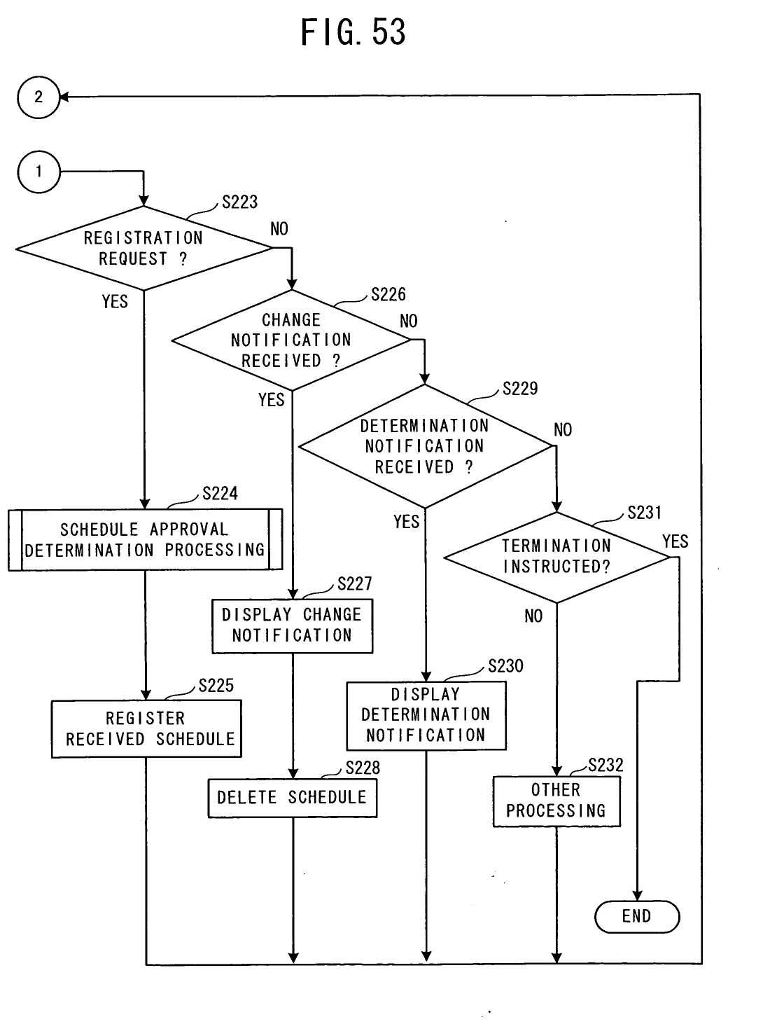

Next, main processing of the scheduling program 2121 that is executed by the CPU 2111 of the user terminal 210 will be described with reference to FIGS. 50 to 52. The main processing shown in FIGS. 52 and 53 will be started when the scheduling program 2121 is started in the user terminal 210. If the user 201 instructs a registration of a schedule of a new event, such as a conference, by selecting “Register new schedule” from the program menu (Yes at S201), the new schedule input screen 51 shown in FIG. 51 is displayed on the display 214 (S202). The new schedule input screen 51 is a screen to be used by the user 201 who wishes to arrange a schedule of a new event by the scheduling program 2121. The user 201 may input new event information using the keyboard 213 of the user terminal 21.

Input items of the new schedule input screen 51 shown in FIG. 51 will be described below more specifically. As shown in FIG. 51, a classification field 511 includes three categories of “Conference”, “Outing”, and “Business trip”, and the classification of a new event may be selected by clicking one of three check boxes corresponding to the categories. Date and time fields 512 may be used to specify a desired date and time for a new event. The date and time fields 512 include specified date and time fields 5121 and specified period fields 5122. The specified date and time fields 5121 may be used to specify a specific date and time, while the specified period fields 5122 may be used to specify a period to allow some latitude in which a new event may be held when an exact date and time cannot be designated.

In addition, a duration field 513, a location field 514, participant fields 515, and a description field 516 are provided. The duration field 513 may be used to input a time required for the new event. The location field 514 may be used to input a desired location for the new event. The participant fields 515 may be used to input participants who are to be requested to attend the new event. The description field 516 may be used to input a description of a new event, such as a name of a conference and the like. The participant fields 515 include a plurality of input fields 5151 to 5156 so that a plurality of names may be inputted. In the present embodiment, it is assumed that “A” inputted in the participant field 5151 is the “user 201”, who is the user of the user terminal 210.

Further, a “Set” button 517 is provided at the lower right corner of the new schedule input screen 51. When the “Set” button 517 is clicked, the input data is set as conditions to be considered in schedule determination processing (S204, See FIGS. 52 to 58) described later. The input data is stored into the RAM 2123, thereby completing input acceptance (FIG. 52, S203). In the present embodiment, the duration” field 513 and the participant fields 515 are required input items. Therefore, if the “Set” button 517 is clicked with no input in one of these fields, the processing may not proceed to the next step, and an error sound is produced.

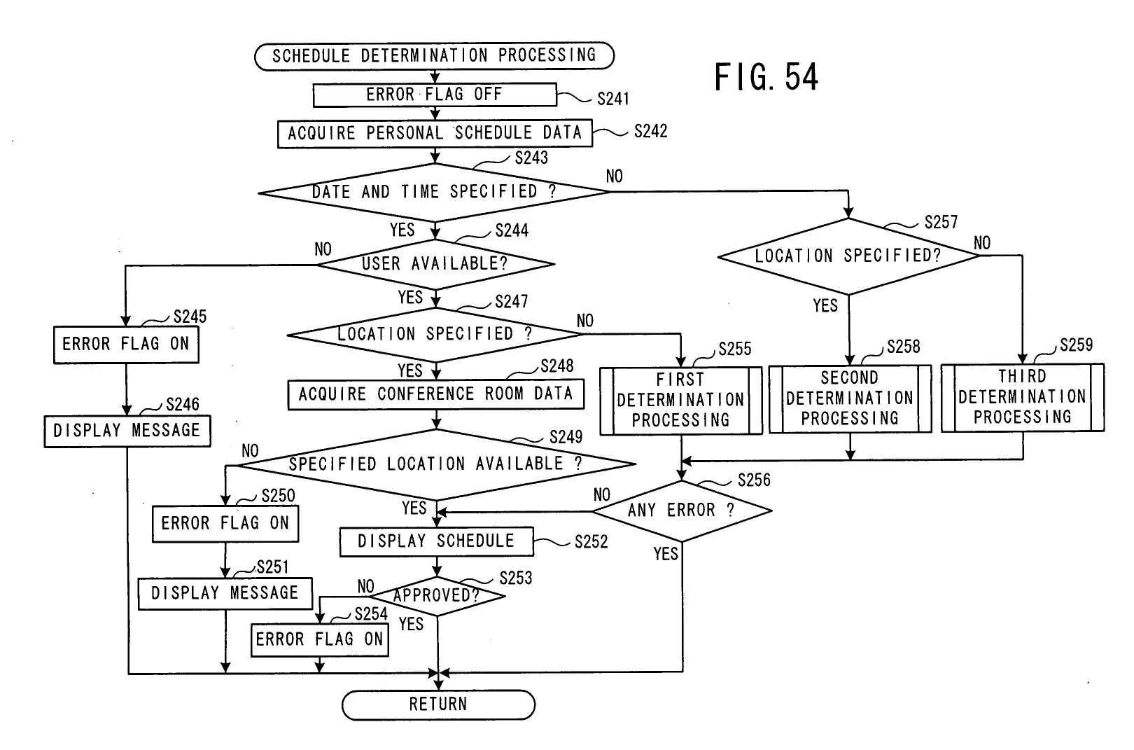

In the main processing shown in FIG. 52, after the input is accepted (S203), the CPU 2111 performs schedule determination processing (S204, See FIGS. 54 to 58), which will be described in detail later. Then, the CPU 2111 determines whether any error has occurred during the processing, based on an ON or OFF state of an error flag (S205). If an error has occurred (Yes at S205), the CPU 2111 displays a selection button on the display 214 to allow the user to select whether to cancel the processing. If cancellation is selected (Yes at S206), the CPU 2111 returns to the determination processing as to whether a registration of a new schedule has been instructed (S201). If cancellation is not selected (No at S206), the processing returns to display the new schedule input screen 51 (S202). Therefore, the user 201 may change the input conditions and perform the schedule determination processing again (S203 and S204).

If no error has occurred in the schedule determination processing (S204) (No at S205), the CPU 2111 transmits a registration request for a new schedule to the user terminals 21 used by the participants (S207). In the example of the new schedule input screen 51 shown in FIG. 51, the registration request is transmitted to user terminals 230, 240, and 250 used by the participants C (a user 203), D (a user 204) and E (a user 205) inputted in the participant fields 515 respectively. Because the participant A is the user 201 who instructed a schedule arrangement, the participant A may be excluded from destination addresses of the registration request. The registration request contains a classification, a date and time, a duration, a location, participants, and a description (conference name, for example) of a new schedule determined through the schedule determination processing (S204, See FIGS. 54 to 58).

After transmitting the registration request to the participants (S207), the CPU 2111 clears the response storage area (not shown), which is one of storage areas provided in the hard disk drive 212 (S208). Responses from the participants C, D, and E, each indicating whether a new schedule has been approved, may be stored into the response storage area. Then, the CPU 2111 sets a check date and time, which is a deadline for waiting for responses from the participants C, D, and E, and stores the check date and time into the check-date-and-time storage area (not shown) provided in the hard disk drive 212 (S209). For example, “0:00 of Jul. 15, 2006”, which is three days after the new event information is inputted by the user 201, may be set as the check date and time.

Further, the CPU 2111 registers the new schedule determined through the schedule determination processing (S204, See FIGS. 54 to 58) into the personal schedule database 2122 in the hard disk drive 212 of the user terminal 210. At the same time, the CPU 2111 accesses the conference room schedule database 1123 provided in the hard disk drive 112 of the server 110 via a network, and registers the new schedule into the conference room schedule database 1123 as well (S210). Then, the CPU 2111 returns to the determination processing as to whether a registration of a new schedule has been instructed (S201).

If a registration of a new schedule is not instructed following the start of the main processing shown in FIG. 52 (No at S201), the CPU 2111 checks whether a check date and time is stored in the check-date-and-time storage area in the hard disk drive 212 (S211). If a check date and time is stored (Yes at S211), a response to the registration request for the new schedule is awaited. In such a case, if a response is received from any of the participants C, D, and E (Yes at S212), the CPU 2111 stores the response into the response storage area of the hard disk drive 212 (S213).

Further, the CPU 2111 checks the response storage area of the hard disk drive 212 to see whether responses from all the participants C, D, and E have been received at this point (S214). If the responses from all the participants C, D, and E have not been received (stored) (No at S214), the CPU 2111 checks whether the check date and time (for example, 0:00 of Jul. 15, 2006) has passed (S215). If the check date and time has passed (Yes at S215) or the responses from all the participants C, D, and E are stored in the response area of the hard disk drive 212 (Yes at S214), there may be no need to wait for the responses any longer. Therefore, in both cases, the CPU 2111 erases the check date and time “0:00 of Jul. 15, 2006”, for example, to clear the check-date-and-time storage area in the hard disk drive 212 (S216).

Next, the CPU 2111 determines whether the responses of all the participants stored in the response area of the hard disk drive 212 indicate approval to the schedule whose registration has been requested (S217). If all the responses indicate approval (Yes at S217), there may be no need to change the schedule. Thus, the CPU 2111 transmits a schedule determination notification indicating that the schedule has been determined with the same content as that of the registration request of the new schedule transmitted at step S207 to the user terminals 230, 240, and 250 used by the participants C, D, and E, respectively (S220).

In the present embodiment, if there is a participant who has not responded when the check date and time has passed (No at S214, Yes at S215), the participant may be regarded as a participant who has transmitted a response of approval (Yes at S217). On the other hand, if a change request requesting a schedule change is included in responses from the participants (No at S217), the CPU 2111 displays a content of the change request on the display 214 (S218). The user 201 (A), who has inputted the new schedule, may select whether to change the schedule with a button displayed on the display 214. Processing that is performed when the user terminal 210 receives a registration request for a new schedule will be described in detail later.

If the user 201 (A) checks the content of the change request and determines not to change the schedule, because, for example, the change request is from a member whose participation is not necessarily required or the like, the user may click a “No change” button displayed on the display 214 (No at S219). In such a case, the CPU 2111 transmits a schedule determination notification indicating that the schedule has been determined without change with the same content as that of the registration request transmitted at step S207 to the user terminals 230, 240, and 250 used by the participants C, D, and E, respectively (S220).

On the other hand, if the user 201 (A) determines to change the schedule, because, for example, a required participant has requested that “the date and time of the schedule of the registration request be changed to an available date and time, because the date and time is occupied”, the user may click the “Change” button displayed on the display 214 (Yes at S219). In such a case, the CPU 2111 transmits a schedule change notification indicating that the schedule included in the registration request transmitted at step S207 to the user terminals 230, 240, and 250 used by the participants C, D, and E has been canceled and a registration of a changed schedule will be requested later (S221).

Further, the CPU 2111 deletes the schedule registered in the personal schedule database 2122 in the hard disk drive 212 of the user terminal 210. At the same time, the CPU 2111 accesses the conference room schedule database 1123 in the hard disk drive 112 of the server 110 via the network to erase the schedule registered in the conference room schedule database 1123 (S222). Then, the CPU 2111 displays the new schedule input screen 51 so that the user 201 may arrange a schedule again by changing the date and time or the like (S202).

If a registration of a new schedule is not instructed (No at S201) and no check date and time is stored in the check-date-and-time storage area of the hard disk drive 212, the user terminal 21 is not waiting for a response to a registration request for a new schedule transmitted by the user terminal 21 itself (No at S211). In such a case, the CPU 2111 checks whether any registration request for a new schedule has been received from one of the other user terminals 21 (FIG. 53, S223). Messages received from one of the other user terminals 21, including the registration request for the new schedule, may be stored in a predetermined storage area of the hard disk drive 212 of the user terminal 21.

If the CPU 2111 is waiting for a response to a transmitted registration request for a new schedule (Yes at S211) but a response has not been received (No at S212), or if responses of all the participants have not received yet (No at S214) and the check date and time has not passed yet (No at S215), the CPU 2111 also checks whether any registration request for a new schedule has been received from one of the other user terminals 21 (FIG. 53, S223). Further, after a schedule determination notification is transmitted (S220), the CPU 2111 also checks whether any registration request for a new schedule has been received (FIG. 53, S223). The schedule determination notification may be transmitted if responses of all the participants have been received (Yes at S214) and all participants have approved the schedule (Yes at S217), or if a change request has not been responded (No at S219).

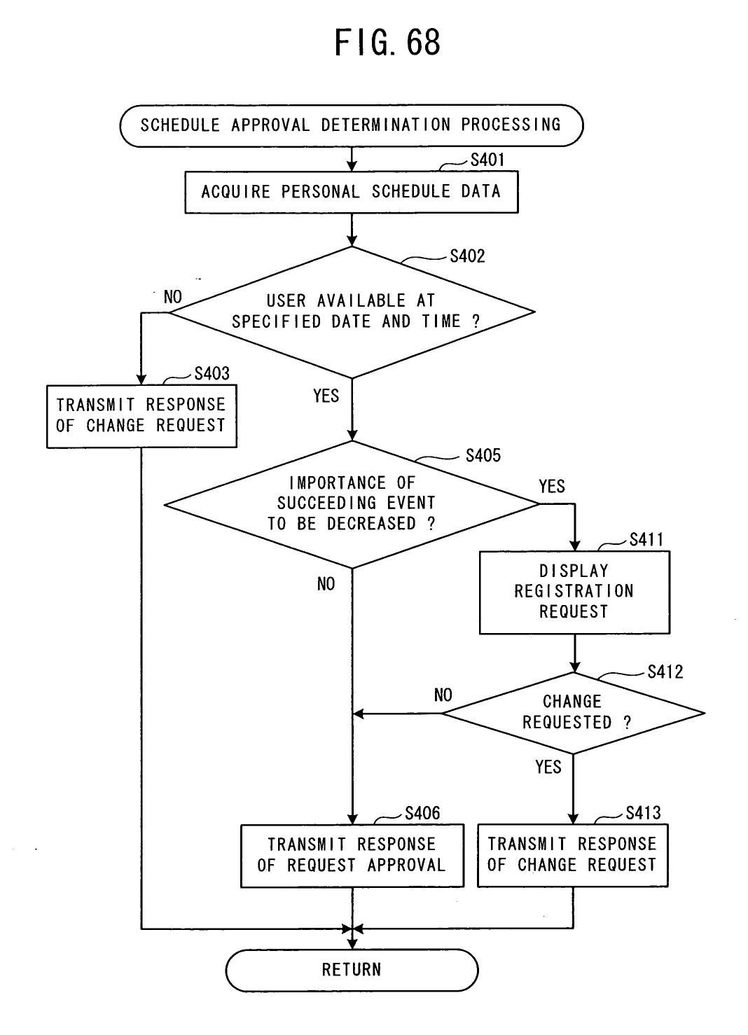

If, as shown in FIG. 53, a registration request for a new schedule has been received from one of the other user terminals 21 (Yes at S223), the CPU 2111 performs schedule approval determination processing to determine whether to approve a received schedule (S224, See FIG. 68). The schedule approval determination processing (S224) will be described in detail later. After the schedule approval determination processing (S224) is finished, the CPU 2111 registers the received schedule into the personal schedule database 2122 in the hard disk drive 212, regardless of whether the received schedule has been approved (S225). Subsequently, the CPU 2111 returns again to the determination processing as to whether a registration of a new schedule has been instructed (S201 in FIG. 52).

If no registration request for a new schedule has been received (No at S223 in FIG. 53) and a schedule change notification concerning a previously received schedule has been received from one of the other user terminals 21 (Yes at S226), a content of the change notification is displayed on the display 214 to notify the user 201 of the change (S227). Subsequently, the CPU 2111 deletes the schedule registered in the personal schedule database 2122 in the hard disk drive 212 (S228). Then, the CPU 2111 returns again to the determination processing as to whether a registration of a new schedule has been instructed (S201 in FIG. 52).

If no schedule change notification has been received (No at S226 in FIG. 53) and a schedule determination notification concerning a previously received schedule has been received from one of the other user terminals 21 (Yes at S229), a content of the determination notification is displayed on the display 214 to notify the user 201 of the determination (S230). Then, the CPU 2111 returns again to the determination processing whether a registration of a new schedule has been instructed (S201 in FIG. 52).

Further, if no schedule determination notification has been received (No at S229 in FIG. 53) and a termination of the program is not instructed (No at S231), other processing is performed (S232). In the other processing step (S232), for example, processing to search the personal schedule database 2122 for a schedule of the user 201 of a fixed day and to print the schedule by a printer (not shown) provided to the user terminal 21. Another example may be processing to access the conference room schedule database 1123 in the hard disk drive 112 of the server 110 to cause the display 214 of the user terminal 21 to display the reservation status of a specific conference room is performed. A detailed description of other processing is omitted here.

After the other processing (S232), the CPU 2111 returns again to the determination processing as to whether a registration of a new schedule has been instructed (S201 in FIG. 52). If “End” processing is selected from the program menu to instruct the end of the program (Yes at S231), the CPU 2111 terminates the scheduling program 2121.

Next, the schedule determination processing (S204) performed in the main processing shown in FIG. 52 will be described in detail with reference to FIGS. 54 to 67. First, outline of the schedule determination processing will be described with reference to a flowchart in FIG. 54.

As shown in FIG. 54, following the start of the schedule determination processing, the CPU 2111 set the error flag OFF in an error flag storage area (not shown) of the RAM 2113 (S241). Then, the CPU 2111 acquires schedule data of the user 201 from the personal schedule database 2122 in the hard disk drive 212 and stores the schedule data into the RAM 2113 temporarily (S242). Next, the CPU 2111 determines whether the user 201 has specified a date and time in the date and time fields 512 of the new schedule input screen 51 shown in FIG. 51, that is, whether there is input data of a specific date and time (S243). If there is input data of a specific date and time (Yes at S243), the CPU 2111 determines whether the user 201 is available at the specified date and time based on the schedule data of the user 201 acquired from the personal schedule database 2122 (S244). At this point, the duration inputted in the duration field 513 of the new schedule input screen 51 may also be considered. If another event is registered at the specified date and time (No at S244), a new event cannot be registered at the specified date and time. In such a case, the CPU 2111 set the error flag ON (S245), and displays a message indicating that another event is already planned for the user 201 on the display 214 (S246). Then, the CPU 2111 returns to the main processing of the scheduling program 2121 shown in FIG. 52.

If it is determined from the schedule data of the user 201 that the user 201 is available at the specified date and time (Yes at S244), the CPU 2111 determines whether the user 201 has specified a specific conference room in the location field 514 of the new schedule input screen 51 shown in FIG. 51, that is, whether there is input data of a specific location (S247). If there is no input data of a specific location (No at S247), the CPU 2111 proceeds to first determination processing (S255), which will be described later.

If there is input data of a specific conference room, for example, (Yes at S247), the CPU 2111 accesses the conference room schedule database 1123 stored in the hard disk drive 112 of the server 110 via the network. Then, the CPU 2111 acquires data of the specified conference room of the time zone obtained by adding the duration to the specified date and time (S248) to determine availability of the conference room (S249). If the specified conference room (specified location) is not available (No at S249), the new event cannot be registered for the specified conference room. Therefore, the CPU 2111 sets the error flag ON (S250), and displays a message indicating that the specified conference room is not available at the specified date and time on the display 214 (S251). Then, the CPU 2111 returns to the main processing of the scheduling program 2121 shown in FIG. 52.

If it is determined from the data acquired from the conference room schedule database 1123 that the specified conference room is available (Yes at S249), the event can be held at the date and time and at the location (conference room) specified by the user 201. Thus, the schedule may be fixed and the CPU 2111 causes the display 214 to display the determined schedule to obtain confirmation of the user 201 (S252). Then, if an approval of the user 201 is obtained (Yes at S253), the CPU 2111 returns to the main processing of the scheduling program 2121 shown in FIG. 52. If an approval of the user 201 is not obtained (No at S253), the CPU 2111 sets the error flag ON (S254), and returns to the main processing.

If it is determined that no specific date and time is specified in the schedule determination shown in FIG. 54 (No at S243), the CPU 2111 next determines whether any location is specified (S257). If there is input data of a specific location (Yes at S257), second determination processing described later is performed (S258). If there is no input data of a specific location (No at S257), third determination processing described later is performed (S259).

After the first determination processing (S255), the second determination processing (S258) or the third determination processing (S259), the CPU 2111 checks whether an error has occurred in the processing based on an ON or OFF state of the error flag (S256). If an error has occurred (Yes at S256), the CPU 2111 returns to the main processing of the scheduling program 2121 shown in FIG. 52. If an error has not occurred (No at S256), the CPU 2111 causes the display 214 to display the determined schedule (S252), and returns to the main processing after the user 201 gives an approval or gives an instruction of non-approval (S253).

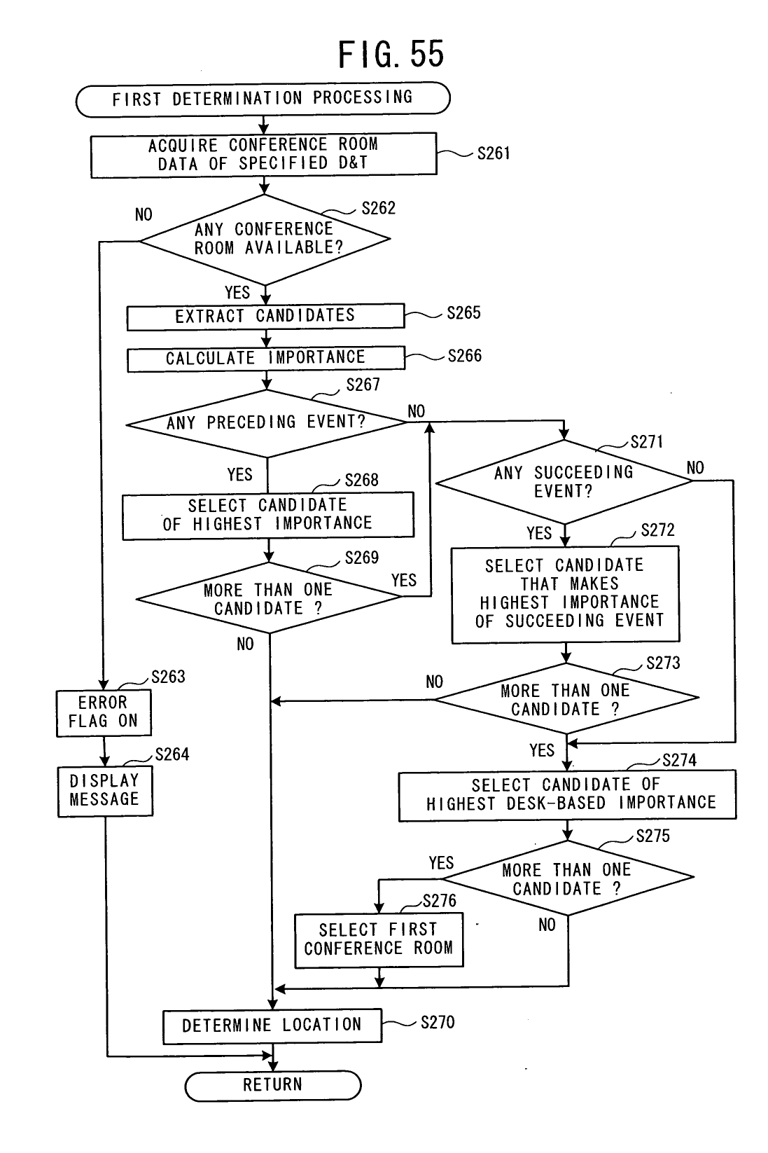

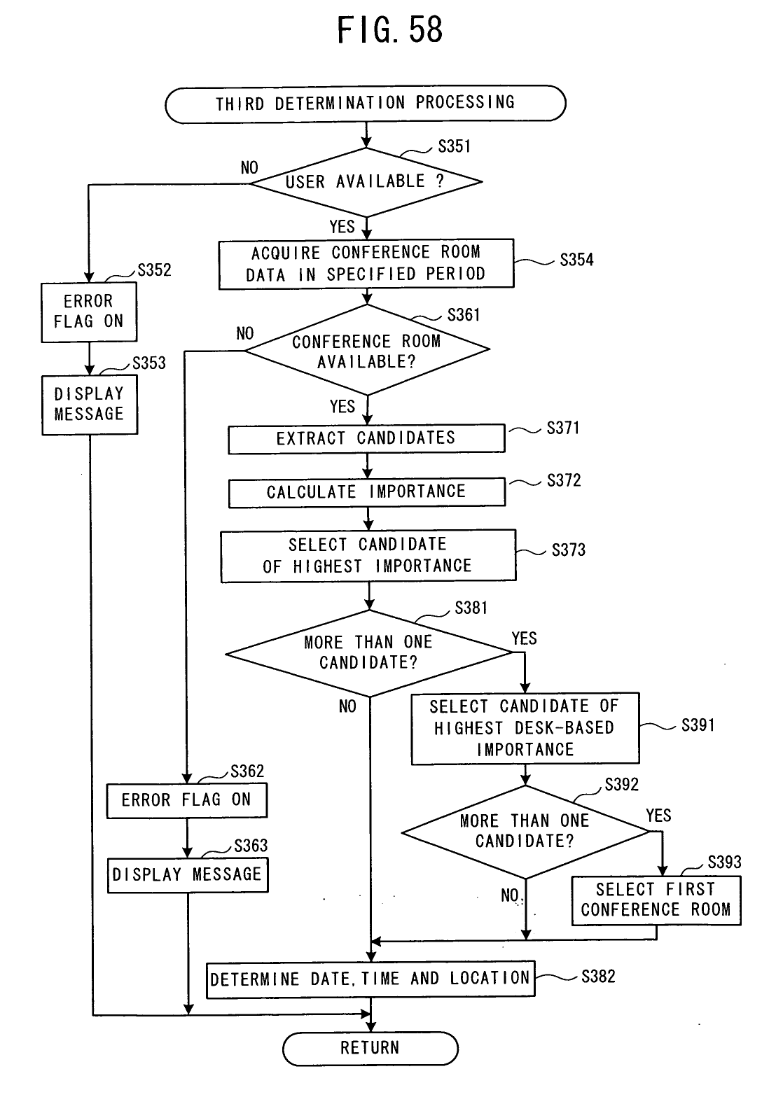

Next, a subroutine of the first determination processing (S255) performed in the schedule determination processing shown in FIG. 54 will be described using examples with reference to a flowchart in FIG. 55, and FIGS. 58, 59, and 61. In the following description with the examples, it is assumed that data has been inputted via the new schedule input screen 51 as shown in FIG. 51. It is also assumed that Head Office and Factory 1 are on the same site in Nagoya, Factory 2 is on a site adjacent to the site of Head Office and Factory 1 in Nagoya, and a desk of the user 201, which is the usual location (whereabouts) of the user 201, is located on 2F of Factory 1. Further, it is assumed that the conference room data is stored in the conference room schedule database 1123 in the order from the left side in the conference room reservation status display screen 61 shown in FIG. 59.

The first determination processing described below is performed when it is determined that the date and time is specified (Yes at S243) but the location is not specified (No at S247) in the schedule determination processing shown in FIG. 54. Thus, as shown in FIG. 55, the CPU 2111 first accesses the conference room schedule database 1123 stored in the hard disk drive 112 of the server 110 via the network to acquire all conference room data in a time zone obtained by adding the duration to the specified date and time (S261). If the CPU 2111 determines that no conference room is available from the acquired conference room data (No at S262), the new event cannot be registered for the specified date and time. Thus, the CPU 2111 sets the error flag ON (S263). Subsequently, the CPU 2111 causes the display 241 to display a message indicating that there is no available conference room at the specified date and time (S264), and returns to the schedule determination processing shown in FIG. 54.

The CPU 2111 determines whether a conference room is available at the specified date and time or in the specified period based on the data acquired from the conference room schedule database 1123 (S262). If the CPU 2111 determines that a conference room is available (Yes at S262), the CPU 2111 extracts candidates at which the new event can be held, considering the schedule data of the user 201 (S265). A candidate includes a candidate date and time and a candidate location. In the input example shown in FIG. 51, the candidate date and time is “10:00-11:00 of Aug. 1, 2006”, which corresponds to a portion enclosed by a thick frame 611 in FIG. 59. As shown in FIG. 59, conference rooms available at the candidate date and time include “Conference Room 1 on 2F, Head Office”, “Conference Room 3 on 2F, Head Office”, “Conference Room 1 on 2F, Factory 1”, “Conference Room 2 on 3F, Factory 1”, and “Conference Room A on 3F, Factory 2” at five locations. These conference rooms may be employed as the candidate locations. Therefore, five candidates may be extracted by combining one candidate date and time and these five candidate locations.

Here, terms to be used in the following description in the third and fourth embodiment will be described. An event registered immediately before a candidate date and time is referred to as a “preceding event”. An event registered immediately after a candidate date and time is referred to as a “succeeding event”. A location where the desk of the user 201 is located is referred to as a “desk location”.

After extraction of the candidates (S265), the CPU 2111 calculates an importance of each candidate and an importance of a succeeding event based on a travel distance from a location where the user 201 is located immediately before each candidate or the succeeding event (S266). More specifically, if there is a preceding event in the schedule data of the user 201, the importance of the candidate is calculated based on a travel distance from the location of the preceding event to the candidate location of the candidate. If there is no preceding event, the importance of the candidate is calculated based on a travel distance from the desk location to the candidate location of the candidate. The importance of the succeeding event is calculated based on a travel distance from the candidate location of the candidate to the location of the succeeding event. Further, a desk-based importance is calculated for each candidate based on a travel distance from the desk location, which is the usual whereabouts of the user 201, to the candidate location of each candidate. Accordingly, up to three kinds of importance, the “importance of e candidate”, the “importance of a succeeding event (only if a succeeding event is registered)”, and the “desk-based importance of a candidate” are calculated, which are stored into the RAM 2113 (S266).

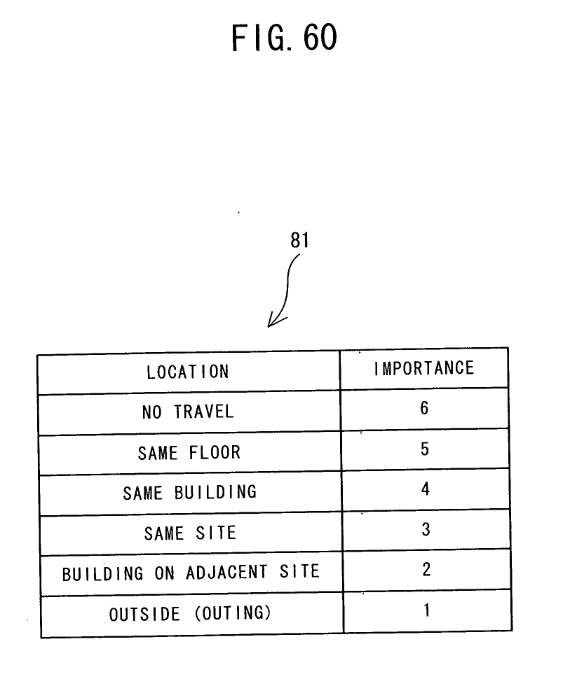

The “importance” in the present embodiment refers to a weighting value that increases as a travel distance between consecutive events is shorter, and decreases as the travel distance is longer. The importance may be calculated, for example, based on an importance calculation table 81 shown in FIG. 60. A calculation method of the importance will be described below with an example in which the schedule table 71 of the user 201 of Aug. 1, 2006 and a correspondence table 91 between the five candidates and the importance of each candidate shown in FIG. 62 are used. As shown in the schedule table 71, the schedule data of August 1 stored in the personal schedule database 2122 of the user 201 includes a preceding event immediately before “10:00-11:00 of August 1”, which is the candidate date and time common to the five candidates. Specifically, the preceding event is a conference 711 to be held in “Conference Room 1 on 2F, Head Office”.

Therefore, the importance of each candidate may be calculated as shown in the correspondence table 91 in FIG. 62, based on the importance calculation table 81 shown in FIG. 60. For example, the first candidate of the correspondence table 91 includes a candidate location “Conference Room 1 on 2F, Head Office”, which is the same location as the location of the conference 711 registered immediately before the candidate. Thus, no travel may be required between the events. Accordingly, the importance of the first candidate is calculated as “6” based on the importance calculation table 81 shown in FIG. 60. Similarly, the importance of a succeeding event and the desk-based importance are calculated. In the example shown in FIG. 62, the importance of a succeeding event is not calculated, because there is no event registered immediately after the candidate date and time “10:00-11:00 of August 1” of each candidate.

As shown in the flowchart in FIG. 55, after the importance is calculated as described above (S266), the CPU 2111 determines whether there is another plan, that is, a preceding event immediately before the candidate date and time common to all the candidates from the schedule data of the user 201 (S267). If the CPU 2111 determines that there is a preceding event (Yes at S267), among up to three kinds of the importance calculated at step S265, the CPU 2111 compares the importance of the candidates to select the candidate of the highest importance (S268). If there is only one candidate of the highest importance (No at S269), the CPU 2111 determines the candidate location of the candidate as the location of the event (S270), and returns to the schedule determination processing shown in FIG. 54.

Because the error flag is not ON in this example (No at S256 in FIG. 54), the CPU 2111 causes the display 214 to display the determined schedule (S252). In the example shown in FIG. 62, the conference 711 is registered immediately before the candidate date and time, and the importance of each candidate is calculated at step S266, as shown in the correspondence table 91. As shown in correspondence table 91, the importance of the first candidate is the highest with “6”. Therefore, in this example, “Date and time: 10:00-11:00 of Aug. 1, 2006, Location: Conference Room 1 on 2F, Head Office” is displayed as the determined schedule on the display 214 (S252).

If there is no preceding event common to all the candidates (No at S267), the CPU 2111 determines whether there is a succeeding event from the schedule data of the user 201 (S271). If there is a preceding event (Yes at S267) and it is determined that there is a plurality of candidates of the highest importance based on comparison of the importance of the candidates (Yes at S269), the CPU 2111 also determines whether there is a succeeding event from the schedule data of the user 201 (S271). If there is a succeeding event common to all the candidates (Yes at S271), the CPU 2111 compares the importance of the succeeding event immediately after the candidates of the highest importance selected at step S268, among various kinds of importance calculated as described above at step S266.

The candidate that makes the importance of the succeeding event the highest is selected (S272). If there is only one candidate that makes the highest importance of the succeeding event (No at S273), the CPU 2111 determines the candidate location of the candidate as the location of the event (S270), and returns to the schedule determination processing shown in FIG. 54. Because no error has occurred in this example (No at S256), the CPU 2111 causes the display 214 to display the determined schedule (S252).

Further, if there is no succeeding event common to all the candidates (No at S271), the CPU 2111 selects the candidate of the highest desk-based importance based on comparison of the desk-based importance of each candidate calculated at step S226 and stored in the RAM 2113 (S274). If there is a succeeding event (Yes at S271) and it is determined that there is a plurality of candidates that make the importance of the succeeding event the highest based on comparison of the importance of the candidates (Yes at S273), the CPU 2111 also selects the candidate of the highest desk-based importance.

If there is only one candidate of the highest desk-based importance (No at S275), the CPU 2111 determines the candidate location of the candidate as the location of the event (S270). If there is a plurality of candidates of the highest desk-based importance (Yes at S275), the CPU 2111 determines the conference room of the candidate location whose data is registered first in the conference room schedule database 1123 as the location of the event (S276). After the location is determined (S270), the CPU 2111 returns to the schedule determination processing shown in FIG. 54. Because no error has occurred (No at S256), the CPU 2111 causes the display 214 to display the determined schedule (S252).

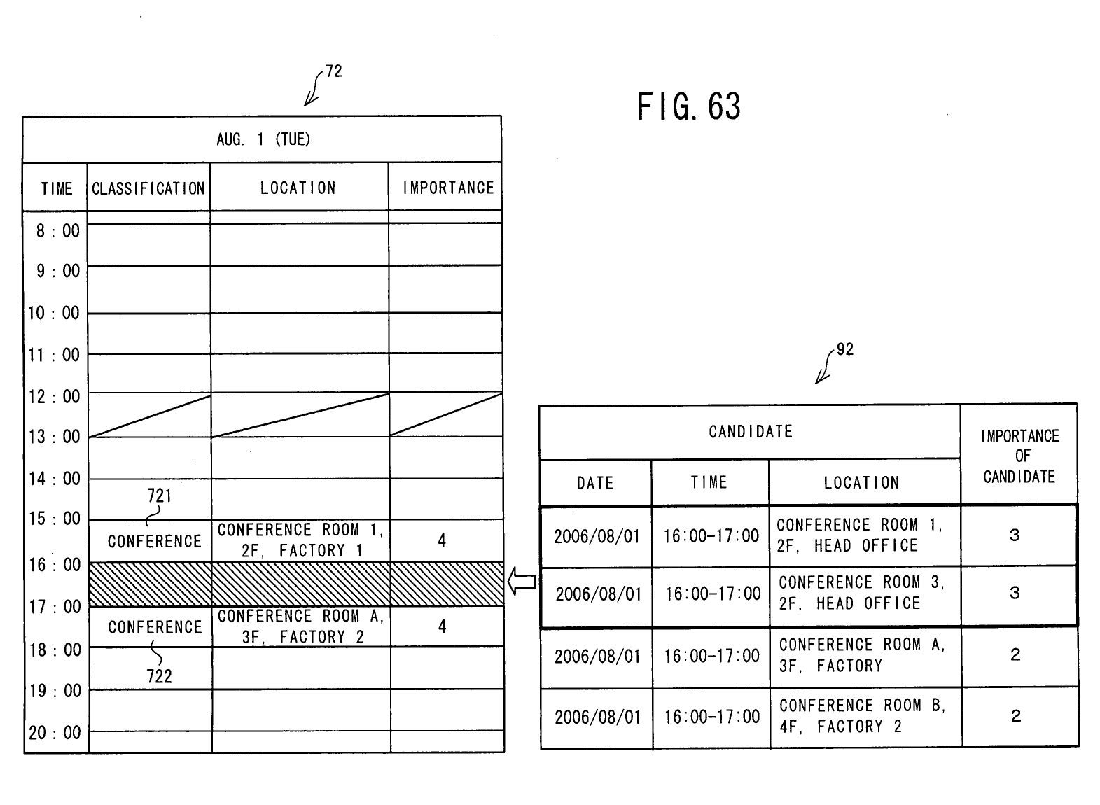

Here, the first determination processing will be described with another example with reference to the flowchart in FIG. 55, the importance calculation table 81 shown in FIG. 60, and explanatory diagrams in FIGS. 63 to 65. In this example, it is assumed that, as shown in a correspondence table 92 in FIG. 63, four candidates which have a common candidate date and time of “16:00-17:00 of Aug. 1, 2006” are extracted (FIG. 55, S265). As shown in a schedule table 72 in FIG. 63, a conference 721 to be held in “Conference Room 1 on 2F, Factory 1” is already registered in the personal schedule database 2122 of the user 201 immediately before the candidate date and time (Yes at 267 in FIG. 55).

Thus, a candidate of the highest importance is selected from these candidates (S268). The importance of each candidate in this example is as shown in the correspondence table 92 shown in FIG. 63. The importance of each candidate is calculated based on the travel distance from the location of the conference 721 of “Conference Room 1 on 2F, Factory 1”, using the importance calculation table 81 shown in FIG. 60. As shown in the correspondence table 92, there are two candidates showing the highest importance “3” (Yes at S269 in FIG. 55).

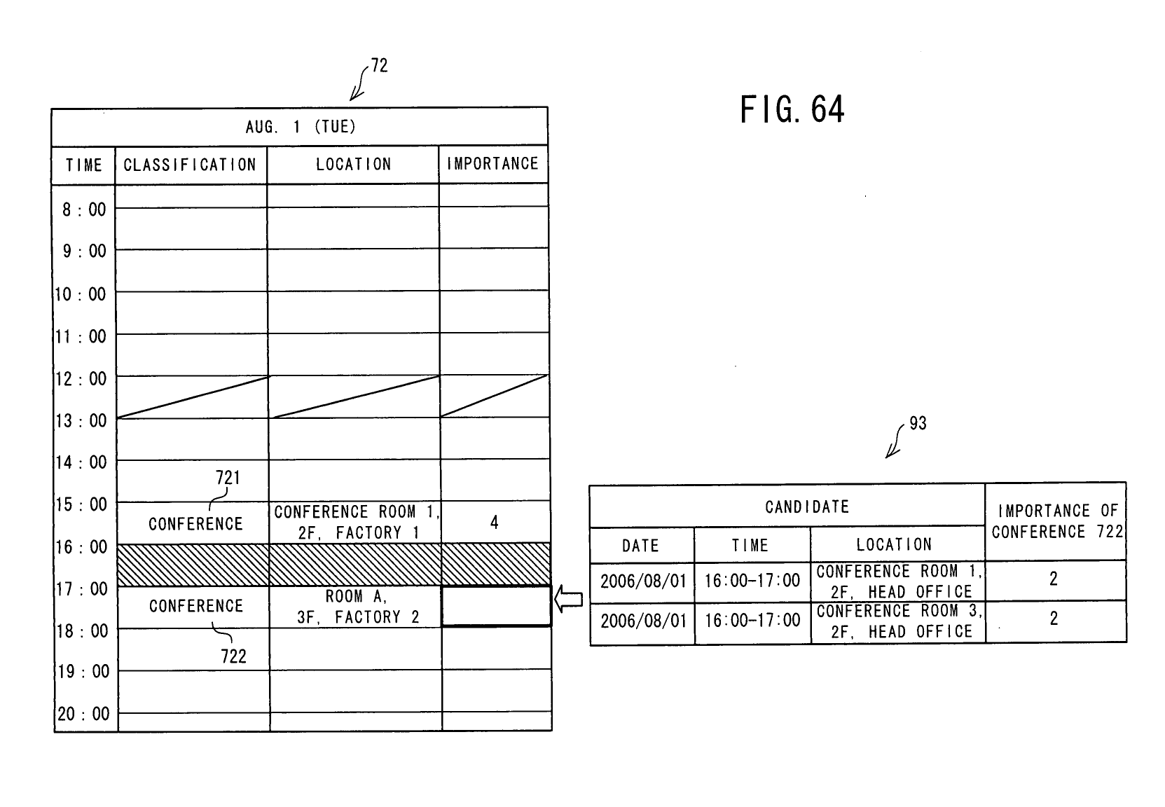

Thus, it is determined whether there is any succeeding event immediately after the candidate date and time of the candidates of the importance “3” (FIG. 55, S271). As shown in the schedule table 72, a conference 722 to be held in “Conference Room A on 3F, Factory 2” from 17:00 of Aug. 1, 2006 is already registered immediately after the candidates of the importance “3” in the personal schedule database 2122 of the user 201 (Yes at S271 in FIG. 55). Therefore, a candidate that makes the highest importance of the conference 722 to be held in “Conference Room A on 3F, Factory 2” will be selected from the two candidates showing the highest importance “3” (FIG. 55, S272). Here, the importance of the conference 722 is shown in a correspondence table 93 in FIG. 64. The importance of the conference 722 is calculated with the importance calculation table 81 shown in FIG. 60, based on the travel distance from the candidate location of each of the two candidates, that is, “Conference Room 1 on 2F, Head Office” and “Conference Room 3 on 2F in Head Office” (FIG. 55, S209).

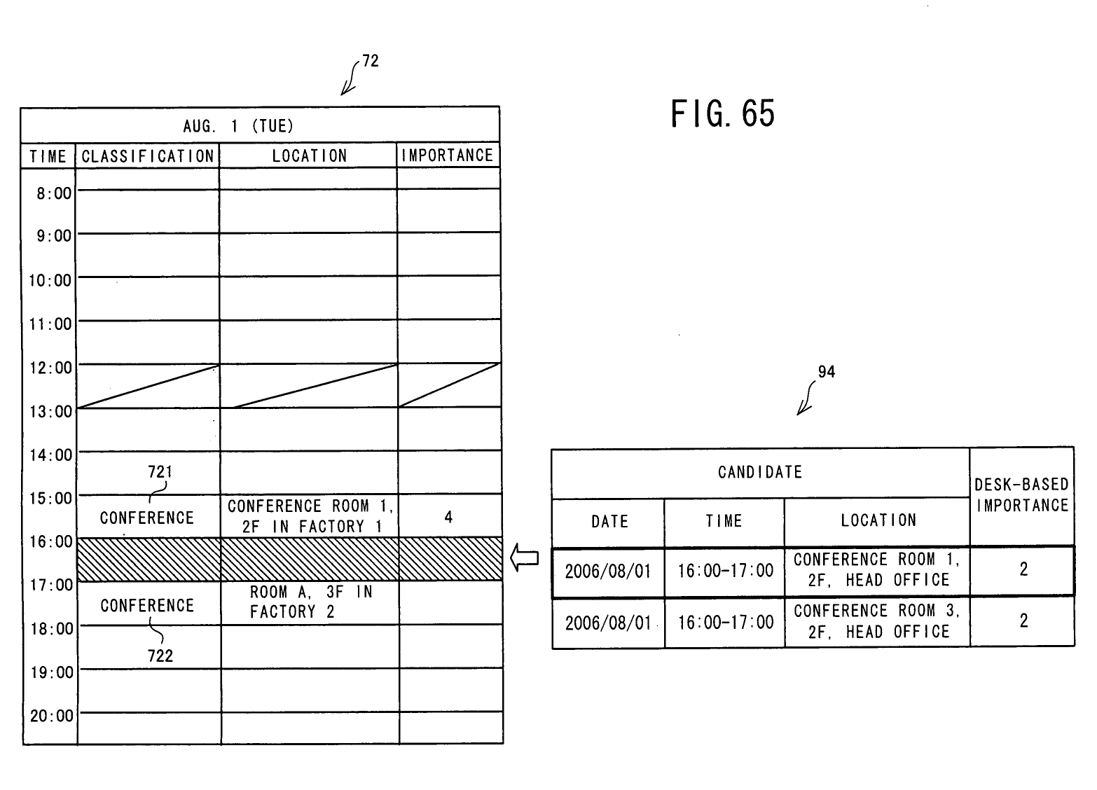

As shown in FIG. 64, there are still two candidates having the highest importance “2” (Yes at S273 in FIG. 55). Therefore, a selection will be made based on the desk-based importance of each candidate (FIG. 55, S274). As described above, because the desk of the user 201 is located on 2F in Factory 1, the desk-based importance of each candidate is as shown in a correspondence table 94 in FIG. 65. Again, the two candidates have the same desk-based importance “2” (Yes at S275 in FIG. 55). Thus, “Conference Room 1 on 2F, Head Office”, which is registered first in the conference room schedule database 1123, is selected (FIG. 55, S276) and the location is fixed (FIG. 55, S270).

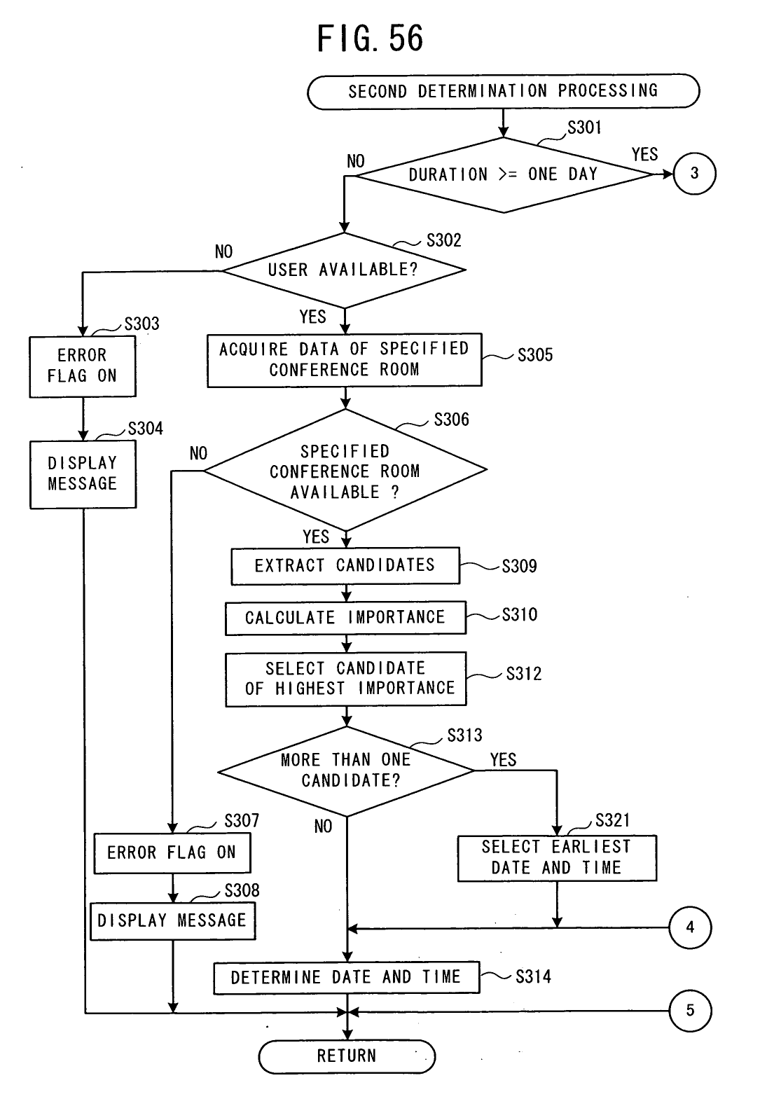

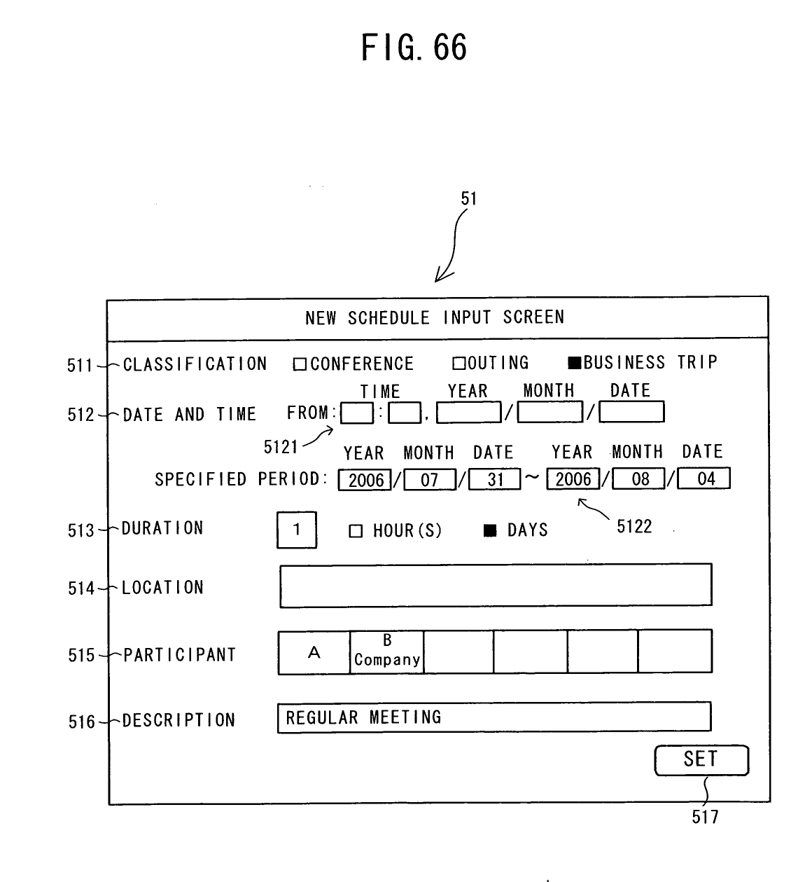

Next, a subroutine of the second determination processing (S258) performed in the schedule determination processing shown in FIG. 54 will be described using examples with reference to the flowcharts in FIGS. 56 and 57, and FIGS. 60, 61, 66 and 67. The second determination is performed in the schedule determination processing shown in FIG. 54 when the date and time is not specified (No at S243), but the location is specified (Yes at S257). In the following description with the examples, it is assumed that “Business trip” is selected from the classification field 511, as shown in the new schedule input screen 51 in FIG. 66. It is also assumed that in the date and time fields 512, instead of a specific date and time being specified, “Jul. 31, 2006 to Aug. 4, 2006” allowing latitude of one week is inputted in the specified period field 5122. Further, it is assumed that “1 (one) day” is inputted in the duration field 513 and “Yokohama” is inputted in the location field 514.

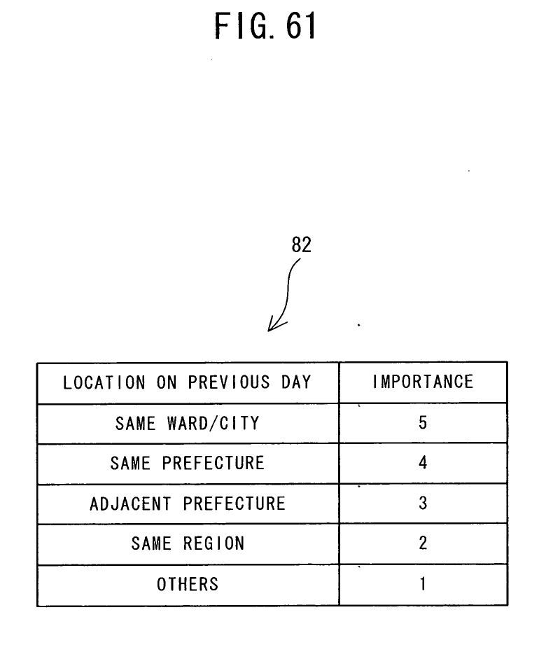

As shown in FIG. 56, in the second determination processing, the CPU 2111 first determines whether the duration is one day or more, or less than one day (S301). This determination is made first, because an importance calculation table to be used for calculating the importance is different depending on whether the duration is one day or more, or less than one day as described later (See FIGS. 60 and 61). If the duration is less than one day (No at S301), the CPU 2111 determines whether the user 201 is available in the specified period or in a predetermined period based on the schedule data of the user 201 acquired from the personal schedule database 2122 (S242, See FIG. 54) (S302).

The specified period refers to a period inputted in the specified period field 5122 of the new schedule input screen 51 shown in FIG. 66. The predetermined period refers to a period that is employed when there is no input in the date and time fields 512 at all. In such a case, the predetermined is obtained by, for example, picking up a certain period such as “one week from the input date”. At this point, the duration inputted in the duration field 513 of the new schedule input screen 51 is also considered. If there is no available duration over the specified period or the predetermined period (No at S302), the schedule cannot be registered under the input conditions. Thus, the CPU 2111 sets the error flag ON (S303), and causes the display 214 to display that the user 201 is not available (S304) before returning to the schedule determination processing shown in FIG. 54.

If it is determined that the user 201 is available in the specified period or in the predetermined period based on the schedule data of the user 201 (Yes at S302), the CPU 2111 accesses the conference room schedule database 1123 stored in the hard disk drive 112 of the server 110 via the network. Then, the CPU 2111 acquires the conference room data in the specified period or in the predetermined period of the conference room specified in the location field 514 of the new schedule input screen 51 (S305). If, considering the duration, the CPU 2111 determines that the specified conference room cannot be reserved for the duration in the specified period or in the predetermined period based on the acquired conference room data (No at S306), the schedule cannot be registered under the input conditions. Thus, the CPU 2111 sets the error flag ON (S307). Subsequently, the CPU 2111 causes the display 214 to display that the specified conference room is not available in the specified period or in the predetermined period (S308), and returns to the schedule determination processing shown in FIG. 54.

If the CPU 2111 determines that the specified conference room is available in the specified period or in the predetermined period based on the data acquired from the conference room schedule database 1123 (Yes at S306), the CPU 2111 extracts candidates, considering the schedule data of the user 201 (S309). The candidate includes a candidate date and time and a candidate location at which a new event can be held. After extracting the candidates (S309), the CPU 2111 calculates the importance of each candidate based on the travel distance from the location where the user 201 is located immediately before the candidate date and time. In calculating the importance, the importance calculation table 81 shown in FIG. 60 prepared for a short distance travel is used. The calculated importance is stored into the RAM 2113 (S310).

Next, the CPU 2111 compares the importance of each candidate to select the candidate of the highest importance among the candidates (S312). If there is only one candidate of the highest importance (No at S313), the CPU 2111 determines the candidate date and time of the candidate as the date and time for the event (S314), and returns to the schedule determination processing shown in FIG. 54. Because no error has occurred in this example (No at S256), the display 214 is caused to display the determined schedule (S256). If, comparing the importance of each candidate, it is determined that there is a plurality of candidates of the highest importance (Yes at S313), the CPU 2111 selects the earliest candidate date and time among the candidates (S321). The CPU 2111 determines the selected candidate date and time as the date and time for the event (S314). After the date and time is fixed (S314), the CPU 2111 returns to the schedule determination processing shown in FIG. 54. Because no error has occurred in this example (No at S256), the display 214 is caused to display the determined schedule (S111).

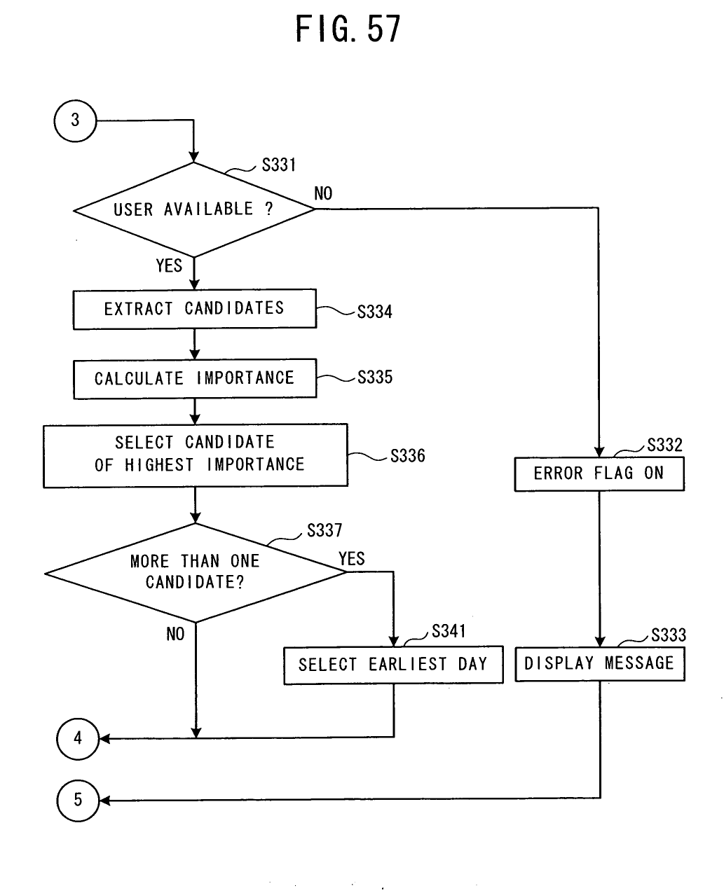

As shown in the subroutine of the second determination processing shown in FIGS. 56 and 57, if it is determined that the duration is one day or more (Yes at S301 in FIG. 56), the CPU 2111 determines whether the user 201 is available in the specified period or in the predetermined period based on the schedule data (S242 in FIG. 54) of the user 201 acquired from the personal schedule database 2122 (FIG. 57, S331). The specified period is, as described above, a period inputted in the specified period field 5122 of the new schedule input screen 51 shown in FIG. 51.

If there is no input in the date and time fields 512 at all, the predetermined period refers to a period obtained by, for example, picking up a certain period such as “one week from the input date”. If there is no available duration (one day or more) over the specified period or the predetermined period (No at S331), the schedule cannot be registered under the input conditions. Thus, the CPU 2111 sets the error flag ON (S332), causes the display 214 to display that the user 201 is not available (S333), and returns to the schedule determination processing shown in FIG. 54.

If it is determined that the user 201 is available for the duration in the specified period or in the predetermined period (Yes at S331), the CPU 2111 extracts candidates (S334). The CPU 2111 calculates the importance of each candidate based on the travel distance from the location where the user 201 is located the previous day, and stores the calculated importance into the RAM 2113 (S335). More specifically, if there are events registered for the previous day of the candidate in the schedule data of the user 201, the importance of the candidate is calculated for the candidate based on the travel distance from the location of the last event registered on the previous day to the candidate location of the candidate. If there is no event registered for the previous day, the importance of the candidate is calculated based on the travel distance from the desk location to the candidate location of the candidate.

As in the case in which the duration is less than one day, the importance here is also a weighting value that increases as a travel distance between consecutive events becomes shorter, and decreases as the travel distance becomes longer. More specifically, the importance of the candidate may be calculated, for example, using an importance calculation table 82 shown in FIG. 61 prepared for a long distance travel. When the duration is one day or more, as described above, the travel distance is mostly long, instead of a travel between buildings in a company or a travel to adjacent facilities. Thus, it may be desirable to use a table that is different from the table prepared for a case when the duration is less than one day. In the importance calculation table 82 shown in FIG. 61, for example, the importance may be classified into ranges like City, Prefecture, and Adjacent prefecture, that are wider than the ranges in the importance calculation table 81 (FIG. 60) prepared for a case when the duration is less than one day assuming a short distance travel.

In the first determination processing (FIG. 55) described above and third determination processing (FIG. 58) described later, it is assumed that the location may be selected only from the conference room data stored in the conference room schedule database 1123. Therefore, the importance calculation table in FIG. 60 prepared for a short distance travel may be used exclusively for the calculation of importance even if the duration is one day or more.

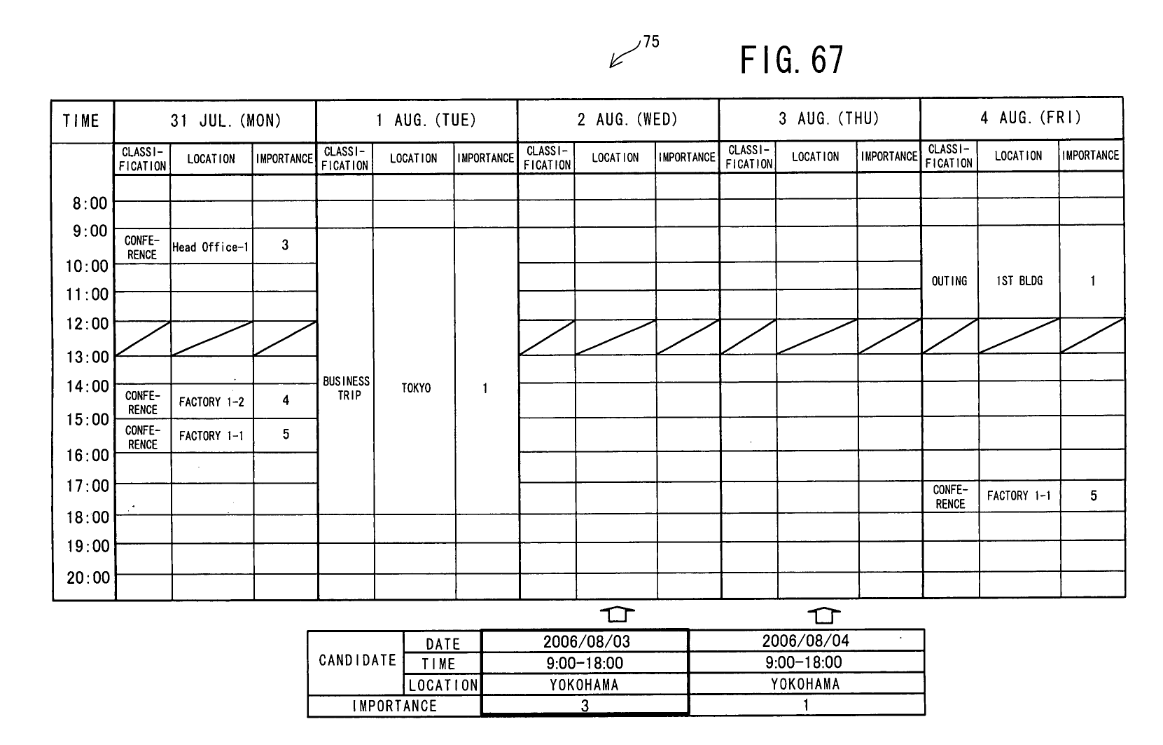

It is assumed that the schedule data of the user 201 during “Jul. 31, 2006 to Aug. 4, 2006”, which is a period inputted in the specified period field 5122 of the new schedule input screen 51 shown in FIG. 66, is as shown in a schedule table 75 in FIG. 67. In this example, there are two candidate dates and times that can ensure the duration of “one day”. Specifically, “Aug. 2, 2006” and “Aug. 3, 2006” are extracted as the candidate dates and times. The importance is calculated for these candidates using the importance calculation table 82 shown in FIG. 61 (S335 in FIG. 57). According to the schedule data of the user 201, the importance of “Aug. 2, 2006” is calculated as “3”, because the user 201 is in Tokyo, which is an adjacent prefecture of Yokohama (Kanagawa), on the previous day of August 1. Similarly, the importance for “Aug. 3, 2006” is calculated as “1”, because there is no registered event for the previous day, August 2, and thus, the importance is calculated based on a travel from the desk (Nagoya) of the user 201.

In the flowchart shown in FIG. 57, after the importance is calculated as described above (S335), the CPU 2111 compares the importance of each candidate to select the candidate of the highest importance among the candidates (S336). Then, if there is only one candidate of the highest importance (No at S337), the CPU 2111 determines the candidate date and time of the candidate as the date and time for the event (FIG. 56, S314), and returns to the schedule determination processing shown in FIG. 54. Because no error has occurred in this example (No at S256), the CPU 2111 causes the display 214 to display the determined schedule (S252).

In the above example, because the importance of “Aug. 2, 2006” is the highest, the schedule “Date and time: Aug. 2, 2006, Location: Yokohama” is fixed and displayed on the display (FIG. 54, S111). On the other hand, if there is a plurality of candidates of the highest importance (Yes at S337), the CPU 2111 selects the earliest date and time among the candidate dates and times (S341), and determines them as the date and time for the event (FIG. 56, S314). Subsequently, the CPU 2111 returns to the schedule determination processing shown in FIG. 54, and the determined schedule is displayed on the display 214 (S111).

In the above-described first determination processing (FIG. 55), the candidate is selected considering one of the “importance of a candidate”, the “importance of a succeeding event of each candidate”, and the “desk-based importance of a candidate” calculated at step S265, depending on whether there is a preceding event and a succeeding event. In the second determination processing, on the other hand, only the “importance of a candidate” is considered. In the first determination processing, only one date and time is specified and all the candidates have a common candidate date and time. Thus, the preceding event and the succeeding event are also common to all the candidates.

In the second determination processing, however, the candidate date and time of each candidate is diverse. Moreover, some candidates have a preceding event and a succeeding event, while others have no such event. Therefore, uniform comparison may be improper. In the present embodiment, if there is a plurality of candidates of the highest importance, the earliest (nearest) candidate date and time among the candidate dates and times may be selected. The candidates having a succeeding event (or an event registered on the next day) may first be selected. Then, the candidate that makes the highest importance of the succeeding event (or the event registered on the next day) may be selected.

Next, a subroutine of the third determination processing (S259) performed in the schedule determination processing shown in FIG. 54 will be described with reference to the flowchart in FIG. 58. This processing is performed in the schedule determination processing shown in FIG. 54 when neither a specific date and time nor a specific location is specified (No at S243 and No at S257). In the present embodiment, a case when “no specific date and time is specified” also refers to a case when there is an input only in the specified period field 5122 but there is no input in the specified date and time field 5121 in the date and time fields 512 of the new schedule input screen 51 shown in FIG. 51.

As shown in FIG. 58, after the third determination processing is started, the CPU 2111 determines whether the user 201 is available in the specified period or in a predetermined period considering the duration, based on the schedule data (S242, See FIG. 54) of the user 201 acquired from the personal schedule database 2122 (S351). As described above, the specified period is a period inputted in the specified period field 5122 of the new schedule input screen 51 shown in FIG. 51. If there is no input at all in the date and time fields 512, the specified period is a period obtained by, for example, picking up a certain period such as one week from the input day. If there is no available duration over the specified period or the predetermined period (No at S351), the schedule cannot be registered under the input conditions. Thus, the CPU 2111 sets the error flag ON (S352), causes the display 214 to display that the user 201 is not available (S353), and returns to the schedule determination processing shown in FIG. 54.

If the CPU 2111 determines that the user 201 is available in the specified period or in the predetermined period based on the schedule data of the user 201 (Yes at S351), the CPU 2111 accesses the conference room schedule database 1123 stored in the hard disk drive 112 of the server 110 via the network. Then, the CPU 2111 acquires the conference room data in the specified period or in the predetermined period (S354). If the CPU 2111 determines that no conference room is available for the duration in the specified period or in the predetermined period based on the acquired conference room data considering the duration (No at S361), the schedule cannot be registered under the input conditions. Thus, the CPU 2111 sets the error flag ON (S362), causes the display 214 to display that no conference room is available in the specified period or in the predetermined period (S363), and returns to the schedule determination processing shown in FIG. 54.

If the CPU 2111 determines that the conference rooms are available in the specified period or in the predetermined period based on the data acquired from the conference room schedule database 1123 (Yes at S361), the CPU 2111 extracts candidates, considering the schedule data of the user 201 (S371). The candidate includes a candidate date and time and a candidate locations at which a new event can be held. Next, the CPU 2111 calculates the importance of each candidate and also the desk-based importance of each candidate, using the importance calculation table 81 shown in FIG. 60 (S372). The calculated importance is stored into the RAM 2113. Then, the CPU 2111 compares the importance of each candidate to select the candidate of the highest importance among the candidates (S373). If there is only one candidate of the highest importance (No at S381), the CPU 2111 determines the candidate as the date and time and the location of the event (S382), and returns to the schedule determination processing shown in FIG. 54. Because no error has occurred in this example (No at S256), the CPU 2111 causes the display 214 to display the determined schedule (S252).

If, as a result of comparison of the importance of each candidate, the CPU 2111 determines that there is a plurality of candidates of the highest importance (Yes at S381), the CPU 2111 compares the desk-based importance of these candidates calculated at step S372 and stored in the RAM 2113 (S391). If there is only one candidate of the highest desk-based importance (No at S392), the candidate is determined as the date and time and the location of the event (S382). If there is a plurality of candidates of the highest desk-based importance (Yes at S392), the CPU 2111 selects the candidate including the conference room whose data is registered first in the conference room schedule database 1123 (S393). After the date and time and the location are fixed in this manner (S382), the CPU 2111 returns to the schedule determination processing shown in FIG. 54. Because no error has occurred in this example (No at S256), the CPU 2111 causes the display 214 to display the determined schedule (S111).

Next, schedule approval determination processing (S224) will be described with reference to FIGS. 63, 64, and 68. The schedule approval determination processing is performed when a schedule is received in a registration request for a new schedule (Yes at S223) from one of the other user terminals 21 in the main processing of the scheduling program 2121 shown in FIG. 53.

As shown in FIG. 68, after the schedule approval determination processing is started, the CPU 2111 acquires the schedule data of the user 201 from the personal schedule database 2122 in the hard disk drive 212 and temporarily stores the schedule data into the RAM 2113 (S401). Next, the CPU 2111 determines whether the schedule of the user 201 is unoccupied at the date and time specified by the received schedule based one the schedule data of the user 201 (S402). If another event is already registered at the date and time or the duration cannot be ensured in the schedule (No at S402), the CPU 2111 transmits a response requesting a change in the time to the user terminal 21, that is, an originator user terminal 21 of the registration request (S403). The response indicates, for example, that a change in the time is requested, because the specified date and time is occupied. In addition, available dates and times at which a predetermined duration can be ensured in a predetermined period (for example, one week) are contained in the response. After transmitting the response of the change request (S403), the CPU 2111 returns to the main processing (FIG. 53) of the scheduling program 2121.

If the schedule of the user 201 is unoccupied at the specified date and time of the received schedule (Yes at S402), the CPU 2111 determines whether the importance of a succeeding event will be decreased, if the received schedule is inserted at the date and time (S405). For example, as shown in the schedule table 72 in FIG. 63, the conference 722 held in Conference Room A on 3F in Factory 2 from 17:00 to 18:00 is already registered. At this point, there is no registered event from 16:00 to 17:00 immediately before the conference 722.

In this case, the importance of the conference 722 is calculated as “4”, based on a travel distance from the desk location (2F in Factory 1) of the user 201. Then, a registration request for a new schedule of “Date and time: 16:00-17:00 of Aug. 1, 2006, Location: Conference Room 1 on 2F, Head Office”, as set by the first candidate in the correspondence table 92, may be received (Yes at S223 in FIG. 53). In such a case, as shown by the first candidate in the correspondence table 93 in FIG. 64, the importance of the conference 722 may be decreased to “2”.

If the importance of a succeeding event is decreased by a newly received schedule being inserted (Yes at S405), like the conference 722 shown in FIGS. 63 and 64, the CPU 2111 displays a content of the registration request and the current importance and the decreased importance of the succeeding event on the display 214 (S411). Subsequently, if the user 201 checks the displayed content and clicks a “Request change” button displayed on the display 214 to instruct a change request of the received new schedule (Yes at S412), the CPU 2111 transmits a response of a change request to the originator of the registration request, the user terminal 21 (S413). The change request indicates, for example, “A conference 722 (importance: 4) is registered for Conference Room A on 3F in Factory 2 from 17:00. A change in the location is requested not to decrease the importance of the conference 722”.

If the importance of the succeeding event is not decreased even if the received schedule is registered, including a case where there is no succeeding event (No at S405), the CPU 2111 transmits a response indicating an approval of the registration request to the originator, the user terminal 210 (S406). The CPU 2111 then returns to the main processing of the scheduling program 2121 shown in FIG. 53. The user 201 may think that the importance of the conference 722 is “4” and a decrease in the importance may be unavoidable. In such a case, the user 201 may click a “No change” button displayed in the display 214 (No at S412). In such a case, the CPU 2111 transmits a response indicating an approval to the user terminal 210 (S406), and returns to the main processing of the scheduling program 2121 shown in FIG. 53.

According to the scheduling system 1 in the present embodiment, as described above, the scheduling program 2121 is started and data of a new event such as a conference is inputted by the user 201. Then, a schedule is determined by selecting a date and time and a location that make a travel distance between the location of the new event and one of the preceding location, the succeeding location, and the usual whereabouts of the user 201 the shortest. Therefore, a travel-efficient schedule, which may not require a useless travel such as travels between the same places or a detour, may be determined for the user 201 automatically.

When the user terminal 210 receives a registration request for a schedule of a new event in which the user 201 is included as a participant from one of the other user terminals 21, it is similarly determined whether to approve the registration considering the travel distance between the new event and a succeeding event. Specifically, if the travel efficiency is decreased, a change of the location to another location making the travel distance as short as possible may be requested to the originator.

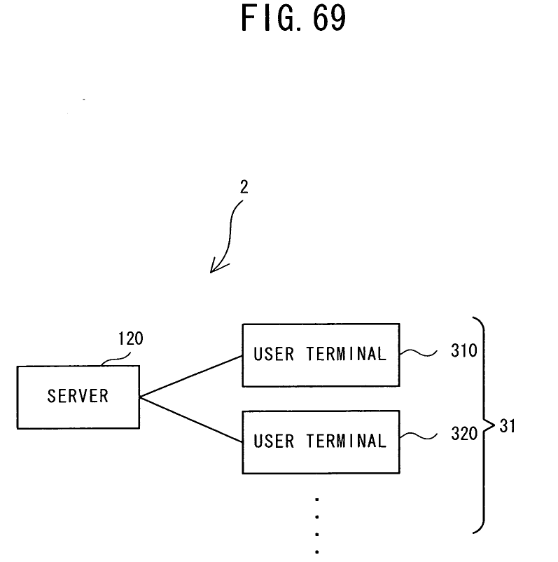

Next, a scheduling system 2 according to the fourth exemplary embodiment will be described with reference to FIGS. 69 to 79. In contrast to the scheduling system 1 according to the third embodiment, of the server 120 and user terminals 31 connected via a network in the scheduling system 2, the server 120 has a main scheduling function.

First, an outline configuration of the scheduling system 2 according to the fourth embodiment will be described with reference to FIGS. 69 to 71. As shown in FIG. 69, the scheduling system 2 includes the server 120 and a plurality of the user terminals 31 including user terminals 310, 320, and the like connected to the sever 120 via the network. In the scheduling system 2, when a user 300 of the user terminal 31 transmits necessary data to the server 120 from the user terminal 31 via the network, processing of arranging a schedule described later is performed in the server 120.

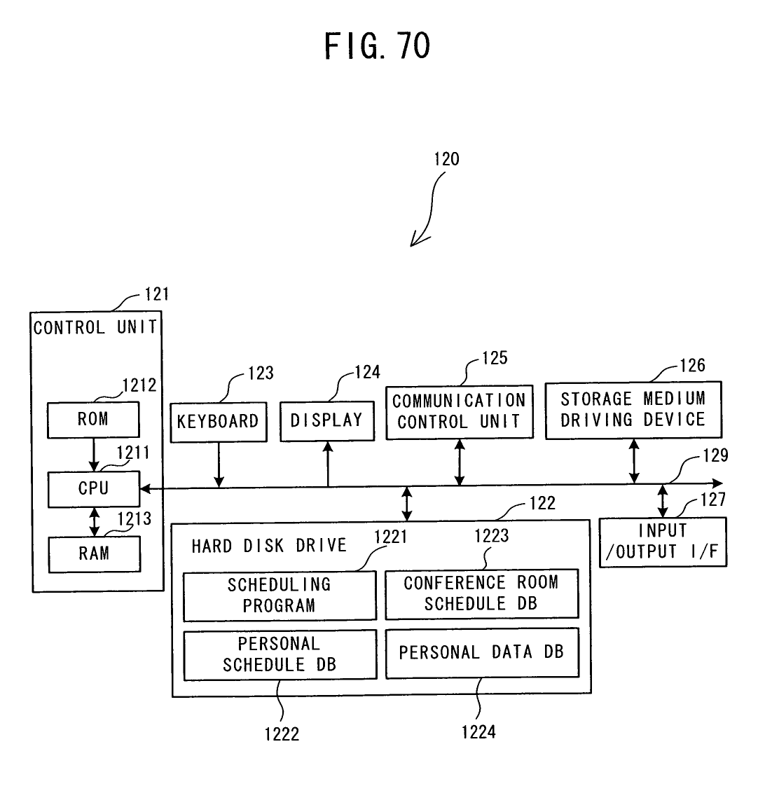

Next, an electrical configuration of the server 120 will be described with reference to a block diagram of FIG. 70. As shown in FIG. 70, the server 120 is provided, like the server 110 in the third embodiment, with a control unit 121 including a CPU 1211, a ROM 1212, and a RAM 1213. The ROM 1212 and the RAM 1213 are each connected to the CPU 1211. The CPU 1211 is further connected via a data bus 129 to a hard disk drive 122 described later, a keyboard 123, a display 124, a communication control unit 125, a storage media driving device 126, and an input and output interface (I/F) 127.

As shown in FIG. 70, the hard disk drive 122 of the server 120 has a plurality of storage areas. A scheduling program 1221, a personal schedule database 1222, a conference room schedule database 1223, and a personal data database 1224 are each stored in four of the storage areas. The scheduling program 1221 performs processing of arranging a schedule after receiving input from the user terminal 31. The personal schedule database 1222 includes schedule data of all the users 300 of the user terminals 31 for each user. The conference room schedule database 1223 includes conference room data including locations of conference rooms managed by the server 120, dates and times, and reservations corresponding to the locations and the dates and times. The personal data database 1224 has personal information such as the identification code, name, section, managing post, telephone number, and e-mail address of all the users 300 of the user terminals 31.

Further, though not shown, various programs to be executed by the CPU 1211 may be stored in other storage areas. The scheduling program 1221 will be described in detail later. The personal schedule database 1222 may be obtained by integrating a database similar to the personal schedule database 2122 stored in the hard disk drive 212 of the user terminal 21 in the third embodiment for each of all the users 300 of the user terminals 31. The conference room schedule database 1223 and the personal data database 1224 may be the same as the conference room schedule database 1123 and the personal data database 1124 in the third embodiment, respectively.

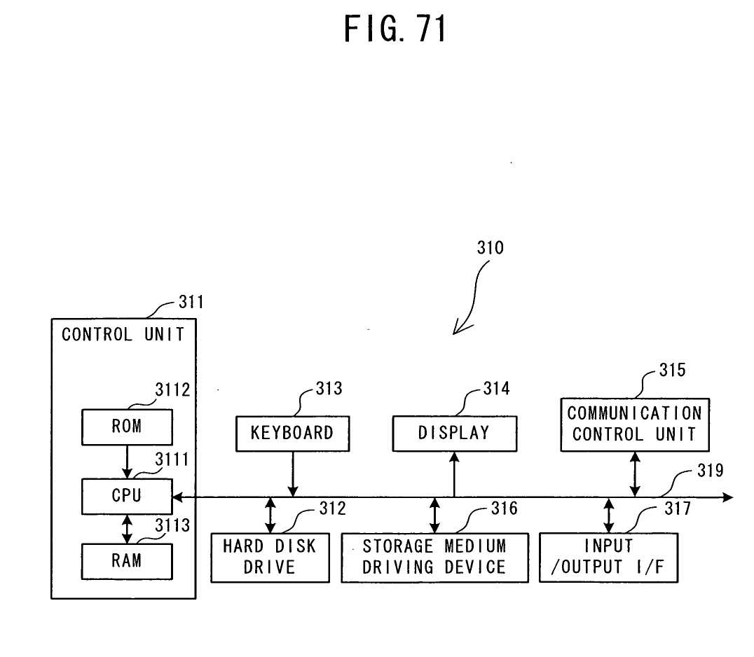

Next, an electrical configuration of the user terminal 310, which is one of the plurality of user terminals 31, will be described with reference to a block diagram in FIG. 71. Each of the user terminals 31 has the same configuration as that of the user terminal 310 described below. As shown in FIG. 71, like the user terminal 210 in the third embodiment, the user terminal 310 is provided with a control unit 311 including a CPU 3111, a ROM 3112, and a RAM 3113. The ROM 3112 and the RAM 3113 are each connected to the CPU 3111. The CPU 3111 is further connected via a data bus 319 to a hard disk drive 312, a keyboard 313, a display 314, a communication control unit 315 to control communication with the server 120, a storage media driving device 316, and an input and output interface (I/F) 317 mediating exchange of data. The hard disk drive 312 has storage areas (not shown) for storing various programs to be executed by the CPU 3111.

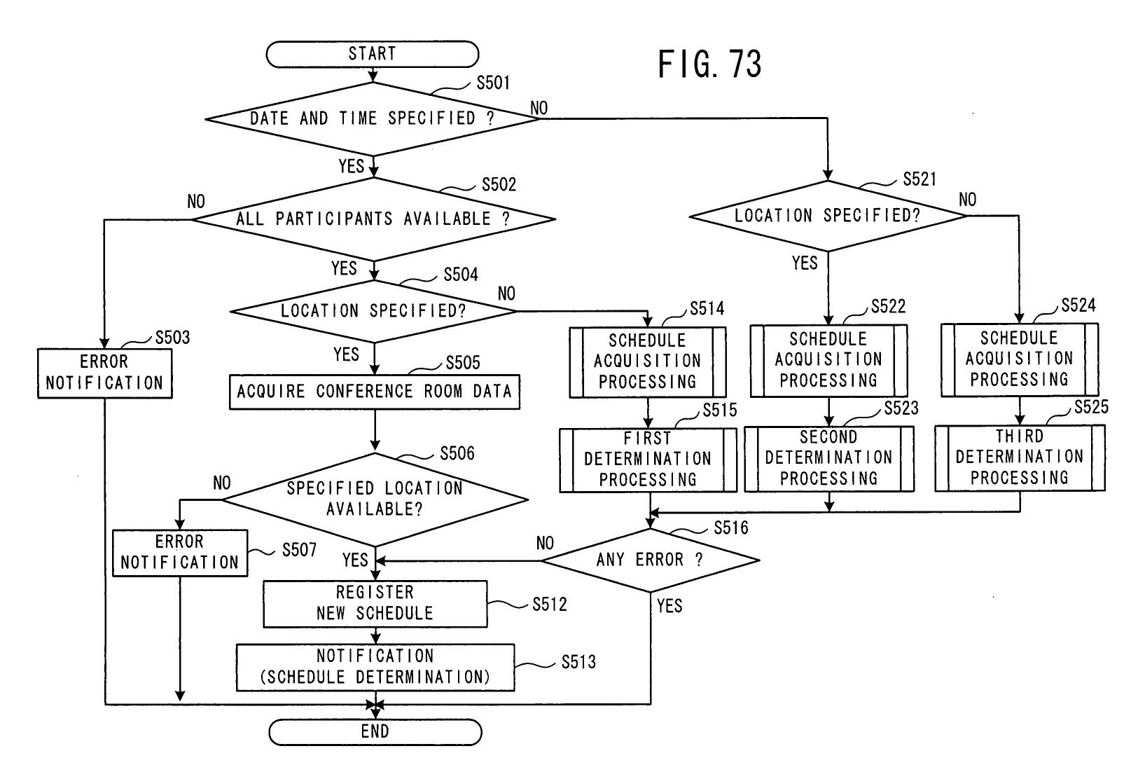

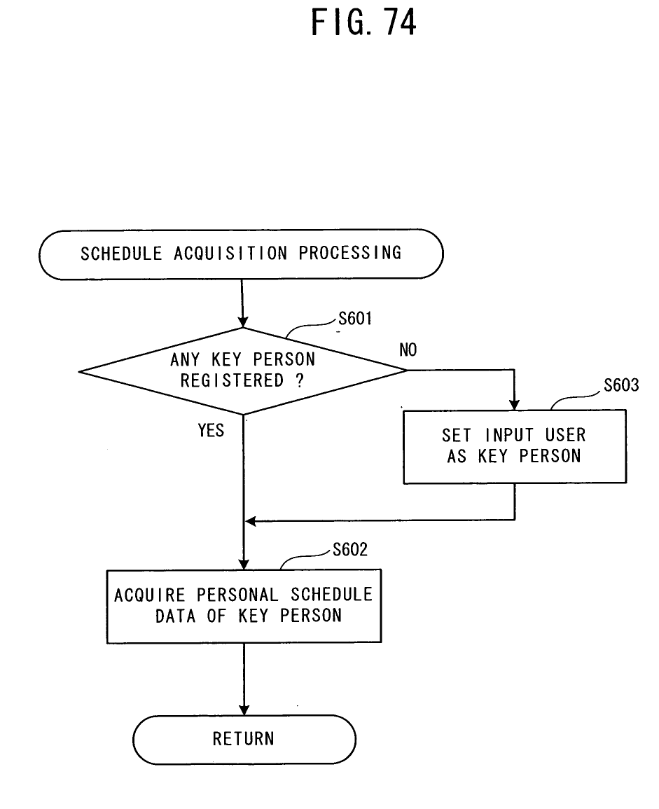

Next, an outline of main processing of the scheduling program 1221 executed by the CPU 1211 of the server 120 will be described with reference to FIGS. 73 and 74. The user 301 may access the scheduling program 1221 of the server 120 via the network from one of the user terminals 31 (referred to as the user terminal 310 hereinafter), input data on a new event for which a schedule arrangement is requested at the user terminal 31, and transmit the data to the server 120. The main processing shown in FIG. 73 is started when the server receives the input data from the user terminal 310.

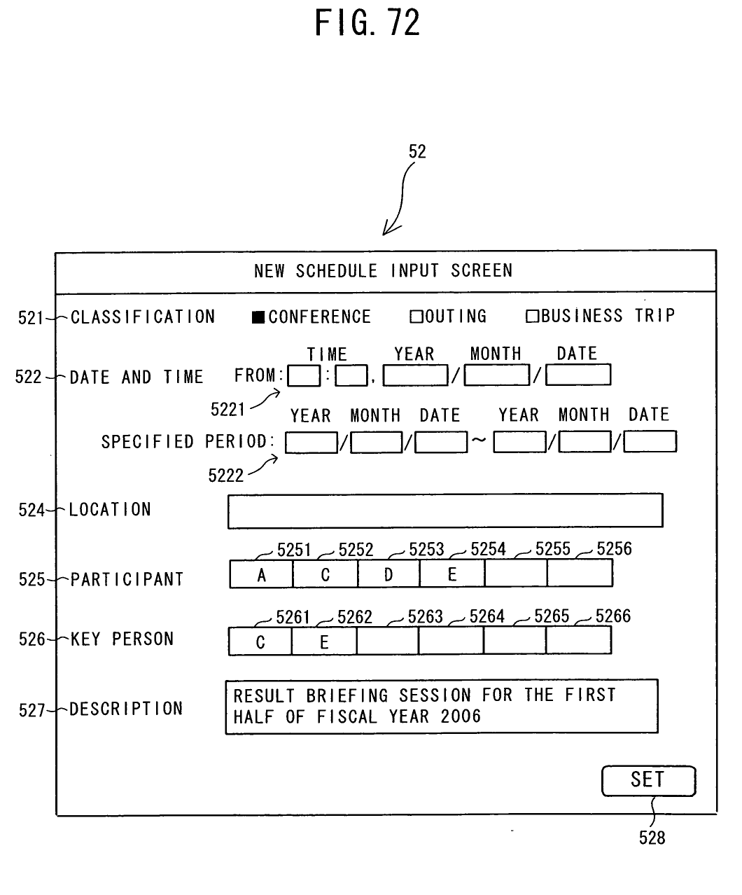

The new schedule input screen 52 shown in FIG. 72 is displayed on the display 314 of the user terminal 310 when the scheduling program 1221 is accessed. Input items of the new schedule input screen 52 are basically the same as the items of the new schedule input screen 51 in the third embodiment. The new schedule input screen 52 additionally includes key-person fields 526. Among the participants inputted in participant fields 525, an important member(s) whose participation is (are) absolutely required, for example, may be specified in the key-person fields 526. The key-person fields 526 include a plurality of input fields 5261 to 5266 so that a plurality of names can be inputted. While, like the third embodiment, a duration field 523 and the participant fields 525 are required input items, other fields are optional input items. Further, like the third embodiment, a “Set” button 528 is provided at the lower right corner of the new schedule input screen 52. If the user 301 clicks the “Set” button 528, the input data is transmitted to the server 120 via the network.

As shown in FIG. 73, after the main processing is started in the server 120, the CPU 1211 determines whether a specific date and time is specified based on the input data received from the user terminal 31 (S501). If there is date and time data inputted through the specified date and time field 5221 (FIG. 72) (Yes at S501), the CPU 1211 acquires schedule data of all the participants from the personal schedule database 1222 in the hard disk drive 122. The CPU 1211 checks whether all the participants inputted in the participant fields 525 (FIG. 72) are available at the specified date and time (S502). The duration inputted in a duration field 523 (FIG. 72) of the new schedule input screen 52 is also considered.

If there is any participant who is not available at the specified date and time (No at S502), the CPU 1211 transmits a message indicating that there is a participant who is not available at the specified date and time to the user terminal 310 of the user 301, who has inputted information of the new event (new event information) (S503). The CPU 1211 extracts dates and times at which all the participants are available for the duration in a predetermined period (for example, one week) from the schedule data of the participants and also notify the user terminal 310 of the extracted dates and times. Then, the CPU 1211 terminates the processing.

If it is determined that all the participants are available at the specified date and time based on the schedule data of the participants (Yes at S502) and also a specific location (conference room) is inputted (Yes at S504), the CPU 1211 acquires conference room data stored in the conference room schedule database 1223 in the hard disk drive 122 (S505). Then, the CPU 1211 checks whether the specified conference room is available at the specified date and time considering the duration (S506).

If the specified conference room is not available (No at S506), the CPU 1211 notifies the user terminal 310 of the user 301 who has inputted the new event information that the specified conference room is not available (S507). The CPU 1211 extracts other conference rooms available at the specified date and time from the conference room data, and also notifies the user terminal 310 of such available conference rooms. If the specified conference room is available (Yes at S506), the CPU 1211 registers the new schedule in the schedule data of the participants in the personal schedule database 1222 in the hard disk drive 122 (S512). The CPU 1211 also registers the new schedule in the conference room schedule database 1223 (S512). Subsequently, the CPU 1211 transmits a schedule determination notification to the user terminals 31 used by the participants including the user terminal 310 (S513), and terminates the processing.

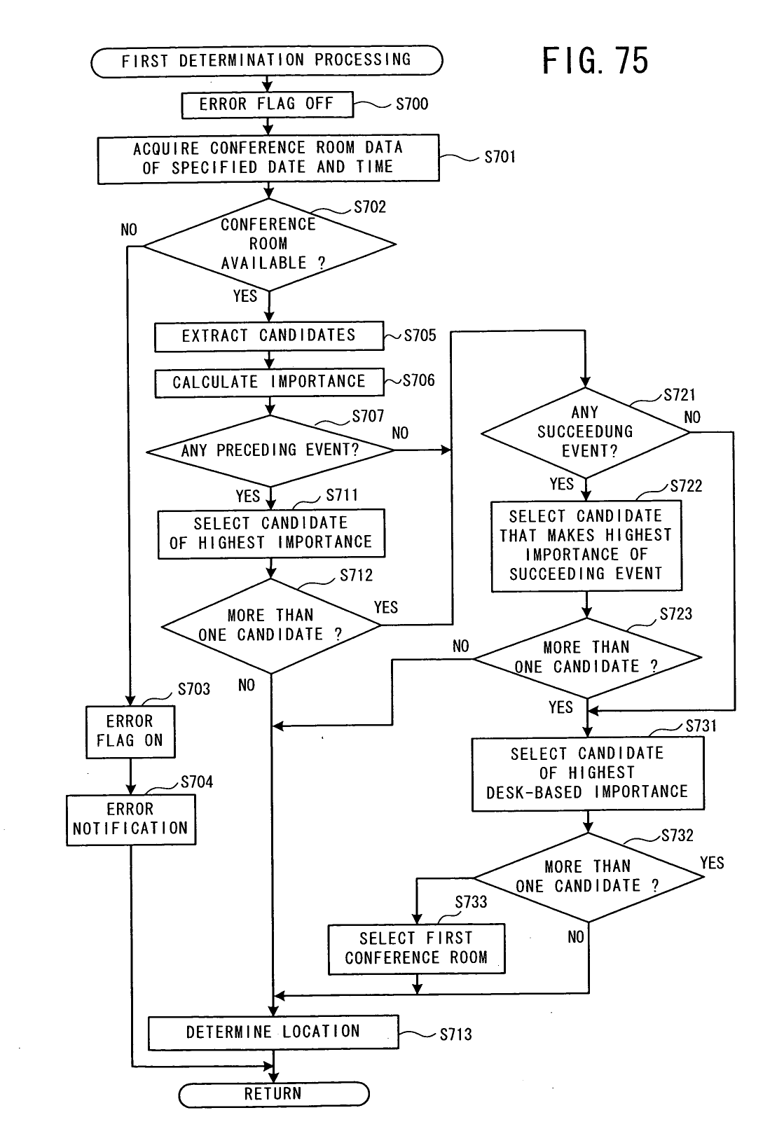

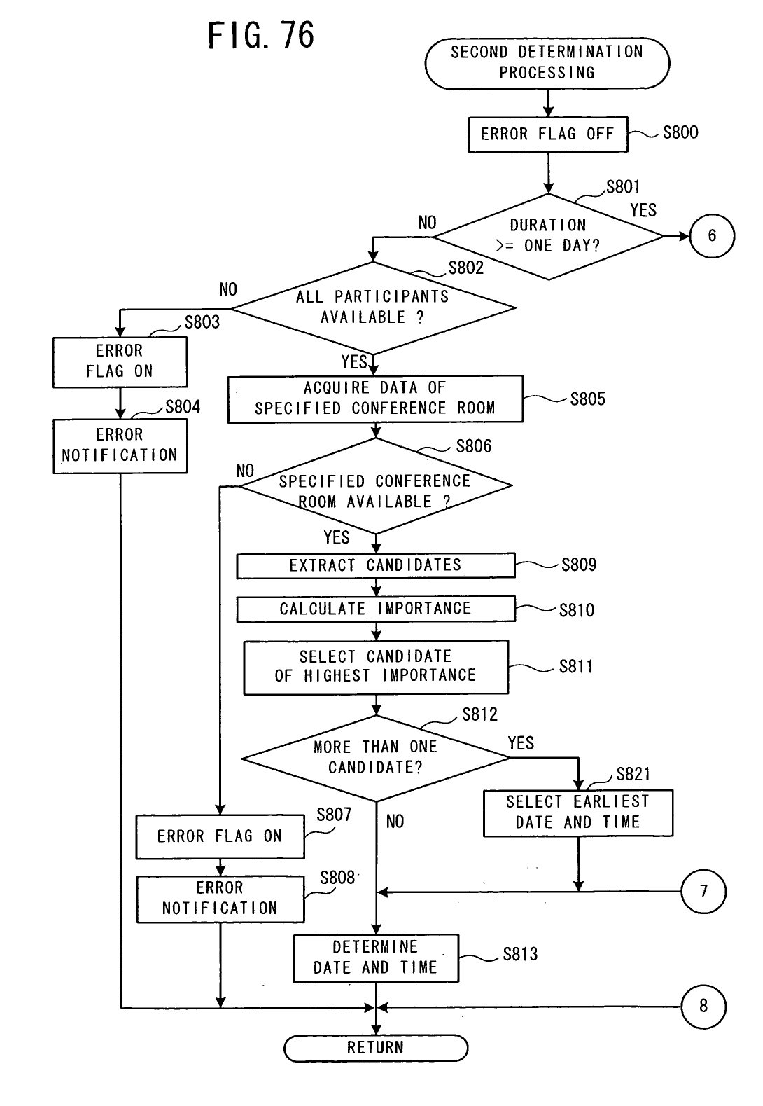

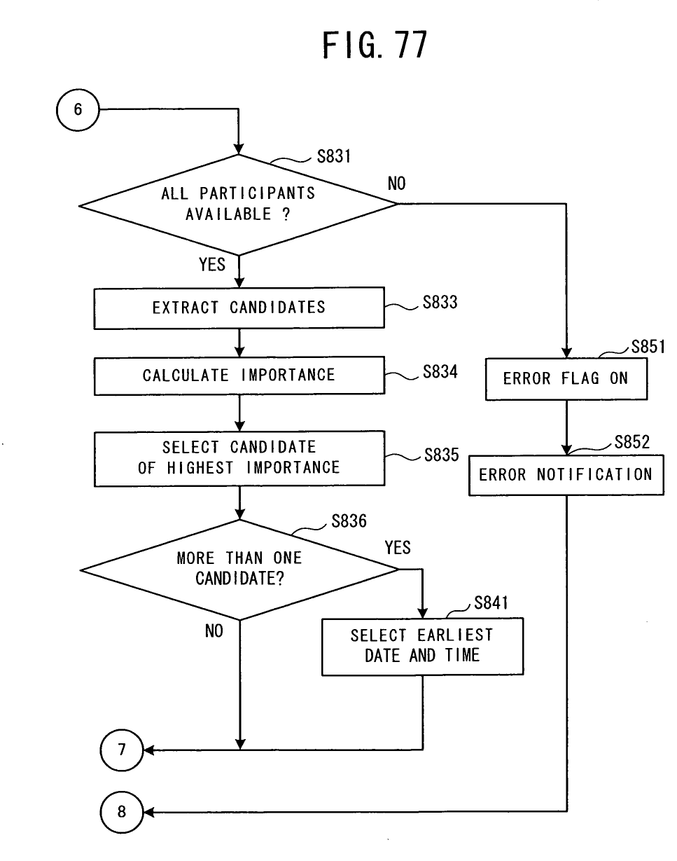

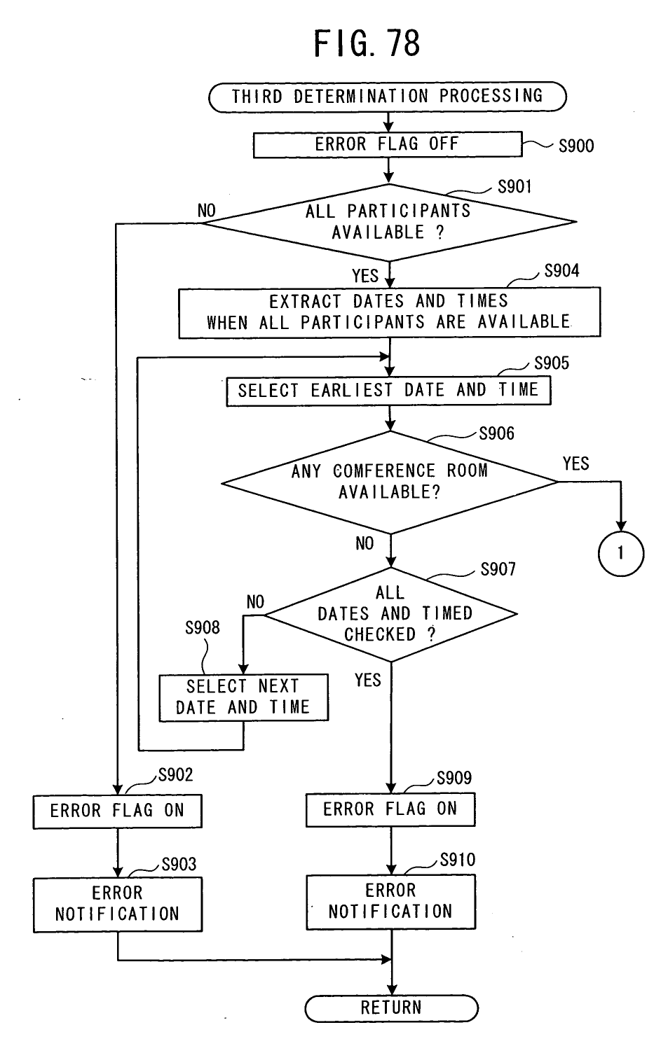

In the main processing shown in FIG. 73, if there is input data of the specified date and time (Yes at S501), but there is no input data of the location (No at S504), the CPU 1211 performs schedule acquisition processing described later (S514, See FIG. 74). Subsequently, the CPU 2111 performs first determination processing of the present embodiment (S515, See FIG. 75). If input data does not contain any specified date and time (No at S501) but contains the location (Yes at S521), the CPU 1211 performs the schedule acquisition processing (S522, See FIG. 74) and second determination processing of the present embodiment (S523, See FIGS. 76 and 77) in this order. If there is neither date and time data nor location data (No at S521), the CPU 1211 performs the schedule acquisition processing (S524, See FIG. 74) and third determination processing of the present embodiment (S525, See FIG. 78) in this order.

Following the first determination processing (S515), the second determination processing (S523), or the third determination processing (S525), the CPU 1211 determines whether an error has occurred in the processing based on an ON or OFF state of the error flag in the error flag storage area (not shown) of the RAM 1213 (S516). If an error has occurred (Yes at S516), the CPU 1211 immediately terminates the processing. If no error has occurred (No at S516), the CPU 1211 registers the new schedule in the schedule data of the respective participants in the personal schedule database 1222 (S512). The CPU 1211 also registers the new schedule with the conference room schedule database 1223 (S512). Subsequently, the CPU 1211 transmits a schedule determination notification to the user terminals 31 used by the participants including the user terminal 310 (S513), and terminates the processing.

Next, a subroutine of the schedule acquisition processing will be described with reference to the flowchart in FIG. 74. The schedule acquisition processing is performed in the main processing shown in FIG. 73 to acquire personal schedules of a user who serves as a reference for a schedule arrangement prior to any one of the first determination processing (S515), the second determination processing (S523), and the third determination processing (S525).

After the processing is started, the CPU 1211 first checks whether any key person is registered, based on the input data received from the user terminal 310 (S601). If there is no input data of the key person (No at S601), the CPU 1211 sets the user 301 of the user terminal 310, which is the originator of the input data of the new event information, as the key person (S603). The CPU 1211 acquires schedule data of the key person specified in the input data (Yes at S601) or the key person (the user 301) set at step S603 from the personal schedule database 1222 in the hard disk drive 122 (S602). The acquired schedule data is stored into in the RAM 1213. Subsequently, the CPU 1211 returns to the main processing shown in FIG. 73 to proceed to one of the first determination processing (S515), the second determination processing (S523), and the third determination processing (S525).

In the example shown in FIG. 72, two key persons are input in the key-person fields 526. In such a case, the “post” data stored in the personal data database 1224 in the hard disk drive 122 of the server 120 is referenced. Then, the member whose post is the highest may be set as the key person, and the schedule data of the member is acquired. If there is a plurality of members whose post is the same, the member whose name is inputted first in the key-person fields 526 may be set as the key person. In the example shown in FIG. 72, “C” may be set as the key person, and the schedule data of “C” may be acquired.

Next, a subroutine of the first determination processing will be described with reference to the flowchart in FIG. 75. The first determination processing is performed in the main processing shown in FIG. 73 when the date and time is specified (Yes at S501), but the location is not specified (No at S504).

After the processing is started, the CPU 1211 sets the error flag OFF in the error flag storage area (not shown) of the RAM 1213 (S700). Then, the CPU 1211 acquires all conference room data in a time zone obtained by adding the duration to the specified date and time from the conference room data stored in the conference room schedule database 1223 of the hard disk drive 212 (S701). If the CPU 1211 determines that there is no available conference room at the specified date and time based on the acquired data (No at S702), the CPU 1211 sets the error flag ON in the RAM 1213 (S703). Then, the CPU 1211 transmits a notification indicating that there is no available conference room at the specified date and time to the user terminal 310 of the user 301, who has inputted the new event information (S704), and returns to the main processing shown in FIG. 73.

If there is any conference room available at the specified date and time (Yes at S702), the CPU 1211 extracts candidates including the date and time specified during input as the candidate date and time and the available conference rooms as the candidate locations, respectively (S705). In the first determination processing, like in the third embodiment, a specific date and time is specified. Thus, even if a plurality of candidates is extracted, all the candidates include the same candidate date and time. After the candidates are extracted, the CPU 1211 calculates various kinds of importance, referencing the importance calculation table 81 shown in FIG. 60 and the schedule data of the key person acquired in the schedule acquisition processing (S514, See FIG. 74) (S706).

More specifically, the importance of each candidate and the importance of a succeeding event are calculated based on the travel distance from the preceding location of the key person. Further, the desk-based importance is calculated based on the travel distance from the desk location of the key person to the candidate location of each candidate. As a result, up to three kinds of importance, the “importance of a candidate”, the “importance of a succeeding event (only if succeeding event is registered)”, and the “desk-based importance of a candidate” are calculated, using the key person as a reference. The calculated importance is stored in the RAM 1213.

Subsequently, the CPU 1211 determines whether there is any preceding event for each candidate, that is, a registered event immediately before the specific date and time specified in the specified date and time field 5221 of the new schedule input screen 52, in the schedule data of the key person (S707). If there is a preceding event (Yes at S707), the CPU 1211 compares the importance of each candidate among the various kinds of importance calculated at step S706, and selects the candidate of the highest importance (S711). If there is only one candidate (No at S712), the CPU 1211 determines the candidate location of the candidate as the location of the event (S713), and returns to the main processing shown in FIG. 73.

If there is no preceding event registered immediately before the candidate date and time common to all the candidates (No at S707), or if there is a preceding event (Yes at S707) and there is a plurality of candidates of the highest importance (Yes at S712), the CPU 1211 determines whether there is a succeeding event, based on the schedule data of the key person (S721). If there is a succeeding event immediately after the candidate date and time common to all the candidates (Yes at S721), the CPU 1211 compares the importance of the succeeding event immediately after the candidates of the highest importance selected at step S711 among the various kinds of importance calculated as described above at step S706. Then, the candidate that makes the importance of the succeeding event the highest is selected (S722). If there is only one selected candidate (No at S723), the CPU 1211 determines the candidate location of the candidate as the location for the event (S713), and returns to the main processing shown in FIG. 73.

Further, if there is no succeeding event immediately after the candidate date and time common to all the candidate and timetable (No at S721), or if there is a succeeding event (Yes at S721) and there is a plurality of candidates that make the importance of the succeeding event the highest (Yes at S723), the CPU 1211 selects a candidate based on the desk-based importance (S731). Specifically, the CPU 1211 compares the desk-based importance of each candidate calculated at step S706 and stored in the RAM 2113 as described above, and selects the candidate of the highest desk-based importance (S731).

If there is only one candidate of the highest desk-based importance (No at S732), the CPU 1211 determines the candidate location of the candidate as the location for the event (S713). If there is a plurality of candidates of the highest desk-based importance (Yes at S732), the CPU 1211 determines the conference room of the candidate location whose data is registered first in the conference room schedule database 1223 as the location for the event (S733). Then, after the location is fixed (S713), the CPU 1211 returns to the main processing shown in FIG. 73.

Next, a subroutine of the second determination processing (S523) performed in the main processing of the scheduling program 1221 shown in FIG. 73 will be described with reference to the flowcharts in FIGS. 76 and 77. The second determination processing is performed in the main processing shown in FIG. 73 when the date and time is not specified (No at S501), but the location is specified (Yes at S521).

After the second determination processing shown in FIG. 76 is started, the CPU 1211 sets the error flag OFF in the error flag storage area (not shown) of the RAM 1213 (S800). Then, the CPU 1211 determines whether the duration is one day or more, or less than one day (S801). This processing is performed because, like the third embodiment, an importance calculation table to be used for calculating the importance changes depending on whether the duration is one day or more, or less than one day (See FIGS. 60 and 61).

If the duration is less than one day (No at S801), the CPU 1211 acquires schedule data for each participant from the personal schedule database 1222 to determine whether there is any time zone in which all the participants specified in the participant fields 525 are available for the duration in the specified period or in the predetermined period (S802). Definitions of the specified period and the predetermined period are the same as those in the third embodiment. If there is no available time for the duration over the specified period or the predetermined period (No at S802), the schedule cannot be registered under the input conditions. Thus, the CPU 1211 sets the error flag ON in the RAM 1213 (S803), and transmits a notification to the user terminal 310 of the user 301 who has inputted the new event information (S804). The notification indicates that there is no date and time in the specified period or in the predetermined period at which all the participants are available. Then, the CPU 1211 returns to the main processing shown in FIG. 73.

If the CPU 1211 determines that there is a date and time in the specified period or in the predetermined period at which all the participants are available (Yes at S802), the CPU 1211 acquires data of the conference room specified in a location field 524 of the new schedule input screen 52 shown in FIG. 72 in the specified period or in the predetermined period (S805). Then, whether or not the specified conference room is available in the specified period or predetermined period is checked (S806). If the specified conference room is not available for the duration (No at S806), the CPU 1211 sets the error flag ON in the RAM 1213 (S807) and transmits a notification that the specified conference room is not available to the user terminal 310 of the user 301 who has inputted the new event information (S808). Then, the CPU 1211 returns to the main processing shown in FIG. 73.

If the specified conference room is available (Yes at S806), the CPU 1211 extracts candidates including candidate dates and times and candidate locations, considering time zones in which all participants are available based on the schedule data of each participant obtained at step S802 (S809). Then, the CPU 1211 calculates the importance of each candidate using the importance calculation table 81 shown in FIG. 60, and stores the calculated importance into the RAM 1213 (S810). More specifically, if there is a preceding event in the schedule of the key person acquired in the schedule acquisition processing (S514, See FIG. 74), the importance is calculated based on the travel distance from the location of the preceding event. If there is no preceding event, the importance is calculated based on the travel distance from the desk location of the key person.

Next, the CPU 1211 compares the importance of each candidate calculated as described above to select the candidate of the highest importance (S811). If there is only one candidate (No at S812), the CPU 1211 determines the candidate date and time of the candidate as the date and time of the new event (S813), and returns to the main processing shown in FIG. 73. If there is a plurality of candidates of the highest importance (Yes at S812), the CPU 1211 selects the candidate of the earliest date and time among the candidates (S821), and determines the candidate date and time as the date and time for the event (S813).

In the second determination processing shown in FIGS. 76 and 77, if the duration is determined to be one day or more (Yes at S801), like when the duration is less than one day, the schedule data of the participants stored in the personal schedule database 1222 is acquired. Then, the CPU 1211 determines whether there are dates and times at which all the participants are available for the duration in the specified period or in the predetermined period (FIG. 77, S831). If there is no time zone in which all the participants are available (No at S831), the CPU 1211 sets the error flag ON in the error flag storage area (not shown) of the RAM 1213 (S851) and transmits a notification to the user terminal 310 of the user 301 who has inputted the new event information (S852). The notification indicates that there is no date and time in the specified period or in the predetermined period at which all the participants are available. Then, the CPU 1211 returns to the main processing shown in FIG. 73.

As shown in FIG. 77, if there are dates and times at which all the participants are available (Yes at S831), the CPU 1211 extracts candidates (S833), calculates the importance of each candidate and stores the calculated importance into the RAM 1213 (S834). More specifically, if there is a registered event on the previous day of each candidate in the schedule of the key person acquired in the schedule acquisition processing (S522, See FIG. 74), the importance is calculated based on the travel distance from the location of the event on the previous day. If there is no registered event on the previous day, the importance is calculated based on the travel distance from the desk location of the key person.

Next, the CPU 1211 compares the importance of each candidate calculated as described above to select the candidate of the highest importance (S835). If there is only one candidate (No at S836), the CPU 1211 determines the candidate date and time of the candidate as the date and time of the new event (S813 in FIG. 76). If there is a plurality of candidates of the highest importance (Yes at S836), the CPU 1211 selects the candidate of the earliest date and time among the candidates (S841) to determine the date and time of the event (S813 in FIG. 76).

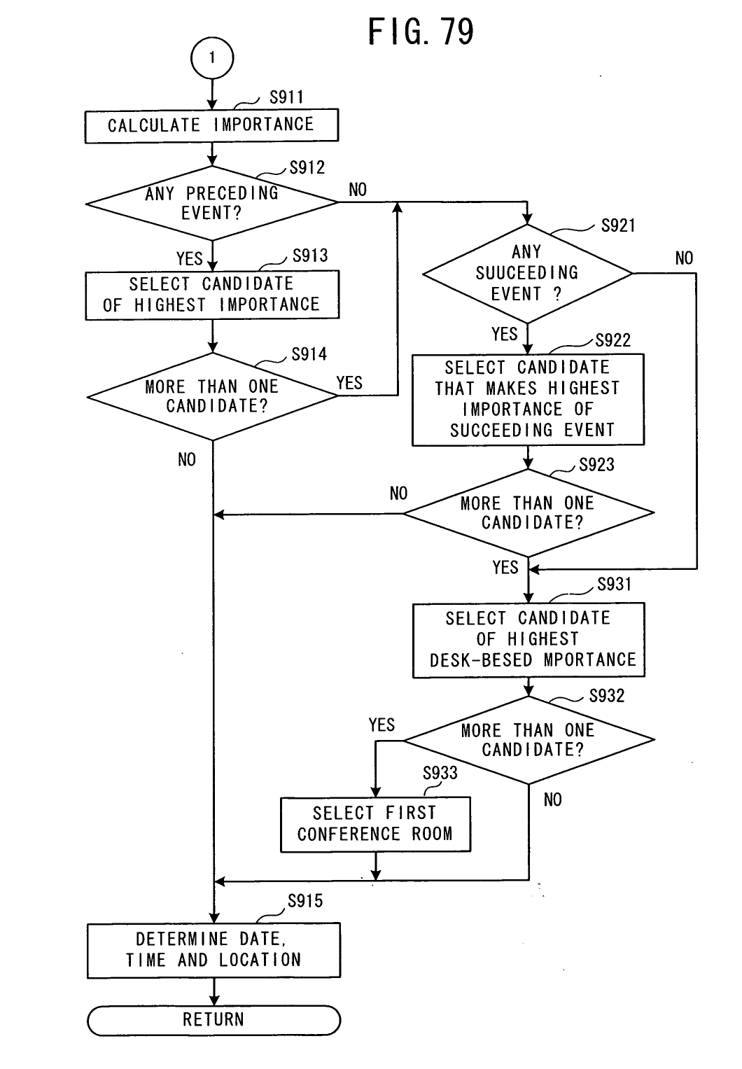

Next, a subroutine of the third determination processing (S525) performed in the main processing shown in FIG. 73 will be described with reference to the flowchart in FIGS. 78 and 79. This processing is performed in the main processing shown in FIG. 73 when neither a specific date and time nor location is specified (No at S501, No at S521 in FIG. 73). In the present embodiment, a case where “no specific date and time is specified” also applies to a case where there is input only in a specified period field 5222 and no input in the specified date and time field 5221 in a date and time fields 522 of the new schedule input screen 52 shown in FIG. 72.

After the third determination processing is started, as shown in FIG. 78, the CPU 1211 sets the error flag OFF in the RAM 1213 (S900). Next, the CPU 1211 acquires schedule data of all the participants (participants “A”, “C”, “D”, and “E” in the input example in FIG. 72) from the personal schedule database 1222. The CPU 1211 checks whether there is any time zone in which all the participants are available for the duration in the specified period or in the predetermined period (S901). Definitions of the specified period and the predetermined period are the same as those in the third embodiment.

If there is no time zone in which all the participants are available (No at S901), the CPU 1211 sets the error flag ON in the RAM 1213 (S902). The CPU 1211 then transmits a notification to the user terminal 310 of the user 301 who has inputted the new event information (S903). The notification indicates that there is no date and time in the specified period or in the predetermined period at which all the participants are available. Then, the CPU 1211 returns to the main processing shown in FIG. 73.

If there are dates and times at which all participants are available for the duration (Yes at S901), the CPU 1211 extracts such dates and times and stores the extracted dates and times in the RAM 1213 (S904). Then, the CPU 1211 selects the earliest date and time among the extracted dates and times (S905), and acquires conference room data of the date and time from the conference room schedule database 1223. The CPU 1211 checks whether there is any conference room available at the selected date and time (S906). If there is no available conference room at that date and time (No at S906), but all the extracted dates and times have not yet been checked for availability (No at S907), the CPU 1211 selects the next earliest date and time (S908) to repeat checks for availability of the conference rooms (S906 to S908).

If, as a result of checking all the extracted dates and times, the CPU 1211 determines that there is no available conference room (No at S906, Yes at S907), the CPU 1211 sets the error flag ON in the RAM 1213 (S909). Subsequently, the CPU 1211 transmits a notification that there is no available conference room in the specified period or in the predetermined period to the user terminal 310 of the user 301 who has inputted the new event information (S910), and returns to the main processing shown in FIG. 73.

If there is any conference room available at the selected date and time (Yes at S906), candidates having the selected date and time as the candidate date and time and the available conference rooms as the candidate locations are determined. Because there is only one selected date and time, all the candidates have the same candidate date and time. Next, the CPU 1211 calculates various kinds of importance, using the importance calculation table 81 shown in FIG. 60 and schedule data of the key person acquired in the schedule acquisition processing (S524, See FIG. 74) (S911 in FIG. 79).

More specifically, the importance of each candidate and the importance of a succeeding event is respectively calculated, based on the travel distance from the location where the key person is located immediately before. Further, the desk-based importance is calculated based on the travel distance from the desk location of the key person to the candidate location of each candidate. Accordingly, up to three kinds of importance, the “importance of each candidate”, the “importance of a succeeding event (only if a succeeding event is registered)”, and the “desk-based importance of each candidate” is calculated using the key person as a reference. The calculated importance is stored into the RAM 1213.

As shown in FIG. 79, if there is a preceding event immediately before the selected date and time (Yes at S912), the CPU 1211 compares the importance of each candidate to select the candidate of the highest importance (S913). If there is only one selected candidate (No at S914), the CPU 1211 determines the candidate as the date and time and the location for the event (S915). Then, the CPU 1211 returns to the main processing shown in FIG. 73. If there is a plurality of candidates of the highest importance (Yes at S914), the CPU 1211 checks whether there is any succeeding event immediately after the candidates with the same date and time (S921). If there is a succeeding event (Yes at S921), the CPU 1211 selects the candidate that makes the importance of the succeeding event calculated at step S911 and stored in the RAM 1213 the highest (S923).

If a plurality of candidates still remains (Yes at S923) or if there is no succeeding event (No at S921), the CPU 1211 compares the desk-based importance calculated at step S911 and stored in the RAM 1213 to select the candidate of the highest desk-based importance (S931). If there is only one selected candidate (No at S932), the CPU 1211 determines the candidate as the date and time and the location for the event (S915). If a plurality of candidates remains (Yes at S932), the CPU 1211 selects the conference room registered first in the conference room schedule database 1123 (S933) to fix the date and time and the location of the event (S915).

As described above, in the scheduling system 2 according to the present embodiment, data of a new event such as a conference inputted by the user 300 at the user terminal 31 is received by the server 120 via the network. Then, the CPU 1211 of the server 120 arranges a schedule to allow all participants to attend the new event by referencing schedules of all the participants based on the personal schedule database 1222 in the hard disk drive of the server 120. Therefore, the rate of participation in the new event may be improved.

In addition, a schedule may be determined by selecting the date and time and location that make the travel distance between events of the key person, who is an important member of the new event, the shortest. Therefore, a travel-efficient schedule, which may not require a useless travel such as travels between the same places or a detour, may be determined for the key person automatically. If all the participants are not available at a specified date and time, or if a specified conference room is not available, the CPU 1211 of the server 120 extracts dates and times at which all the participants can attend or other available conference rooms. The CPU 1211 then notifies the user terminal 31 of the user who has inputted the new event. Thus, the notified user who has inputted the new event can rearrange a schedule for a new date and time and a location that are more likely to meet conditions.

It is needless to say that scheduling apparatuses and scheduling programs in the present disclosure are not limited to the above embodiments and various modifications may be made.

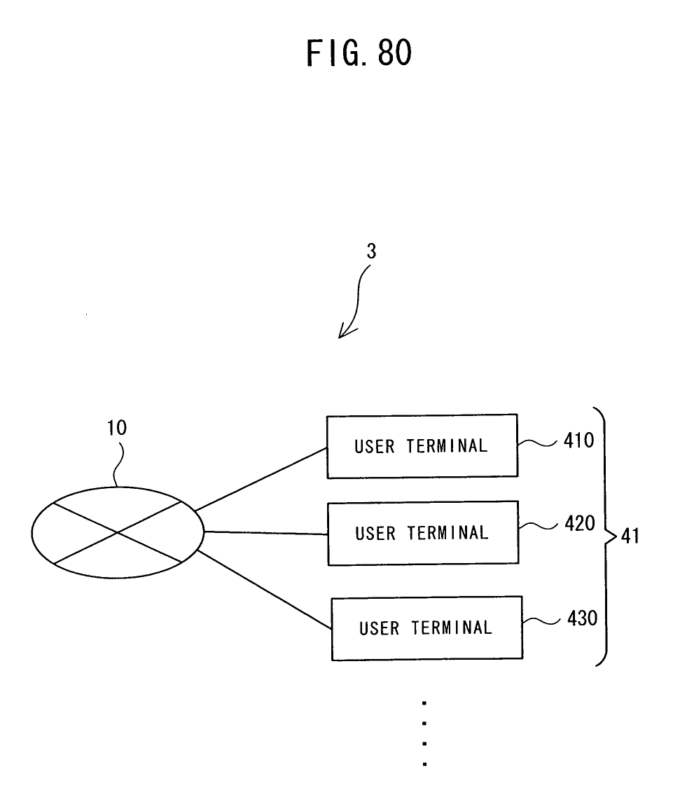

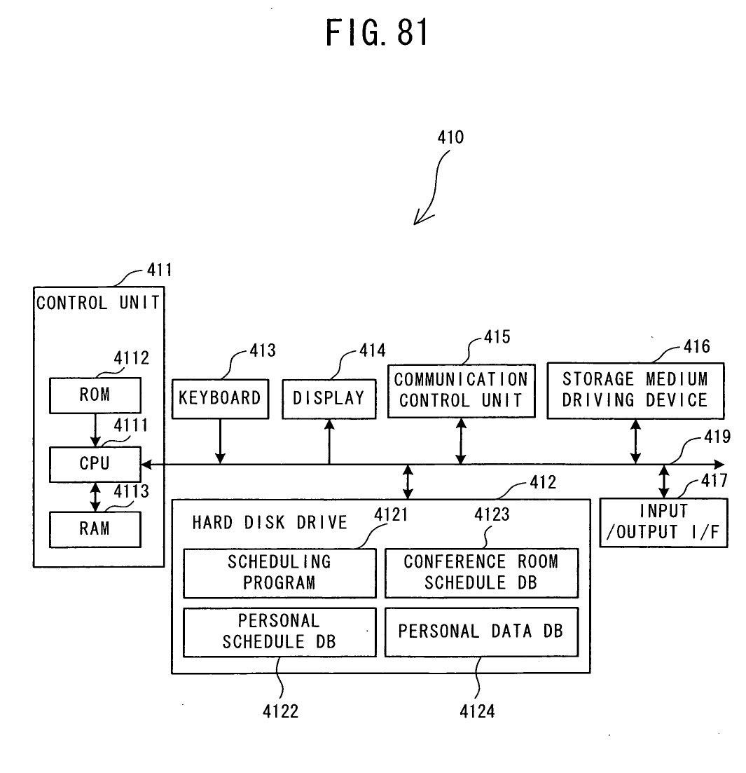

For example, FIGS. 80 and 81 show the scheduling system 3, which is a modification of the scheduling system 1 in the third embodiment. In contrast to the third embodiment, as shown in FIG. 80, the scheduling system 3 does not include a server and has a configuration in which a plurality of user terminals 41 is mutually connected via a network 10. As shown in FIG. 81, like the user terminal 210 in the third embodiment, a user terminal 410 is provided with a control unit 411 including a CPU 4111, a ROM 4112, and a RAM 4113. The ROM 4112 and the RAM 4113 are each connected to the CPU 4111. The CPU 4111 is further connected via a data bus 419 to a hard disk drive 412, a keyboard 413, a display 414, a communication control unit 415, a storage media driving device 416, and an input and output interface (I/F) 417. The user terminals 41 other than the user terminal 410 each have the same configuration as the configuration of the user terminal 410.

In contrast to the user terminal 21 in the third embodiment, the hard disk drive 412 in the user terminal 410 stores a scheduling program 4121, a personal schedule database 4122, a conference room schedule database 4123, and a personal data database 4124. The scheduling program 4121 performs processing of arranging a schedule after receiving input from the keyboard 413 of the user terminal 410. The personal schedule database 4122 includes schedule data of all users 401 of the user terminals 41. The conference room schedule database 4123 includes conference room data including locations of conference rooms available to the users 400 of the plurality of user terminals 41, dates and times, and reservations corresponding to the locations and the dates and times. The personal data database 4124 includes personal information such as the identification code, name, section, managing post, telephone number, and e-mail address of all the users 400 of the user terminals 41.

Among these, the conference room schedule database 4123 and the personal data database 4124 are provided on the server 110 in the scheduling system 1 in the third embodiment, and the users 200 of the plurality of user terminals 21 use them in common by accessing the server 110. In the scheduling system 3 according to the present modification, however, each of the user terminals 41 is provided with the conference room schedule database 4123 and the personal data database 4124. Each time an update is performed in one of the user terminals 41, the conference room schedule database 4123 and the personal data database 4124 of the other user terminals 41 are updated via the network. Accordingly, the scheduling system 3 is configured so that each of the user terminals 41 always has the same conference room schedule database 4123 and the same personal data database 4124. Other configurations and functions are the same as those of the scheduling system 1 in the third embodiment. Thus, a scheduling system may be configured to include only the user terminals 41, without a server.

in the first and second exemplary embodiments, the weather forecast acquired from the weather forecast terminal 7 and stored in the weather forecast DB storage area 283 is referenced. However, the server 20 may acquire the weather forecast by connecting to the weather forecast terminal 7 each time the weather forecast is referenced. Alternatively, the terminal 10 may include a device that can connect to the Internet 6 so that the weather forecast is acquired by directly connecting to the weather forecast terminal 7.

In the first exemplary embodiment, the building and the room need to be specified to specify a location but only the building may be specified. In such a case, it may be determined whether the building is specified prior to step S65 of the second scheduling processing shown in the flowchart in FIG. 24 performed in the case where “only one date and time is specified”. If the building is specified, the building is set as the candidate building and stored in the candidate building storage area 240 before proceeding to step S67.

In the second exemplary embodiment, the personal schedule DB storage area 1181 is provided in the user terminal 10, but the information may also be stored in the hard disk drive 28 of the server 20. In such a case, availability inquiry information may be transmitted to the server 20, and available dates and times may be extracted on the server 20.

In the third and fourth exemplary embodiments, after candidates are extracted, up to three kinds of importance, the “importance of each candidate”, the “importance of a succeeding event”, and the “desk-based importance of each candidate” is calculated at the same step and stored into a RAM so that necessary importance is referenced in subsequent processing. However, only the necessary importance may be calculated each time processing is performed. Further, while the order of considering the three kinds of importance is set as the “importance of each candidate”, the “importance of a succeeding event”, and the “desk-based importance of each candidate”, this order may be changed.

In the third and fourth exemplary embodiments, the importance of each candidate is calculated in accordance with the travel distance from the location where a user is located immediately before a new event (the location of a registered event or the desk of the user) to a candidate location of the new event using an importance calculation table. However, the importance of each candidate may be calculated in accordance with the travel distance from a candidate location of a new event to the location where the user is located immediately after the new event. Further, a correspondence between the location and importance in the importance calculation table may further be subdivided or more tables may be employed in accordance with classifications such as “Conference”, “Outing”, and “Business trip”.

Further, in the first to fourth exemplary embodiments, some screens are shown to inform a user or to make the user select or input. It is needless to say that the text and designs displayed in the screens are not limited to the above examples. While schedules are divided up in hours, schedules may be divided up, for example, in units of 30 minutes to allow finer schedule arrangements.

A scheduling apparatus or a scheduling program according to the present disclosure may determine a location and a date and time of a new event based on new event information, personal schedule information, and at least the weather forecast or a travel distance of at least one of participants. Thus, the location and the date and time of the new event that are most favorable for the user in terms of a weather or a travel efficiency may be determined.

Also, the scheduling apparatus or the scheduling program according to the present disclosure may determine the location of the new event based on the weather forecast and may determine the date and time giving priority to dates and times for clear weathers are forecast. In such a case, the probability of a travel to the location under a bad weather may be made lower.

Also, the scheduling apparatus or the scheduling program according to the present disclosure may determine the time between the starting time and the finishing time of work hours for a predetermined number of days from the current date as a desired date and time, if no desired date and time of the new event is included in the new event information. In such a case, the date and time of the schedule may be determined from an appropriate period even if a user specifies no date and time during input.

Also, the scheduling apparatus or the scheduling program according to the present disclosure may set a desired date and time as one of a starting date and time and a finishing date and time of the new event, a starting date and time and a duration of the new event, and a desired time zone and a duration of the new event. In such a case, a user may input only one desired date and time so that a time zone having more latitude can be specified.

Also, the scheduling apparatus or the scheduling program according to the present disclosure may set the desired date and time as the date and time of the new event, if the desired date and time is a starting date and time and a finishing date and time of the new event or a starting date and time and a duration of the new event. In such a case, if only one date and time desired by a user is input, the date and time desired by the user may be determined as the date and time of the new event.

Also, the scheduling apparatus or the scheduling program according to the present disclosure may determine the date and time of the new event by extracting from the desired dates and times those dates and times at which at least a predetermined number of participants are available based on personal schedule information of the participants, and giving priority to dates and times among the extracted dates and times for which a clear weather is forecast. In such a case, a date and time at which more participants are expected may be set as the date and time of the new event, and also the probability of a travel under a bad weather, which is not clear weather, may become lower.

Also, the scheduling apparatus or the scheduling program according to the present disclosure may determine the date and time of the new event by acquiring the reservation status showing whether or not a location that can be determined as the location is reserved, and giving priority to dates and times for which clear weathers are forecast among the dates and times determined to be available. In such a case, the date and time of the new event may be determined in favor of the dates and times for which clear weathers are forecast among the dates and times at which the location is available. Thus, the date and time at which the location can be reliably reserved may be determined, and also the probability of a travel under a bad weather, which is not clear weather, may become lower.

Also, the scheduling apparatus or the scheduling program according to the present disclosure may make a notification to prompt the participants of the new event to input whether to be able to attend the new event at the date and time of the new event. If at least a predetermined number of participants are not able to attend based on input results from participants, a new date and time may be determined. In such a case, another date and time may be set as the date and time of the new event when the number of participants who will be able to attend is small, and thus, a date and time at which more participants can be expected may be set as the date and time of the new event.

Also, the scheduling apparatus or the scheduling program according to the present disclosure may determine a location as the location of the new event by giving priority to a possible location that may be designated as the location and that has a calculated travel distance value showing a shorter travel distance, if one location cannot be specified by the desired location and a clear weather is not forecast for the date and time of the new event. The calculated travel distance value may be calculated based on travel distance values for travels between the location of the user immediately before the date and time of the new event and the possible location. In such a case, if a date and time for which a bad weather, which is not clear weather, is forecast is set as the date and time of the new event, a location that makes the travel distance from the location where the participants are located immediately before the date and time to the location as short as possible may be set. Therefore, despite bad weather, an influence thereof may possibly be reduced.

Also, if a clear weather is not forecast for the date and time of the new event and the calculated travel distance value calculated based on the travel distance values between the whereabouts of the participants immediately before the date and time and the possible location that may be determined as the location of the new event shows a long travel distance, the scheduling apparatus or the scheduling program according to the present disclosure may make a notification to that effect. In such a case, because the participants can know that they may be affected by the bad weather if the location and date and time are fixed, the drafter of the new event may be able to examine whether to change the location or date and time of the new event.

Also, the scheduling apparatus or the scheduling program according to the present disclosure may make a notification that the desired date and time will have inappropriate weather, if a clear weather is not forecast for the date and time and the location is outdoors. In such a case, because the participants can know that holding the new event may be affected by the bad weather, the drafter of the new event may examine whether to change the date and time.

Also, the scheduling apparatus or the scheduling program according to the present disclosure may register the new schedule when instructed to execute storage even if the notification is made. In such a case, the schedule may be registered with the location and date and time even if the schedule may be affected by bad weather.

Also, the scheduling apparatus or the scheduling program according to the present disclosure may determine a new location or a new date and time, if the notification is made and the desired location or desired date and time is changed. In such a case, if the schedule is affected by the bad weather, the desired location or desired date and time may be changed to rearrange the schedule. Thus, an influence due to the bad weather may be avoided.

Also, the scheduling apparatus or the scheduling program according to the present disclosure may acquire and make a notification of the weather forecast for a registered date and time of an existing event prior to the registered date and time. In such case, the drafter of the schedule may know the possibility of the schedule being affected by a bad weather, if the weather has changed to the bad weather after registration of the schedule. Thus, the drafter may be able to examine whether to change the location or date and time.

Also, the scheduling apparatus or the scheduling program according to the present disclosure may determine a new location or a new date and time, if the weather forecast for the registered date and time of the existing event is notified of and the desired location or desired date and time is changed. In such a case, if the weather forecast changes to a bad weather after registration of the schedule, the schedule may be rearranged by changing the desired location or desired date and time. Thus, an influence due to the bad weather may be avoided.

Also, the scheduling apparatus or the scheduling program according to the present disclosure may determine the location and date and time based on a travel distance between a candidate location of a candidate at which a new event can be held and a registered existing event immediately before or immediately after the candidate, or a travel distance between the candidate location the usual whereabouts of a user. In such a case, if a plurality of conferences is held continuously, determinations of schedules involving inefficient movement such as travelling between the same places or making a detour may be avoided.

Also, the scheduling apparatus or the scheduling program according to the present disclosure may determine the location and date and time of the new event first considering the travel distance from the existing event immediately before the candidate and if there is no existing event immediately before, then, by considering the travel distance to an existing event immediately after or that from the reference location, which is the usual whereabouts of a user, in such a way that the travel distance is made the shortest. In such a case, processing of arranging a travel-efficient schedule may be performed systematically.

Also, when there is a plurality of the candidates for the new event that make the travel distance from the existing event immediately before the candidate the shortest, the scheduling apparatus or the scheduling program according to the present disclosure may determine the location and date and time in such a way that the travel distance to the existing event immediately after or that from the reference location, which is the usual whereabouts of the user, becomes the shortest. In such a case, processing of arranging a travel-efficient schedule may be performed systematically.

Also, the scheduling apparatus or the scheduling program according to the present disclosure may calculate the importance, which increases with a shorter travel distance between the new event and the existing event immediately before or after the new event or that between the reference location and the new event, and determine the location and execution date and time based on the calculated importance. In such a case, the travel distance may easily be compared.

Also, the scheduling apparatus or the scheduling program according to the present disclosure may determine whether to approve the new schedule of which the participants are notified based on the travel distance between the new schedule and the existing event immediately after the new schedule, and notify a notification source of the new schedule of a result thereof. In such a case, if the determination result is negative, the notification source of the new schedule may be able to increase an attendance rate of the participants by changing the schedule.

Also, the scheduling apparatus or the scheduling program according to the present disclosure may use the personal schedule information of at least one of the participants in selecting the candidates. In such a case, the candidates in which the specific participant(s) can attend may reliably be selected.

Also, the scheduling apparatus or the scheduling program according to the present disclosure may consider the travel distance based on information about existing events included in the personal schedule information of at least one of the participants. In such a case, a schedule arrangement that realizes best travel-efficiency for the specific participant(s) may be made.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A scheduling apparatus that arranges a schedule for a new event in accordance with an input, comprising:
an input accepting device that accepts as an input new event information that may include a desired date and time of the new event, a desired location of the new event, and participants of the new event, at least the participants being requisite in the new event information;
a personal schedule information acquisition device that acquires personal schedule information from a personal schedule storage device, the personal schedule storage device storing the personal schedule information including identification information of a user, a registered date and time and a registered location, the registered date and time being a date and time of a registered existing event, the registered location being a location of the registered existing event;
a schedule determination device that determines a new schedule including a holding date and time and a holding location based on the new event information accepted by the input accepting device, the personal schedule information acquired by the personal schedule information acquisition device, and at least one of a weather forecast or a travel distance of at least one of the participants to attend the new event, the holding date and time being a determined date and a time of the new event, and the holding location being a determined location of the new event; and
a schedule registration device that registers the new schedule determined by the schedule determination device into the personal schedule storage device.

2. The scheduling apparatus according to claim 1, further comprising:
a connecting device that connects to a weather forecast terminal via a network, the weather forecast terminal providing the weather forecast; and
a weather forecast acquisition device that acquires the weather forecast from the weather forecast terminal connected by the connection device,
wherein:
the schedule determination device includes:
a location determination device that determines the holding location of the new event based on the new event information accepted by the input accepting device, the personal schedule information acquired by the personal schedule information acquisition device, and the weather forecast acquired by the weather forecast acquisition device; and
a date and time determination device that determines the holding date and time of the new event based on the new event information accepted by the input accepting device, the personal schedule information acquired by the personal schedule information acquisition device, and the weather forecast acquired by the weather forecast acquisition device, giving priority to a date and time at which a clear weather is forecast from among desired dates and times, if the desired dates and times are included in the new event information.

3. The scheduling apparatus according to claim 2, further comprising:
a desired date and time arrangement device that sets dates and times each starting at a start time of working hours and ending at a finish time of the working hours in a predetermined number of days from a current date as the desired dates and times, if the desired dates and times are not included in the new event information,
wherein the date and time determination device determines the holding date and time, giving priority to a date and time at which a clear weather is forecast from among the desired dates and times set by the desired date and time arrangement device.

4. The scheduling apparatus according to claim 2, wherein the desired date and time is specified with a starting date and time and a finishing date and time of the new event, with a starting date and time and a duration of the new event, or with a desired time zone and a duration of the new event.

5. The scheduling apparatus according to claim 2, wherein the date and time determination device determines the desired date and time as the holding date and time, if the desired date and time is specified with a starting date and time and a finishing date and time of the new event or with a starting date and time and a duration of the new event.

6. The scheduling apparatus according to claim 2, wherein:
the date and time determination device includes:
an available date and time extraction device that extracts available dates and times at which a predetermined number of the participants are available among the desired dates and times included in the new event information, based on the personal schedule information of the participants acquired by the personal schedule information acquisition device, and
the date and time determination device determines the holding date and time, giving priority to a date and time at which the clear weather is forecast among the available dates and times extracted by the available date and time extraction device.

7. The scheduling apparatus according to claim 2, further comprising:
a reservation status acquisition device that acquires a reservation status from a reservation status storage device that stores the reservation status indicating whether a possible location is available or reserved, the possible location being possible for the location determination device to determine as the holding location,
wherein:
the date and time determination device includes:
an availability determination device that determines whether the holding location determined by the location determination device or a desired location included in the new event information is available at the desired dates and times included in the new event information, based on the reservation status of the holding location or the desired location acquired by the reservation status acquisition device, and
the date and time determination device determines the holding date and time giving priority to a date and time at which the clear weather is forecast among the desired dates and times at which the holding location or the desired location is determined to be available by the availability determination device.

8. The scheduling apparatus according to claim 2, wherein:
the date and time determination device includes:
an input notification device that makes a notification to prompt the participants of the new event to input whether to be able to attend to the new event at the holding date and time via a participation input device, and
the date and time determination device determines a new holding date and time other than the holding date and time, if results inputted via the participation input device by the participants of the new event indicate that a predetermined number of the participants are not able to attend the new event.

9. The scheduling apparatus according to claim 2, further comprising:
a weather determination device that determines whether the clear weather is forecast at the holding date and time determined by the date and time determination device;
a preceding location acquisition device that acquires a preceding location of at least one of the participant from the personal schedule storage device, the preceding location being a location where the user is located immediately before the holding date and time;
a travel distance value acquisition device that acquires travel distance values for travels between one of possible locations and the preceding location of at least one of the participants acquired by the preceding location acquisition device from a travel distance value storage device, the travel values each relating to a travel distance between two possible locations, the possible locations each being possible for the location determination device to determine as the holding location, the travel distance value storage device storing travel distance value information pieces each indicating the travel distance value; and
a calculated travel distance value calculation device that calculates calculated travel distance values of the possible locations based on the travel distance values acquired by the travel distance value acquisition device,
wherein:
the location determination device determines the holding location giving priority to one of the possible locations having the calculated travel distance value calculated by the calculated travel distance value calculation device that indicates a short travel distance, if one location cannot be specified by a desired location included in the new event information and the weather determination device determines that the clear weather is not forecast at the holding date and time.

10. The scheduling apparatus according to claim 2, further comprising:
a weather determination device that determines whether a clear weather is forecast at the holding date and time determined by the date and time determination device;
a preceding location acquisition device that acquires a preceding location of at least one of the participant from the personal schedule storage device, the preceding location being a location where the user is located immediately before the holding date and time;
a travel distance value acquisition device that acquires travel distance values for travels between one of possible locations and the preceding location of at least one of the participants acquired by the preceding location acquisition device from a travel distance value storage device, the travel values each relating to a travel distance between two possible locations, the possible locations each being possible for the location determination device to determine as the holding location, the travel distance value storage device storing travel distance value information pieces each indicating the travel distance value;
a calculated travel distance value calculation device that calculates calculated travel distance values of the possible locations based on the travel distance values acquired by the travel distance value acquisition device;
a reference value determination device that determines whether the calculated travel distance value for the holding location calculated by the calculated travel distance value calculation device indicates a long travel distance, based on a predetermined reference value; and
a first notification device that makes a notification that a bad weather is forecast at the holding date and time and the holding location requires a long travel distance, if the weather determination device determines that the clear weather is not forecast and the reference value determination device determines that the calculated travel distance value indicates a long travel distance.

11. The scheduling apparatus according to claim 2, further comprising:
a weather determination device that determines whether a clear weather is forecast at the holding date and time determined by the date and time determination device; and
a second notification device that makes a notification that an unsuitable weather is forecast at the desired date and time, if the weather determination device determines that the clear weather is not forecast and the holding location is outdoors.

12. The scheduling apparatus according to claim 10, wherein the schedule registration device stores the new schedule into the personal schedule device, if the first notification device makes a notification and an instruction of registering the new schedule is inputted via an instruction input device.

13. The scheduling apparatus according to claim 10, further comprising:
a change device that changes the desired location to a new location or the desired date and time to a new date and time, if the first notification device makes the notification and the new location or the new date and time is specified via a change specification device that specifies the new location or the new date and time,
wherein:
the location determination device determines a new holding location if the desired location is changed by the change device; and
the date and time determination device determines a new holding date and time if the desired date and time is changed by the change device.

14. The scheduling apparatus according to any of claim 2, further comprising:
a weather forecast acquisition device acquires the weather forecast for the registered date and time of the existing event acquired by the personal schedule information acquisition device at a predetermined date and time prior to the registered date and time;
a registered date and time weather determination device that determines whether the weather forecast for the registered date and time acquired by the registered date and time indicates the clear weather; and
a registered date and time weather notification device that makes a notification of the weather forecast for the registered date and time, if the registered date and time weather determination device determines that the weather forecast for the registered date and time does not indicate the clear weather.

15. The scheduling apparatus according to claim 14, wherein:
the location determination device determines a new holding location, if the desired location is changed via a new desired information input device to input a new desired location or a new desired date and time; and
the date and time determination device determines a new holding date and time, if the desired date and time is changed via the new desired information input device,
in a case where the notification of the weather forecast for the registered date and time is made by the registered date and time weather notification device, and an instruction to change the existing event is inputted via a change instruction input device to input an instruction to maintain or to change the existing event.

16. The scheduling apparatus according to claim 1, further comprising:
a conference room information acquisition device that acquires reservation information from conference room information storage device that stores reservation information for conference rooms, the reservation information including locations of the conference rooms, dates and times, and conference reservations corresponding to the locations of conference rooms and the dates and times;
a candidate selecting device that selects new event candidates based on the new event information accepted by the input accepting device, the personal schedule information acquired by the personal schedule information acquisition device, and the reservation information acquired by the conference room information acquisition device, the new event candidates each including a candidate date and time and a candidate location at which the new event can be held; and
a schedule notification device that notifies the participants of the new schedule determined by the schedule determination device,
wherein:
the input accepting device accepts at least one of the desired date and time, the desired location, and a duration of the new event in addition to the participants,
the personal schedule information stored in the personal schedule storage device includes a reference location where the user is usually located, and
the schedule determination device determines the candidate date and time and the candidate location of one of the new event candidates as the holding date and time and the holding location of the new event, based on a travel distance between the candidate location of each of the new event candidate and the registered location of a preceding event, a travel distance between the candidate location of each of the new event candidate and the registered location of a succeeding event, or a travel distance between the candidate location of each of the new event candidate and the reference location, the preceding event being the existing event registered immediately before the new event candidate, and the succeeding event being the existing event registered immediately after the new event candidate.

17. The scheduling apparatus according to claim 16, wherein:
the schedule determination device determines one of the new event candidates that makes the travel distance between the registered location of the preceding event and the candidate location of the new event candidate the shortest, as the new schedule, if the preceding event exists; and
the schedule determination device determines one of the new event candidates that makes the travel distance between the registered location of the succeeding event and the candidate location of the new event candidate or the travel distance between the reference location and the candidate location of the new event candidate the shortest, as the new schedule, if no preceding event exists.

18. The scheduling apparatus according to claim 17, wherein:
the schedule determination device determines one of the new event candidates that makes the travel distance between the registered location of the succeeding event and the candidate location of the new event candidate or the travel distance between the reference location of the user and the candidate location of the new event candidate the shortest, as the new schedule, if the preceding event exists and there are a plurality of the new event candidates that make the travel distance between the registered location of the preceding event and the candidate location of the new event candidate the shortest.

19. The scheduling apparatus according to claim 16, further comprising:
an importance calculation device that calculates an importance regarding the travel distance between the candidate location of the new event candidate and the registered location of the preceding event, travel distance between the candidate location of the new event candidate and the succeeding event, or the travel distance between the candidate location of the new event candidate and the reference location, the importance increasing as the travel distance becomes shorter,
wherein the schedule determination device determines the new schedule based on the importance calculated by the importance calculation device.

20. The scheduling apparatus according to claim 19, further comprising:
an approval determination device that determines whether to approve the new schedule notified of by the schedule notification device based on the importance of the existing event registered immediately after the new schedule; and
an approval notification device that notifies a notification source of the new schedule of a determination result by the approval determination device.

21. The scheduling apparatus according to claim 16, wherein the personal schedule information used by the candidate selection device to select the candidates is the personal schedule information of at least one of the participants included in the new event information.

22. The scheduling apparatus according to claim 16, wherein the existing event used for by the schedule determination device to determine the new schedule is the existing event included in the personal schedule information of at least one of the participants included in the new event information.

23. A computer-readable medium storing a scheduling program that comprises instructions to cause a computer to execute:
accepting new event information that may include a desired date and time of the new event, a desired location of the new event, and participants of the new event, at least the participants being requisite in the new event information;
acquiring personal schedule information from a personal schedule storage device, the personal schedule information a including identification information of a user, a registered date and time and a registered location of a registered event;
determining a new schedule including a holding date and time and a holding location based on the accepted new event information, the acquired personal schedule information, and at least one of a weather forecast or a travel distance of at least one of the participants to attend the new event, the holding date and time being a determined date and a time of the new event, and the holding location being a determined location of the new event; and
registering the determined new schedule into the personal schedule storage device.
